(19) United States
(12) Patent Application Publication
(10) Pub. No.: US 2022/0016624 A1
(43) Pub. Date: Jan. 20, 2022

(54) COMPOSITIONS, METHODS AND SYSTEMS FOR SAMPLE PROCESSING

(71) Applicant: ReadCoor, LLC, Pleasanton, CA (US)

(72) Inventors: Evan Daugharthy, Cambridge, MA (US); Richard Terry, Carlisle, MA (US); Hong Chen, Cambridge, MA (US); Ben Pruitt, Cambridge, MA (US); Gene Daidone, Cambridge, MA (US); Vikki Asman, Medford, MA (US); Adrian Tanner, Somerville, MA (US); Eric Evje, Somerville, MA (US)

(21) Appl. No.: 17/185,749

(22) Filed: Feb. 25, 2021

Related U.S. Application Data
(63) Continuation of application No. PCT/US21/18878, filed on Feb. 19, 2021.
(60) Provisional application No. 62/979,893, filed on Feb. 21, 2020.

(51) Int. Cl. B01L 3/00

(52) U.S. Cl. CPC B01L 3/502715; B01L 2300/0663; B01L 2300/087; B01L 2300/0822; B01L 2300/1822; B01L 2200/16; B01L 2300/043; B01L 2300/163

(57) ABSTRACT

The present disclosure provides compositions and methods for making and using a support (e.g., a sample slide) for sample analysis. The present disclosure also provides compositions, methods, and systems for processing a sample on the support for use in nucleic acid sequence detection.

### CROSS-REFERENCE

This application is a continuation of International Application No. PCT/US21/18878, filed Feb. 19, 2021 which claims priority to U.S. Provisional Patent Application No. 62/979,893, filed Feb. 21, 2020, which application is herein incorporated by reference in its entirety for all purposes.

### BACKGROUND

Fluorescent in situ sequencing (FISSEQ) can be used to detect target molecules within a sample (e.g., a biological sample) in situ. During FISSEQ, a three-dimensional (3D) matrix can be generated within the sample to immobilize the target molecules or derivatives thereof. Nucleic acid target molecules may be subsequently amplified and sequenced within the 3D matrix. The 3D matrix with the attached nucleic acid molecules can provide an information storage medium where the nucleic acid molecules represent stored information which can be read within the 3D matrix.

FISSEQ may be used to detect one or more fluorescent signals emanating from each sequencing template within a FISSEQ library over more than one cycle of fluorescence detection, wherein the fluorescent signals over the totality of detection cycles may comprise an information construct, which may be mapped to molecular identification or otherwise provide information about the nature of the detected molecule. The 3D matrix can allow reagent exchange and removal of background molecules without losing the target molecules.

### SUMMARY

Samples used for Fluorescent in situ sequencing (FISSEQ) may be processed on a support (e.g., a glass slide). Recognized herein is a need for preparing a support to be used for immobilizing a sample and/or the three-dimensional (3D) matrix. The present disclosure provides compositions, methods, devices and systems for sample processing, such as for preparing such support and immobilizing the sample and/or the 3D matrix on the support. The present disclosure also provides systems and devices that can use the support for automated sample processing and detection. The methods and systems provided herein may allow efficient sample processing and detection within the 3D matrix.

In an aspect, the present disclosure provides a device for holding a sample comprising: a support; a coating coupled to the support comprising: a matrix binding agent for attaching a synthetic three-dimensional (3D) matrix to the support; and a sample binding agent for attaching a sample to the support.

In some embodiments, the matrix binding agent forms a covalent bond to the 3D matrix. In some embodiments, the matrix binding agent binds to the 3D matrix via an interpenetrating network. In some embodiments, the matrix binding agent and the sample binding agent are different. In some embodiments, the matrix binding agent and the sample binding agent are the same. In some embodiments, the matrix binding agent comprises an acrylate. In some embodiments, the acrylate is a methacrylate. In some embodiments, the matrix binding agent comprises a silane. In some embodiments, the silane of the matrix binding agent comprises a methyl silane, dimethyl silane, or trimethyl silane. In some embodiments, the acrylate is bound to the silane by a C1-C15 alkyl, alkenyl, or alkynyl. In some embodiments, the matrix binding agent comprises 3-(trimethoxysilyl)propyl acrylate or 3-(trimethoxysilyl)propyl methacrylate. In some embodiments, the matrix binding agent comprises polymeric 3-(trimethoxysilyl)propyl acrylate or 3-(trimethoxysilyl)propyl methacrylate. In some embodiments, the matrix binding agent comprises methacryloxymethyltrimethoxysilane, 3-acrylamidopropyltrimethoxysilane, acryloxymethyltrimethoxysilane, (3-acryloxypropyl)trimethoxysilane, (3-methacrylamidopropyl)triethoxysilane, methacryloxymethyltriethoxysilane, methacryloxymethyltrimethoxysilane, methacryloxypropyltriethoxysilane, or any combinations thereof. In some embodiments, the matrix binding agent comprises a hydrogel. In some embodiments, a thickness of the hydrogel is at most about 300 micrometer (μm). In some embodiments, the hydrogel comprises acrylamide. In some embodiments, the acrylamide is a polyacrylamide. In some embodiments, the sample binding agent attaches to a biological sample via an electrostatic interaction. In some embodiments, the sample binding agent comprises a negative charge. In some embodiments, the sample binding agent comprises a positive charge. In some embodiments, the sample binding agent comprises a silane. In some embodiments, the silane of the sample binding agent comprises a methyl silane, dimethyl silane, or trimethyl silane. In some embodiments, the sample binding agent comprises 3-aminopropyltriethoxysilane (APES). In some embodiments, the sample binding agent comprises a hydrolytic stability enhancing agent. In some embodiments, the sample binding agent comprises bis(triethoxysilyl)ethane (BTESE). In some embodiments, the sample binding agent comprises a heteropolymer comprising APES and BTESE. In some embodiments, the sample binding agent comprises poly-L-lysine. In some embodiments, the sample binding agent attaches to the biological sample via at least one of a hydrogen bond and a Van der Waals force. In some embodiments, the sample binding agent comprises a hydrogel. In some embodiments, the hydrogel comprises acrylamide. In some embodiments, the acrylamide is a polyacrylamide. In some embodiments, a thickness of the hydrogel is at most about 300 μm. In some embodiments, the sample binding agent is the same as the matrix binding agent.

In some embodiments, a surface of the support is hydrophilic. In some embodiments, the support is a solid support or a semi-solid support. In some embodiments, the support comprises a plate, a slide, a coverslip, a flow cell, a microchip, a microcentrifuge tube, a test tube, or a well. In some embodiments, the support comprises glass, microspheres, inert particles, magnetic particles, plastic, polysaccharide, nylon, nitrocellulose, ceramic, resin, silica, silicon, modified silicon, polytetrafluoroethylene, or metal. In some embodiments, the glass comprises modified glass, functionalized glass, or inorganic glass. In some embodiments, the plastic comprises acrylic, polystyrene, polypropylene, polyethylene, polybutylene, or polyurethane.

In some embodiments, at least a portion of the support is covered by a removable mask. In some embodiments, the removable mask is or is substantially impermeable to formaldehydes, waxes, polyolefins, alcohols or glycols. In some embodiments, the removable mask is attached to the support using an adhesive. In some embodiments, a removable boundary is attached to a surface of the support, wherein the removable boundary comprises a side wall and wherein the surface of the support and the removable boundary form a well. In some embodiments, the removable boundary is attached to the surface of the support with an adhesive, wherein the adhesive forms a seal between the removable boundary and a surface of the support. In some embodiments, the removable boundary is a sample cassette. In some embodiments, the support is sandwiched in between a top piece and a bottom piece of the sample cassette. In some embodiments, the support comprises a sample binding area. In some embodiments, the sample binding area is identified with a visible marking. In some embodiments, the sample binding area is transparent. In some embodiments, the support or the removable boundary comprises a machine-readable identification tag. In some embodiments, the machine-readable identification tag provides the device with a unique identifier. In some embodiments, the machine-readable identification tag identifies a sample attached to the device. In some embodiments, the machine-readable identification tag provides a system preparing or analyzing a sample attached to the device with instructions for preparing or analyzing the sample. In some embodiments, the machine-readable identification tag comprises a quick response (QR) code, a data matrix, a radio-frequency identification (RFID) tag, or a near-field communication (NFC) chip. In some embodiments, the support comprises at least one fiducial marker. In some embodiments, the support comprises the sample attached thereto. In some embodiments, the support comprises a positive charge. In some embodiments, the positive charge of the support is reduced or neutralized. In some embodiments, the positive charge of the support comprises an amine group. In some embodiments, the amine group is neutralized by an n-hydroxysuccinimide (NHS) ester. In some embodiments, the support further comprises the synthetic 3D matrix attached thereto. In some embodiments, a thickness of the synthetic 3D matrix is at least about 100 μm. In some embodiments, the sample is a biological sample. In some embodiments, the biological sample is a cell or a tissue. In some embodiments, the sample comprises one or more nucleic acid molecules.

In another aspect, the present disclosure provides a system for analyzing a sample comprising a stage for holding a device described herein.

In another aspect, the present disclosure provides a system for analyzing a sample comprising: a first module having a first housing comprising: a stage configured to retain a sample comprising a plurality of nucleic acid molecules in a three dimensional (3D) matrix, which plurality of nucleic acid molecules have a relative 3D spatial relationship; and a detector configured to detect one or more signals from the sample; and a second module having a second housing comprising: a computer operatively coupled to the detector, wherein the computer is configured to: (a) bring said plurality of nucleic acid molecules or derivatives thereof in contact with detectable moieties, and (ii) use said detector to obtain signals corresponding to said detectable moieties from a plurality of planes of said 3D matrix, and (b) use said signals obtained by said detector to generate a 3D volumetric representation of said plurality of nucleic acid molecules, which 3D volumetric representation identifies said relative 3D spatial relationship of said plurality of nucleic acid molecules, a stage; wherein the first housing is physically distinct from the second housing.

In some embodiments, the first module further comprises a fluidic waste extraction tube positioned above the stage. In some embodiments, the second module further comprises a reagent reservoir interface. In some embodiments, the stage comprises at least one recess for holding a device for retaining the sample, wherein the device comprises a support. In some embodiments, the stage comprises a lid for securing the device. In some embodiments, the lid comprises a hinge. In some embodiments, the device for retaining the sample is a device described herein. In some embodiments, the system further comprising the device described herein. In some embodiments, the at least one recess comprises a sample position controller that positions the sample within the at least one recess. In some embodiments, the sample position controller comprises at least one mechanical linkage that positions the sample within the at least one recess. In some embodiments, the at least one mechanical linkage comprises a cam In some embodiments, sample position controller comprises at least one pin that positions the sample within the at least one recess. In some embodiments, the sample position controller comprises at least one X pin, at least one Y pin, and at least one Z pin. In some embodiments, the stage further comprises a temperature controller. In some embodiments, the temperature controller comprises a Peltier element. In some embodiments, the stage is a motorized stage that moves in an x, y, and z direction relative to the detector.

In some embodiments, the first module comprises a machine-readable identification tag reader. In some embodiments, the machine-readable identification tag reader comprises at least one of a quick response (QR) code reader, a data matrix reader, a radio-frequency identification (RFID) tag reader, and a near-field communication (NFC) chip reader. In some embodiments, the stage comprises the machine-readable identification tag reader. In some embodiments, the machine-readable identification tag reader reads a machine-readable identification tag on a device for retaining a sample.

In some embodiments, the first module comprises an optical assembly that comprises the detector. In some embodiments, the detector is a camera. In some embodiments, the camera comprises a CMOS or sCMOS sensor. In some embodiments, the optical assembly comprises an objective lens. In some embodiments, the objective lens is a water immersion lens, oil immersion lens, water dipping lens, air lens, or lens with an adjustable refractive index. In some embodiments, the objective lens is an autofocus objective lens. In some embodiments, the system further comprises an autofocus controller. In some embodiments, the autofocus controller comprises an integrated circuit, a computer, or a field-programmable gate array (FPGA). In some embodiments, the autofocus controller is a reflection-based autofocus controller.

In some embodiments, the first module comprises a light source. In some embodiments, the light source comprises a laser, light-emitting diode, or incandescent lamp. In some embodiments, the light source comprises a spectral filter. In some embodiments, the fluidic waste extraction tube is a sipper tube. In some embodiments, the first module further comprises a sensor that detects a position of the fluidic waste extraction tube. In some embodiments, the sensor is a plurality of sensors. In some embodiments, the plurality of sensors comprises a plurality of photointerruptors. In some embodiments, the position of the fluidic waste extraction tube comprises a position of a tip of the fluidic waste extraction tube. In some embodiments, the position of the fluidic waste extraction tube comprises a position of the fluidic waste extraction tube relative to a device for retaining the sample or a position of the fluidic waste extraction tube relative to the sample. In some embodiments, second module comprises a user interface. In some embodiments, the user interface comprises a touchscreen.

In some embodiments, the second module further comprises a reagent reservoir loaded onto the reagent reservoir interface. In some embodiments, the reagent reservoir comprises a plurality of reagent reservoirs. In some embodiments, the reagent reservoir interface is in fluidic communication with the first module. In some embodiments, the reagent reservoir interface is in fluidic communication with a sample in the first module. In some embodiments, the reagent reservoir comprises a machine-readable identification tag. In some embodiments, the reagent reservoir interface comprises a machine-readable identification tag reader. In some embodiments, the machine-readable identification tag reader comprises at least one of a quick response (QR) code reader, a data matrix reader radio-frequency identification (RFID) tag reader, and near-field communication (NFC) chip reader. In some embodiments, the machine-readable identification tag reader reads the machine-readable identification tag on the reagent reservoir.

In some embodiments, the system further comprises a reagent cartridge interface for fluidically connecting the system to a reagent cartridge comprising a plurality of chambers for holding reagents. In some embodiments, the reagent cartridge interface comprises a plurality of first tubular bodies for introducing gas into the chambers for holding reagents. In some embodiments, the first tubular bodies comprise piercing elements for piercing a plurality of upper seals on the top of the reagent cartridge. In some embodiments, the first tubular bodies comprising piercing elements are needles. In some embodiments, the system further comprises a tank of pressurized argon gas fluidically connected to the tubular bodies. In some embodiments, the reagent cartridge interface comprises a lid. In some embodiments, the lid comprises the plurality of first tubular bodies. In some embodiments, the reagent cartridge interface comprises a plurality of second tubular bodies on the bottom for removing reagents from the chambers for holding reagents. In some embodiments, the plurality of second tubular bodies comprise piercing elements for piercing a lower seal on the bottom of the chambers for holding reagents. In some embodiments, the plurality of second tubular bodies are in fluidic communication with the device for retaining the sample. In some embodiments, the plurality of second tubular bodies are in fluidic communication with a sample. In some embodiments, the plurality of second tubular bodies comprise a plurality of sprung needle shrouds or a sprung needle shroud plate. In some embodiments, the plurality of second tubular bodies become exposed when the lid of the reagent cartridge interface secures a reagent cartridge. In some embodiments, the exposed plurality of second tubular bodies pierce a seal on the reagent cartridge. In some embodiments, the reagent cartridge interface comprises a machine-readable identification tag reader. In some embodiments, the machine-readable identification tag reader comprises at least one of a quick response (QR) code reader, a data matrix reader, radio-frequency identification (RFID) tag reader, and near-field communication (NFC) chip reader. In some embodiments, the machine-readable identification tag reader reads a machine-readable identification tags on a reagent cartridge connected to the reagent cartridge interface. In some embodiments, the first module comprises the reagent cartridge interface. In some embodiments, the second module comprises the reagent cartridge interface.

In some embodiments, the system further comprises a reagent cartridge comprising a main reservoir body comprising a plurality of chambers for holding reagents comprising upper seals and lower seals. In some embodiments, the upper seals comprise a foil or a septum. In some embodiments, the lower seals comprise a foil or a septum. In some embodiments, the chambers further comprise a filter between a cavity of the chamber and the septum. In some embodiments, the filter is a 10, 20, 30, 40, 50, or 60 μm filter. In some embodiments, the filter is separated from the septum by a void for a second tubular body of the plurality of second tubular bodies to withdraw reagent from the chamber. In some embodiments, the plurality of chambers hold a plurality of reagents, wherein at least one of the plurality of reagents comprises an enzyme, a buffer, a detection probe, and a nucleic acid. In some embodiments, the reagent cartridge further comprises a machine-readable identification tag. In some embodiments, the machine-readable identification tag comprises at least one of a quick response (QR) code, a data matrix, radio-frequency identification (RFID) tag, and near-field communication (NFC) chip. In some embodiments, the machine-readable identification tag is informative of the contents of the reagent cartridge.

In some embodiments, the second module further comprises a waste reservoir in fluidic communication with the fluidic waste extraction tube. In some embodiments, the second module further comprises a sensor to detect a presence of the waste reservoir. In some embodiments, the second module further comprises a sensor to detect a level of fluid in the waste reservoir.

In some embodiments, the second module comprises a digital processing device comprising: at least one processor, an operating system configured to perform executable instructions, a memory, and a computer program including instructions executable by the digital processing device to provide an application comprising: a software module for controlling the system to repeatedly scan a three-dimensional sub-volume of a sample, the repeated scans including temporal data, and processing data from the repeated scans including the temporal data to generate three-dimensional map of the sub-volume of the sample. In some embodiments, the three-dimensional map comprises a coordinate system. In some embodiments, the digital processing device comprises a software module for detecting a position of a fiducial marker on the sample device associated with a scan of the repeated scans and adjusting the three-dimensional map of the sub-volume of the sample to compensate for the position of the fiducial marker on the sample device. In some embodiments, the digital processing device comprises a software module for controlling the timing of fluidic, optical, and motion-related events occurring in the first module. In some embodiments, the software module for controlling the timing of fluidic, optical, and motion-related events occurring in the first module controls motors, cameras, optical tuning systems, optical gating systems, and sensors. In some embodiments, the digital processing device comprises a software module that selects or suggests a protocol for processing or analyzing a sample based on detection by the system of a machine-readable identification tag present on at least one of a sample, a reagent reservoir, and a reagent cartridge. In some embodiments, the digital processing device comprises a user interface. In some embodiments, the user interface comprises a touchscreen. In some embodiments, the first module comprises a fluidic cooling system. In some embodiments, the first module does not comprise a fan for cooling. In some embodiments, the second module comprises a fan for cooling.

In another aspect, the present disclosure provides a method of analyzing a biological sample comprising attaching a sample to the sample binding agent of a device described herein. In some embodiments, the method further comprises contacting the sample attached to the sample binding agent of the device with a matrix-forming material. In some embodiments, the matrix-forming material comprises acrylamide. In some embodiments, the acrylamide is propargyl acrylamide. In some embodiments, the matrix-forming material further comprises a crosslinker. In some embodiments, the crosslinker is N,N′-methylenebisacrylamide (BIS), piperazine diacrylate (PDA), N,N′-bisacrylylcystamine (BAC), or N,N′-diallyltartardiamide (DATD). In some embodiments, the matrix-forming material further comprises an activator or an inhibitor, which activator or inhibitor controls a rate of polymerization of the matrix-forming material. In some embodiments, the method further comprises generating a synthetic 3D matrix from the matrix-forming material. In some embodiments, the generating comprises polymerizing or crosslinking the matrix-forming material. In some embodiments, generating the synthetic 3D matrix from the matrix-forming material is performed in an oxygen-free environment. In some embodiments, the method further comprises attaching a synthetic 3D matrix to the matrix binding agent of the device. In some embodiments, attaching the synthetic 3D matrix to the matrix binding agent comprises crosslinking the synthetic 3D matrix to the matrix binding agent. In some embodiments, the crosslinking comprises physical crosslinking or chemical crosslinking. In some embodiments, the crosslinking comprises free-radical polymerization, chemical conjugation, or bioconjugation reactions. In some embodiments, the crosslinking comprises photopolymerization. In some embodiments, the photopolymerization is initiated by single-photon or multiphoton excitation systems. In some embodiments, the photopolymerization is initiated by manipulation of light to form specific two-dimensional (2D) or 3D patterns. In some embodiments, the photopolymerization is initiated by a spatial light modulator. In some embodiments, the spatial light modulator is a digital spatial light modulator. In some embodiments, the spatial light modulator employs a transmissive liquid crystal, reflective liquid crystal on silicon (LCOS), digital light processing, or a digital micromirror device (DMD). In some embodiments, the 3D matrix comprises a polymeric material. In some embodiments, the synthetic 3D matrix comprises an additional polymeric material crosslinked to said polymeric material. In some embodiments, said material comprises polyacrylamide, poly-ethylene glycol (PEG), poly(acrylate-co-acrylic acid) (PAA) or poly(N-isopropylacrylamide) (NIPAM). In some embodiments, said synthetic 3D matrix is configured to expand. In some embodiments, the method further comprises obtaining a three-dimensional map of the sample. In some embodiments, the three-dimensional map comprises a three-dimensional map of a plurality of nucleic acid sequences present in the sample. In some embodiments, the method comprises performing a FISSEQ protocol on the biological sample. In some embodiments, at least a portion of the method is performed by a system described herein.

In another aspect, the present disclosure provides a kit comprising a device described herein. In some embodiments, the kit further comprises a sample cassette. The kit further comprises an informational material that directs a user to perform a method for attaching a sample to the device.

Another aspect of the present disclosure provides a non-transitory computer readable medium comprising machine executable code that, upon execution by one or more computer processors, implements any of the methods above or elsewhere herein.

Another aspect of the present disclosure provides a system comprising one or more computer processors and computer memory coupled thereto. The computer memory comprises machine executable code that, upon execution by the one or more computer processors, implements any of the methods above or elsewhere herein.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “Figure” and “FIG.” herein), of which:

FIG. 1. shows a schematic of using methacryloxymethyltrimethoxysilane to functionalize glass slide.

FIG. 2A shows an example result of using the contact angle test to verify the hydrophilicity change of the support after plasma cleaning.

FIG. 2B shows an example result of using the gel adhesion test to verify the acrylate functionalization of methacryloxymethyltrimethoxysilane coated supports.

FIG. 3 shows a schematic of using (3-Aminopropyl)triethoxysilane/bis-1,2-(triethoxysilyl)ethane (APES/BTESE) to functionalize a methacryloxymethyltrimethoxysilane coated slide.

FIG. 4A shows an example result of using the negatively charged polystyrene microspheres to verify the positive surface charge of the support coated with a double coating comprising a methacryloxymethyltrimethoxysilane coating and a APES/BTESE coating.

FIG. 4B shows an example result of using the gel adhesion test to verify the acrylate functionalization of the support coated with a double coating comprising a methacryloxymethyltrimethoxysilane coating and a APES/BTESE coating.

FIG. 5 shows a schematic of using poly-L-Lysine (PLL) to functionalize a methacryloxymethyltrimethoxysilane coated slide.

FIG. 6A shows an example result of using the negatively charged polystyrene microspheres to verify the positive surface charge of the support coated with a double coating comprising a methacryloxymethyltrimethoxysilane coating and a PLL coating.

FIG. 6B shows an example result of using the gel adhesion test to verify the acrylate functionalization of the support coated with a double coating comprising a methacryloxymethyltrimethoxysilane coating and a PLL coating.

FIG. 7 shows a schematic of using a layer of hydrogel to coat the methacryloxymethyltrimethoxysilane coated slide.

FIG. 8 shows a schematic of the interaction between the thin gel and the 3D matrix.

FIG. 9A shows an example result of the gel adhesion test. The thin gel layer was scraped by vacuum tip.

FIG. 9B shows an example result of the gel adhesion test used to examine the bonding between the thin gel coating and the 3D matrix.

FIG. 10 shows an example result, indicating that the 3D matrix (with a mouse brain frozen tissue) can be strongly and stably adhered on the thin gel coated support throughout the FISSEQ process.

FIG. 11 shows an example workflow of using the mask for controlling the thickness of the thin gel coating.

FIG. 12 shows an example of the masked support.

FIG. 13A shows a schematic of assembling the sample cassette.

FIG. 13B shows an assembled sample cassette with the support sandwiched in between the top piece and the bottom piece of the sample cassette

FIG. 14 shows example mechanisms of charge passivation.

FIG. 15 shows an example result of charge passivation.

FIG. 16 shows an example of a two-module system for sample analysis.

FIG. 17 shows an example design of the stage of the system for sample analysis.

FIG. 18 shows an example process of inserting a sample device into the recess of the stage.

FIG. 19 shows an example design of the mechanism for sample device positioning, retention and thermal management.

FIG. 20 shows an example design of the sipper tube calibration mechanism.

FIG. 21 shows an example of the reagent cartridge interface and the fluidics manifold and solenoid system of the fluidics dispensing system.

FIG. 22 shows an example fluidics control system of the fluidics dispensing system.

FIG. 23 shows a waste dish located on top of a load cell of the fluidics dispensing system.

FIG. 24A shows an example of the reagent cartridge.

FIG. 24B shows a view of the distal end (or the bottom) of the reagent cartridge.

FIG. 25A shows an example of the reagent cartridge.

FIG. 25B shows a cross-sectional view of the reagent cartridge.

FIG. 26 shows an example workflow of loading a reagent cartridge into a fluidics system.

FIG. 27A shows an example of the bulk reagent bottle connect to the bulk reagent interface module (BRIM) through the interface cap.

FIG. 27B shows a cross-sectional view of the bulk reagent bottle connected to the BRIM through the interface cap.

FIG. 28 shows an example process of loading a bulk reagent bottle to the bulk reagent interface.

FIG. 29 shows an example waste interface module loaded with a consumable waste bottle.

FIG. 30 shows a computer system that is programmed or otherwise configured to implement methods provided herein.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

Whenever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” or “less than or equal to” precedes the first numerical value in a series of two or more numerical values, the term “no more than,” “less than,” or “less than or equal to” applies to each of the numerical values in that series of numerical values. For example, less than or equal to 3, 2, or 1 is equivalent to less than or equal to 3, less than or equal to 2, or less than or equal to 1.

The term “nucleic acid,” as used herein, generally refers to a nucleic acid molecule comprising a plurality of nucleotides or nucleotide analogs. A nucleic acid may be a polymeric form of nucleotides. A nucleic acid may comprise deoxyribonucleotides and/or ribonucleotides, or analogs thereof. A nucleic acid may be an oligonucleotide or a polynucleotide. Nucleic acids may have various three-dimensional structures and may perform various functions. Non-limiting examples of nucleic acids include DNA, RNA, coding or non-coding regions of a gene or gene fragment, loci (locus) defined from linkage analysis, exons, introns, messenger RNA (mRNA), transfer RNA, ribosomal RNA, short interfering RNA (siRNA), short-hairpin RNA (shRNA), micro-RNA (miRNA), ribozymes, cDNA, recombinant nucleic acids, branched nucleic acids, plasmids, vectors, isolated DNA of any sequence, isolated RNA of any sequence, nucleic acid probes, and primers. A nucleic acid may comprise one or more modified nucleotides, such as methylated nucleotides and nucleotide analogs. If present, modifications to the nucleotide structure may be made before or after assembly of the nucleic acid. The sequence of nucleotides of a nucleic acid may be interrupted by non-nucleotide components. A nucleic acid may be further modified after polymerization, such as by conjugation, with a functional moiety for immobilization.

The terms “polypeptide” and “peptide” are used interchangeably herein, and they refer to a polymeric form of amino acids. A polypeptide can comprise two or more amino acids. A polypeptide can be unstructured or structured. A polypeptide can be a protein.

### Overview

During the in situ detection such as fluorescent in situ sequencing (FISSEQ), the three-dimensional (3D) gel matrix may be immobilized onto a support. The 3D gel matrix may be stably linked to the support by chemical functionalization of the support, absorption, or chemical bonds. The chemical functionalization can comprise organosilane functionalization of glass slide, e.g., by methacryloxymethyltrimethoxysilane. Samples such as tissues or biological specimens can be placed onto the sample slide as sections, e.g., cryostat or microtome, and may need to adhere to the support until encapsulation into the 3D matrix. Complete and secure adhesion of tissue can maintain sample integrity during preanalytical operations. Maintaining flatness can be an additional benefit to prevent distortion of the sample during analysis. Tissue section placement can be impeded by the presence of structures on the support and enabled by a large, flat space to place the tissue section. The surface of the support may have areas that may be needed for subsequent assembly of the support into a cassette or other mechanical interface with devices such as a sequencer.

Assembly areas may need a level of cleanliness to enable robust seal with the sample cassette assembly to prevent leaking of reagents. Tissue placement may adulterate the support in areas outside the region of the support designated for sample analysis, such as areas used for assembly into mechanical interface assembly (e.g., cassette). For example, debris (e.g., environmental and sample extending beyond the region designated for sample analysis), or embedding medium (e.g., optical cutting temperature compounds for cryosectioning, paraffin for FFPE), or other preanalytical sample treatment reagents (e.g., for fixation or permeabilization) prior to cassette assembly may render the surface of the support with poor quality such that leaking may occur when the support is assembled into the cassette.

The devices and methods provided herein can allow immobilization of a sample and a 3D matrix for in situ detection. The devices can be used in a system for sample analysis for downstream sample processing and/or detection (e.g., sequencing).

### Devices for Holding Samples

The present disclosure provides devices (e.g., sample devices) for holding samples. The devices can be used for sample processing or analysis. A device for holding a sample can comprise a support. The support can comprise a coating attached thereto. The coating can comprise a matrix binding agent for attaching a three-dimensional (3D) matrix or gel matrix (e.g., a fluorescent in situ sequencing matrix, or FISSEQ matrix) to the support. The 3D matrix can be a synthetic 3D matrix. The coating can further comprise a sample binding agent for attaching a sample to the support. In some cases, the support can comprise one or more coatings. A first coating of the one or more coatings can comprise a matrix binding agent for attaching a 3D matrix to the support. A second coating of the one or more coatings can comprise a sample binding agent for attaching a sample to the support.

A support provided herein can be used to immobilize a sample and a 3D matrix or gel matrix that embeds the sample. The support can be a solid or semi-solid support. In some cases, the support can be a glass slide.

The support provided herein can comprise a coating. The coating can be used to immobilize a sample or a 3D matrix. The support can comprise a first coating and a second coating.

The coating can comprise an agent (e.g., a matrix binding agent) to immobilize the 3D matrix. Various agents can be used to coat the surface of the support. The matrix binding agent can comprise a silane. The matrix binding agent can comprise a methyl silane, dimethyl silane, or trimethyl silane. The matrix binding agent can comprise 3-(trimethoxysilyl)propyl acrylate or 3-(trimethoxysilyl)propyl methacrylate. The matrix binding agent can comprise methacryloxypropyltrimethoxysilane. The matrix binding agent can comprise a silane functionally equivalent to methacryloxypropyltrimethoxysilane, for example, 3-acrylamidopropyltrimethoxysilane, acryloxymethyltrimethoxysilane, (3-acryloxypropyl)trimethoxysilane, (3-methacrylamidopropyl)triethoxysilane, methacryloxymethyltriethoxysilane, methacryloxymethyltrimethoxysilane, or methacryloxypropyltriethoxysilane.

The silane described herein can have a general chemical as shown in formula (I): R—(CH₂)n-Si—X₃ (I), where R is an organofunctional group; (CH₂)n is the linker of various length, n can be any integer such as 1, 2, 3, 4, 5, 6, 7, 8, 9, 10, or more; Si denotes the silicon atom; and X denotes an hydrolyzable group, such as alkoxy, acyloxy, halogen or amine. The silane described herein can be a trialkoxysilane, monoalkoxysilane, or dipodal silane. Examples of silanes that can be used in the coating described herein include, but are not limited to, 3-acrylamidopropyltrimethoxysilane, n-(3-acryloxy-2-hydroxypropyl)-3-aminopropyltriethoxysilane, acryloxymethyltrimethoxysilane, (acryloxymethyl)phenethyltrimethoxysilane, (3-acryloxypropyl)trimethoxysilane, (3-methacrylamidopropyl)triethoxysilane, o-(methacryloxyethyl)-n-(triethoxysilylpropyl)carbamate, n-(3-methacryloxy-2-hydroxypropyl)-3-aminopropyltriethoxysilane, methacryloxymethyltriethoxysilane, methacryloxymethyltrimethoxysilane, methacryloxypropyltriethoxysilane, methacryloxypropyltriisopropoxysilane, methacryloxypropyltrimethoxysilane, methacryloxypropyltrimethoxysilane, methacryloxypropyltris(methoxyethoxy)silane, (3-acryloxypropyl)methyldiethoxysilane, (3-acryloxypropyl)methyldimethoxysilane, (methacryloxymethyl)methyldiethoxysilane, (methacryloxymethyl)methyldimethoxysilane, methacryloxypropylmethyldiethoxysilane, methacryloxypropylmethyldimethoxysilane, (3-acryloxypropyl)dimethylmethoxysilane, (methacryloxymethyl)dimethylethoxysilane, methacryloxypropyldimethylethoxysilane, methacryloxypropyldimethylmethoxysilane, (3-acryloxypropyl)trimethoxysilane, methacryloxypropyltrimethoxysilane, triethoxysilylbutyraldehyde, triethoxysilylundecanal, triethoxysilylundecanal, ethylene glycolacetal, 4-aminobutyltriethoxysilane, 4-amino-3,3-dimethylbutyltrimethoxysilane, n-(2-aminoethyl)-3-aminopropyltriethoxysilane, 3-(m-aminophenoxy)propyltrimethoxysilane, m-aminophenyltrimethoxysilane, p-aminophenyltrimethoxysilane, aminophenyltrimethoxysilane, 3-aminopropyltriethoxysilane, 3-aminopropyltriethoxysilane, 3-aminopropyltrimethoxysilane, 3-aminopropyltris(methoxyethoxyethoxy)silane, 11-aminoundecyltriethoxysilane, 2-(4-pyridylethyl)triethoxysilane, 2-(2-pyridylethyl)trimethoxysilane, n-(3-trimethoxysilylpropyl)pyrrole, 3-aminopropylsilanetriol, 4-amino-3,3-dimethylbutylmethyldimethoxysilane, 3-aminopropylmethyldiethoxysilane, 1-amino-2-(dimethylethoxysilyl)propane, 3-aminopropyldiisopropylethoxysilane, 3-aminopropyldimethylethoxysilane, (aminoethylaminomethyl)phenethyltrimethoxysilane, n-(2-aminoethyl)-3-aminopropyltrimethoxysilane, n-(2-aminoethyl)-3-aminopropyltrimethoxysilane, n-(6-aminohexyl)aminomethyltriethoxysilane, n-(6-aminohexyl)aminopropyltrimethoxysilane, n-(2-aminoethyl)-11-aminoundecyltrimethoxysilane, n-3-[(amino(polypropylenoxy)]aminopropyltrimethoxysilane, n-(2-n-benzylaminoethyl)-3-aminopropyltrimethoxysilane, n-(2-aminoethyl)-3-aminopropylsilanetriol, n-(2-aminoethyl)-3-aminopropyltrimethoxysilane-propyltrimethoxysilane, n-(2-aminoethyl)-3-aminoisobutylmethyldimethoxysilane, n-(2-aminoethyl)-3-aminopropylmethyldiethoxysilane, n-(2-aminoethyl)-3-aminopropylmethyldiethoxysilane, n-(2-aminoethyl)-3-aminoisobutyldimethylmethoxysilane, (3-trimethoxysilylpropyl)diethylenetriamine, 3-(n-allylamino)propyltrimethoxysilane, n-butylaminopropyltrimethoxysilane, t-butylaminopropyltrimethoxysilane, (n-cyclohexylaminomethyl)methyldiethoxysilane, (n-cyclohexylaminomethyl)triethoxysilane, (n-cyclohexylaminopropyl)trimethoxysilane, (3-(n-ethylamino)isobutyl)methyldiethoxysilane, (3-(n-ethylamino)isobutyl)trimethoxysilane, n-methylaminopropylmethyldimethoxysilane, n-methylaminopropyltrimethoxysilane, (phenylaminomethyl)methyldimethoxysilane, n-phenylaminomethyltriethoxysilane, n-phenylaminopropyltrimethoxysilane, n,n-bis(2-hydroxyethyl)-3-aminopropyltriethoxysilane, bis(3-trimethoxysilylpropyl)-n-methylamine, 3-carbazolylpropyltriethoxysilane, (n,n-diethylaminomethyl)triethoxysilane, (n,n-diethylaminomethyl)trimethoxysilane, (n,n-diethyl-3-aminopropyl)trimethoxysilane, 3-(n,n-dimethylaminopropyl)aminopropylmethyldimethoxysilane, n,n-dimethyl-3-aminopropylmethyldimethoxysilane, (n,n-dimethyl-3-aminopropyl)trimethoxysilane, n-methyl-n-trimethylsilyl-3-aminopropyltrimethoxysilane, tris(triethoxysilylmethyl)amine, tris(triethoxysilylpropyl)amine, n-(2-n-benzylaminoethyl)-3-aminopropyltrimethoxysilane hydrochloride, n,n-didecyl-n-methyl-n-(3-trimethoxysilylpropyl)ammonium chloride, octadecyldimethyl(3-trimethoxysilylpropyl)ammonium chloride, (styrylmethyl)bis(triethoxysilylpropyl)ammonium chloride, 3-(n-styrylmethyl-2-aminoethylamino)propyltrimethoxysilane hydrochloride, tetradecyldimethyl(3-trimethoxysilylpropyl)ammonium chloride, 4-(trimethoxysilylethyl)benzyltrimethylammonium chloride, s-(trimethoxysilylpropyl)isothiouronium chloride, n-trimethoxysilylpropyl-n,n,n-trimethylammonium chloride, 1-[3-(2-aminoethyl)-3-aminoisobutyl]-1,1,3,3,3-pentaethoxy-1,3-disilapropane, bis(methyldiethoxysilylpropyl)amine, bis(methyldimethoxysilylpropyl)-n-methylamine, bis(3-triethoxysilylpropyl)amine, n,n′-bis[3-(triethoxysilyl)propyl]urea, 1,11-bis(trimethoxysilyl)-4-oxa-8-azaundecan-6-ol, bis(3-trimethoxysilylpropyl)amine, n,n′-bis[(3-trimethoxysilyl)propyl]ethylenediamine, n,n′-bis[(3-trimethoxysilyl)propyl]ethylenediamine, bis(3-trimethoxysilylpropyl)-n-methylamine, n,n′-bis(3-trimethoxysilylpropyl)thiourea, n,n′-bis(3-trimethoxysilylpropyl)urea, (styrylmethyl)bis(triethoxysilylpropyl)ammonium chloride, n,n′-bis(3-trimethoxysilylpropyl)thiourea, 3-(1,3-dimethylbutylidene)aminopropyltriethoxysilane, 3-(1,3-dimethylbutylidene)aminopropyltriethoxysilane, n,n-dioctyl-n′-triethoxysilylpropylurea, 3-(guanidinyl)propyltrimethoxysilane, [3-(1-piperazinyl)propyl]methyldimethoxysilane, 3-(2-pyridylethyl)thiopropyltrimethoxysilane, 3-(4-pyridylethyl)thiopropyltrimethoxysilane, 3-(4-semicarbazidyl)propyltriethoxysilane, 11-(succinimidyloxy)undecyldimethylethoxysilane, 4-(triethoxysilylpropoxy)-2,2,6,6-tetramethylpiperidine n-oxide, n-[3-(triethoxysilyl)propyl]-2-carbomethoxyaziridine, n-(3-triethoxysilylpropyl)-4,5-dihydroimidazole, n-[5-(trimethoxysilyl)-2-aza-1-oxopentyl]caprolactam, n-(3-trimethoxysilylpropyl)perfluorohexanamide, ureidopropyltriethoxysilane, ureidopropyltrimethoxysilane, n-allyl-aza-2,2-dimethoxysilacyclopentane, n-(2-aminoethyl)-2,2,4-trimethyl-1-aza-2-silacyclopentane, n-(3-aminopropyldimethyl silyl)aza-2,2-dimethyl-2-silacyclopentane, n-n-butyl-aza-2,2-dimethoxysilacyclopentane, 2,2-dimethoxy-1,6-diaza-2-silacyclooctane, 2,2-dimethoxy-1,6-diaza-2-silacyclooctane, (n,n-dimethylaminopropyl)-aza-2-methyl-2-methoxysilacyclopentane, 1-ethyl-2,2-dimethoxy-4-methyl-1-aza-2-silacyclopentane, (1-(3-triethoxysilyl)propyl)-2,2-diethoxy-1-aza-2-silacyclopentane, aminopropylsilsesquioxane in aqueous solution, aminopropylsilsesquioxane in aqueous solution, aminoethylaminopropylsilsesquioxane in aqueous solution, aminoethylaminopropyl/vinyl/silsesquioxane in aqueous solution, trimethoxysilylpropyl modified (polyethylenimine), dimethoxysilylmethylpropyl modified (polyethylenimine), (3-triethoxysilyl)propyl succinic anhydride, (azidomethyl)phenethyltrimethoxysilane, p-azidomethylphenyltrimethoxysilane, 3-azidopropyltriethoxysilane, 6-azidosulfonylhexyltriethoxysilane, 4-(azidosulfonyl)phenethyltrimethoxysilane, 11-azidoundecyltrimethoxysilane, bis(3-triethoxysilylpropyl)carbonate, bis(3-trimethoxysilylpropyl) fumarate, carboxyethylsilanetriol, disodium salt, 2-(4-chlorosulfonylphenyl)ethyltrimethoxysilane, 2-(4-chlorosulfonylphenyl)ethyltrimethoxysilane, triethoxysilylpropylmaleamic acid, triethoxysilylpropyl(polyethyleneoxy)propylpotassium sulfate, trihydroxysilylethyl phenyl sulphonic acid, 3-(trihydroxysilyl)-1-propanesulfonic acid, n-(trimethoxysilylpropyl)ethylenediaminetriacetate, tripotassium salt, n-(trimethoxysilylpropyl)ethylenediaminetriacetate, trisodium salt, 2-(3,4-epoxycyclohexyl)ethyltriethoxysilane, 2-(3,4-epoxycyclohexyl)ethyltrimethoxysilane, 5,6-epoxyhexyltriethoxysilane, (3-glycidoxypropyl)triethoxysilane, (3-glycidoxypropyl)trimethoxysilane, (3-glycidoxypropyl)trimethoxysilane, 2-(3,4-epoxycyclohexyl)ethylmethyldiethoxysilane, (3-glycidoxypropyl)methyldiethoxysilane, (3-glycidoxypropyl)methyldimethoxysilane, (3-glycidoxypropyl)dimethylethoxysilane, acetoxymethyltriethoxysilane, acetoxymethyltrimethoxysilane, 2-Racetoxy(polyethyleneoxy)propyl]triethoxysilane, 3-acetoxypropyltrimethoxysilane, benzoyloxypropyltrimethoxysilane, 10-(carbomethoxy)decyldimethylmethoxysilane, 2-(carbomethoxy)ethyltrimethoxysilane, triethoxysilylpropoxy(polyethyleneoxy)dodecanoate, 4-bromobutyltrimethoxysilane, 7-bromoheptyltrimethoxysilane, 5-bromopentyltrimethoxysilane, 3-bromopropyltrimethoxysilane, 11-bromoundecyltrimethoxysilane, 3-chloroisobutyltrimethoxysilane, 2-(chloromethyl)allyltrimethoxysilane, ((chloromethyl)phenylethyl)trimethoxysilane, chloromethylphenethyltris(trimethylsiloxy)silane, (p-chloromethyl)phenyltrimethoxysilane, chloromethyltriethoxysilane, chloromethyltriisopropoxysilane, chloromethyltrimethoxysilane, 3-chloropropyltriethoxysilane, 3-chloropropyltrimethoxysilane, 11-chloroundecyltriethoxysilane, 11-chloroundecyltrimethoxy silane, 3-iodopropyltrimethoxysilane, (3-trimethoxysilyl)propyl 2-bromo-2-methylpropionate, vinyl(chloromethyl)dimethoxysilane, chloromethylmethyldiethoxysilane, ((chloromethyl)phenylethyl)methyldimethoxysilane, 3-chloropropylmethyldiethoxysilane, 3-chloropropylmethyldiisopropoxysilane, 3-chloropropylmethyldimethoxysilane, (3-iodopropyl)methyldiisopropoxysilane, 3-chloroisobutyldimethylmethoxysilane, chloromethyldimethylethoxysilane, ((chloromethyl)phenylethyl)methyldimethoxysilane, 3-chloropropyldimethylethoxysilane, 3-chloropropyldimethylmethoxysilane, 1-(3-chloroisobutyl)-1,1,3,3,3-pentaethoxy-1,3-disilapropane, n-(hydroxyethyl)-n-methylaminopropyltrimethoxysilane, hydroxymethyltriethoxysilane, n-(3-triethoxysilylpropyl)gluconamide, n-(3-triethoxysilylpropyl)-4-hydroxybutyramide, n-(triethoxysilylpropyl)-o-polyethylene oxide urethane, n-(hydroxyethyl)-n,n-bis(trimethoxysilylpropyl)amine, 11-(trimethylsiloxy)undecyltriethoxysilane, 3-isocyanatopropyltriethoxysilane, 3-isocyanotopropyltrimethoxysilane, 3-isocyanatopropylmethyldiethoxysilane, 3-isocyanatopropylmethyldimethoxysilane, (thiocyanatomethyl)phenethyltrimethoxysilane, 3-thiocyanatopropyltriethoxysilane, n-(3-triethoxysilylpropyl)-o-t-butylcarbamate, triethoxysilylpropyl ethylcarbamate, n-trimethoxysilylpropylmethylcarbamate, 2-(3-trimethoxysilpropylthio)thiophene, tris(3-trimethoxysilylpropyl)isocyanurate, bis(2-diphenylphosphinoethyl)methylsilylethyltriethoxysilane, (2-dicyclohexylphosphinoethyl)triethoxysilane, (2-diethylphosphatoethyl)methyldiethoxysilane, (2-diethylphosphatoethyl)triethoxysilane, (2-diphenylphosphino)ethyldimethylethoxysilane, 2-(diphenylphosphino)ethyltriethoxysilane, 3-(diphenylphosphino)propyltriethoxysilane, 3-(trihydroxysilyl)propyl methylphosphonate, monosodium salt, 2,2-dimethoxy-1-thia-2-silacyclopentane, 3-mercaptopropyltriethoxysilane, 3-mercaptopropyltrimethoxysilane, 3-mercaptopropyltrimethoxysilane, 11-mercaptoundecyltrimethoxysilane, s-(octanoyl)mercaptopropyltriethoxysilane, 3-(2-pyridylethyl)thiopropyltrimethoxysilane, 3-(4-pyridylethyl)thiopropyltrimethoxysilane, 3-thiocyanatopropyltriethoxysilane, 2-(3-trimethoxysilpropylthio)thiophene, (mercaptomethyl)methyldiethoxysilane, 3-mercaptopropylmethyldimethoxysilane, bis[m-(2-triethoxysilylethyl)tolyl]polysulfide, bis[3-(triethoxysilyl)propyl]disulfide, bis[3-(triethoxysilyl)propyl]tetrasulfide, n,n′-bis[3-(triethoxysilyl)propyl]thiourea, 11-allyloxyundecyltrimethoxysilane, m-allylphenylpropyltriethoxysilane, allyltriethoxysilane, allyltrimethoxysilane, [(5-bicyclo[2.2.1]hept-2-enyl)ethyl]trimethoxysilane, (5-bicyclo[2.2.1]hept-2-enyl)methyldichlorosilane, (5-bicyclo[2.2.1]hept-2-enyl)triethoxysilane, 3-butenyltriethoxysilane, 2-(chloromethyl)allyltrimethoxysilane, [2-(3-cyclohexenyl)ethyl]triethoxysilan, [2-(3-cyclohexenyl)ethyl]trimethoxysilane, 3-cyclohexenyltrimethoxysilane, (3-cyclopentadienylpropyl)triethoxysilane, 2-(divinylmethylsilyl)ethyltriethoxysilane, docosenyltriethoxysilane, hexadecafluorododec-11-en-1-yltrimethoxysilane, 5-hexenyltriethoxysilane, 5-hexenyltrimethoxysilane, 7-octenyltrimethoxysilane, o-(propargyl)-n-(triethoxysilylpropyl) carbamate, styrylethyltrimethoxysilane, 3-(n-styrylmethyl-2-aminoethylamino)propyltrimethoxysilane, 10-undecenyltrimethoxysilane, o-(vinyloxybutyl)-n-triethoxysilylpropyl carbamate, vinyltriacetoxysilane, vinyltri-t-butoxysilane, vinyltriethoxysilane, vinyltriisopropenoxysilane, vinyltriisopropoxysilane, vinyltrimethoxysilane, vinyltris(2-methoxyethoxy)silane, vinyltris(1-methoxy-2-propoxy)silane, vinyltris(methylethylketoximino)silane, n-allyl-aza-2,2-dimethoxysilacyclopentane, allylmethyldimethoxysilane, (5-bicyclo[2.2.1]hept-2-enyl)methyldiethoxysilane, vinylmethyldiethoxysilane, vinylmethyldimethoxysilane, (5-bicyclo[2.2.1]hept-2-enyl)dimethylethoxysilane, trivinylmethoxysilane, vinyldimethylethoxysilane, 1,2-bis(methyldiethoxysilyl)ethylene, bis(triethoxysilylethyl)vinylmethylsilane, 1,2-bis(triethoxysilyl)ethylene, 1,3-[bis(3-triethoxysilylpropyl)polyethylenoxy]-2-methylenepropane, 1,1-bis(trimethoxysilylmethyl)ethylene, bis(3-trimethoxysilylpropyl) fumarate, vinyltriethoxysilane, vinyltriethoxysilane-propyltriethoxysilane, vinyltrimethoxysilane, triethoxysilyl modified poly-1,2-butadiene, triethoxysilyl modified poly-1,2-butadiene, diethoxymethylsilyl modified poly-1,2-butadiene, (30-35% triethoxysilylethyl)ethylene-(35-40% 1,4-butadiene)-(25-30% styrene) terpolymer, 1,7-bis(4-triethoxysilylpropoxy-3-methoxyphenyl)-1,6-heptadiene-3,5-dione, 3-carbazolylpropyltriethoxysilane, 3-(2,4-dinitrophenylamino)propyltriethoxysilane, 2-hydroxy-4-(3-methyldiethoxysilylpropoxy)diphenylketone, 2-hydroxy-4-(3-triethoxysilylpropoxy)diphenylketone, o-4-methylcoumarinyl-n-[3-(triethoxysilyl)propyl]carbamate, nitroveratryloxycarbonylamidopropyltriethoxysilane, 7-triethoxysilylpropoxy-5-hydroxyflavone, n-(triethoxysilylpropyl)dansylamide, 3-(triethoxysilylpropyl)-p-nitrobenzamide, (r)-n-triethoxysilylpropyl-o-quinineurethane, (r)-n-1-phenylethyl-n′-triethoxysilylpropylurea, (s)-n-1-phenylethyl-n′-triethoxysilylpropylurea, (s)-n-triethoxysilylpropyl-o-menthocarbamate, (r)-n-triethoxysilylpropyl-o-quinineurethane, n-(acetylglycyl)-3-aminopropyltrimethoxysilane, 3-(n-acetyl-4-hydroxyprolyloxy)propyltriethoxysilane, n-(n-acetylleucyl)-3-aminopropyltriethoxysilane, (3-(3-thyminyl)propionoxy)propyltrimethoxysilane, o-dl-a-tocopherolylpropyltriethoxysilane, 11-bromoundecylsilane, 2-chloroethylsilane, dodecylsilane, n-octadecylsilane, (tridecafluoro-1,1,2,2-tetrahydrooctyl)silane, 10-undecenylsilane, 1,2-bis(tetramethyldisiloxanyl)ethane, 1,10-disiladecane, bis[(3-methyldimethoxysilyl)propyl]polypropylene oxide, 1,2-bis(triethoxysilyl)ethane, bis(triethoxysilyl)methane, 1,8-bis(triethoxysilyl)octane, 1,2-bis(trimethoxysilyl)decane, 1,2-bis(trimethoxysilyl)ethane, bis(trimethoxysilylethyl)benzene, and 1,6-bis(trimethoxysilyl)hexane, 1-(triethoxysilyl)-2-(diethoxymethylsilyl)ethane.

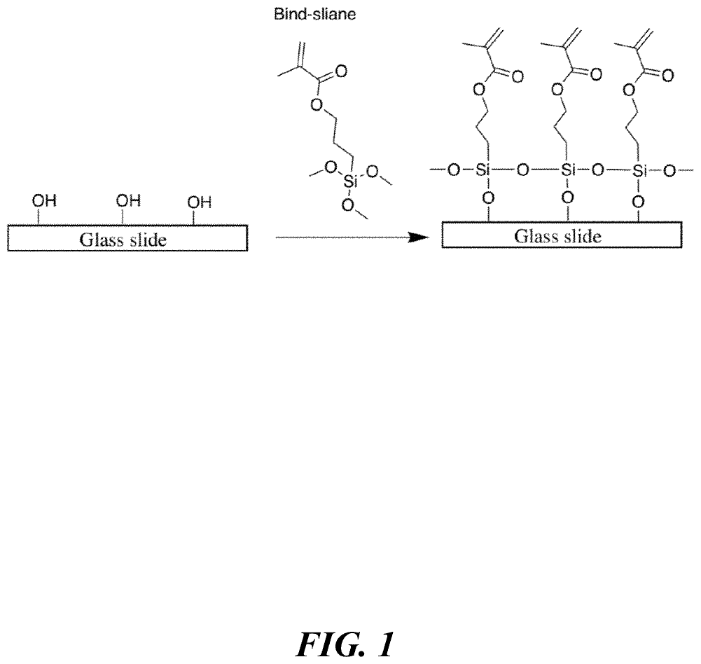

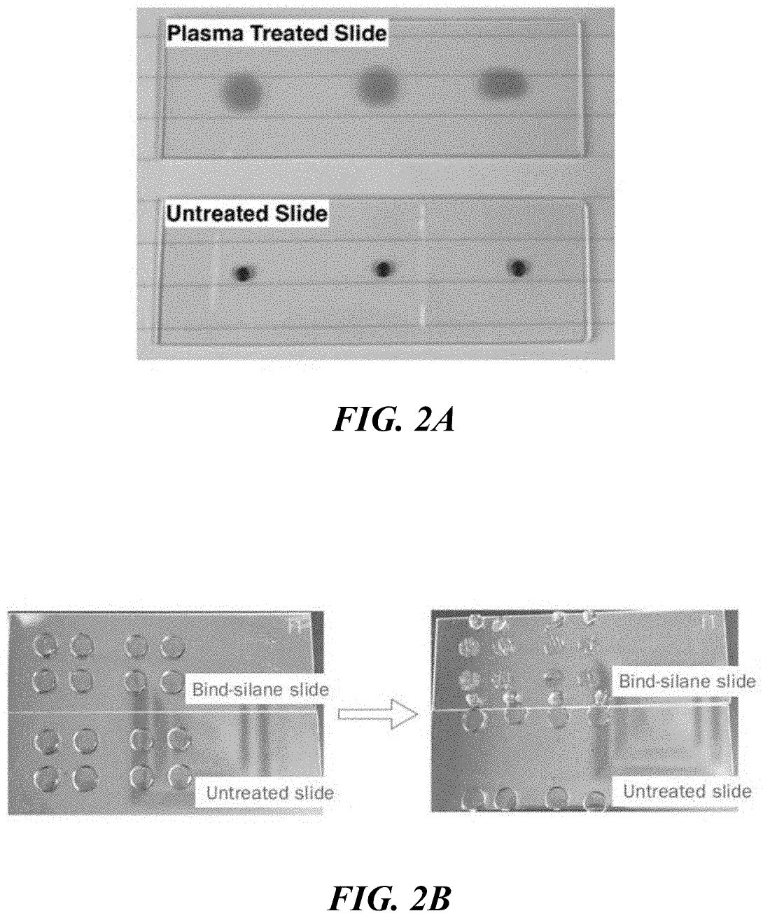

The matrix binding agent can be used to introduce an acrylate group on a surface of the support via silane chemistry (FIG. 1). For example, the acrylate can be bound to the silane by a C₁-C₁₅ alkyl, alkenyl, or alkynyl. The agent can be coated onto the support by methods provided herein. An example method can comprise providing a support such as a bare glass slide. Next, the support can be cleaned. The cleaning can be performed by sonicating the support in a buffer comprising acetone, ethanol, or dH₂O. In some cases, the support can be sonicated in acetone, ethanol or dH₂O successively, but the order may not be defined. The sonication in each buffer may be at least about 5 minutes, 10 minutes, 15 minutes, 20 minutes, 25 minutes, 30 minutes or more. After sonication, the support can be dried. The support can be dried in the oven, for example, at a condition of at least about 50° C., 60° C., 70° C., 80° C., 90° C., 100° C., 110° C., 120° C., 130° C., 140° C., 150° C. or more. The support can be dried in the condition for at least about 10 minutes, 15 minutes, 20 minutes, 25 minutes, 30 minutes, 35 minutes, 40 minutes, 45 minutes, 50 minutes, 60 minutes or more. The cleaning can further comprise a plasma cleaning (e.g., by air) for at least about 5 minutes, 10 minutes, 15 minutes, 20 minutes or more. A contact angle test can be used to test the hydrophilicity and to verify the plasma cleaning (FIG. 2A). The support can then be soaked in a silane solution after the plasma cleaning for coating. The silane solution can comprise at least about 0.5%, 1%, 1.2%, 1.5%, 1.8%, 2%, 2.5%, 3% or more methacryloxymethyltrimethoxysilane. The silane solution can be prepared in EtOH/dH₂O (e.g., 95%/5% EtOH/dH₂O). The pH of the solution can be at least about 3, 4, 5, 6, or more. The support can be soaked (e.g., incubated) in the silane solution at room temperature (e.g., about 25° C.) for at least about 1 minute, 5 minutes, 10 minutes, 20 minutes, 30 minutes, 40 minutes, 50 minutes, 60 minutes, 70 minutes, 80 minutes, 90 minutes, 100 minutes, 120 minutes, 150 minutes or more. After soaking, the support can be washed, for example, by sonicating in EtOH solution for at least about 30 seconds, 40 seconds, 50 seconds, 1 min, 2 minutes, 3 minutes, 4 minutes, 5 minutes or more. The EtOH solution may be 50%, 60%, 70% or more. The support can then be dried in the oven, for example, at a condition of at least about 50° C., 60° C., 70° C., 80° C., 90° C., 100° C., 110° C., 120° C., 130° C., 140° C., 150° C. or more. The support can be dried in the condition for at least about 10 minutes, 15 minutes, 20 minutes, 25 minutes, 30 minutes, 35 minutes, 40 minutes, 45 minutes, 50 minutes, 60 minutes or more. A gel adhesion test can be used test whether the coating can immobilize the gel matrix (FIG. 2B).

FIG. 2A shows an example result of using the contact angle test to verify the hydrophilicity change of the support after plasma cleaning. About 5 μL of colored dH₂O was dropped onto the surface of the support (e.g., a glass slide). The result showed that plasma-treated support had a hydrophilic surface. FIG. 2B shows an example result of using the gel adhesion test to verify the acrylate functionalization of methacryloxymethyltrimethoxysilane coated supports. In this example, polyacrylamide gel plugs were casted on the methacryloxymethyltrimethoxysilane support or untreated support in eight different areas. The gel plugs were peeled off with tweezer. The methacryloxymethyltrimethoxysilane treated support had gel residues remaining on the surface, while the untreated support had no or little gel residues.

The support can comprise a double coating, where a first coating can be used to immobilize a gel matrix onto the support, and a second coating can be used to immobilize a sample (e.g., a tissue sample) onto the support. The support can comprise a first coating comprising a matrix binding agent for immobilizing a gel matrix, and a second coating comprising a sample binding agent for immobilizing a sample. The matrix binding agent may be the same as the sample binding agent. The matrix binding agent may be different from the sample binding agent. In some cases, the support can comprise a first coating that can be used to immobilize a second coating, where the second coating comprise an agent for both immobilizing the gel matrix and the sample. In some cases, the support can comprise a coating having a matrix binding agent for immobilizing a gel matrix, and a sample binding agent for immobilizing a sample. The matrix binding agent can form a covalent bond to the gel matrix. The matrix binding agent can bind to the gel matrix via an interpenetrating network. The matrix binding agent can comprise a silane. The silane can be a methyl silane, dimethyl silane, or trimethyl silane. The matrix binding agent can comprise an acrylate. The matrix binding agent can comprise a hydrogel. The hydrogel can comprise acrylamide. The sample binding agent can attach to a sample via an electrostatic interaction. The sample binding agent can comprise a negative charge. The sample binding agent can comprise a positive charge. The sample binding agent can attach to the sample via at least one of a hydrogen bond and a Van der Waals force. The sample binding agent can comprise a silane. The silane of the sample binding agent can comprise a methyl silane, dimethyl silane, or trimethyl silane. The sample binding agent can comprise 3-aminopropyltriethoxysilane (APES). The sample binding agent can comprise a hydrolytic stability enhancing agent. The sample binding agent can comprise bis(triethoxysilyl)ethane (BTESE). The sample binding agent can comprise poly-L-lysine. The sample binding agent can comprise a hydrogel.

For culture of live cells, tissue culture (e.g., the process of culturing live tissue sections), organoids, and other types of specimens, the sample binding agent may comprise a charged surface for adhesion of the specimen by electrostatic interaction (positive, e.g., poly(L)-lysine, or negative). The binding agent may comprise a peptide, protein, or protein mixture, such as collagens, laminins, or composite substrates such as Matrigel Matrix. Such binding agents may be absorbed or chemically linked to the solid substrate. For thin-gel preparations, the thin-gel may be impregnated with sample binding agent. For example, the thin gel may be polymerized onto the solid surface in the presence of sample binding agent (e.g., laminin, collagen, or Matrigel, non-limiting examples of live culture sample binding agents). The sample binding agent may be infused into the thin gel after polymerization. The sample binding agent may be chemically functionalized to form linkages with the thin gel or solid surface, e.g., by NHS-ester acrylate or azide to primary amine moieties in the sample binding agent, and respectively by co-polymerization or chemical linkage to a chemically reactive group present on the surface or in the thin gel, such as by co-polymerization or click chemistry.

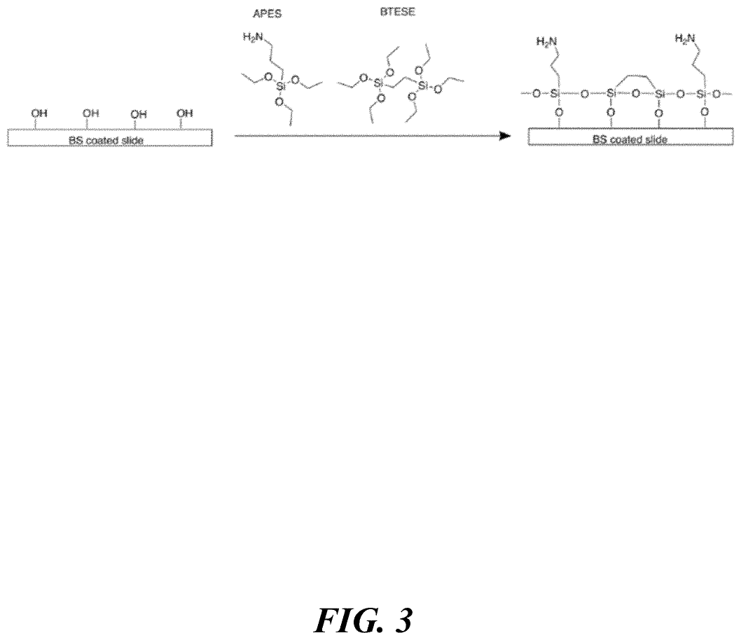

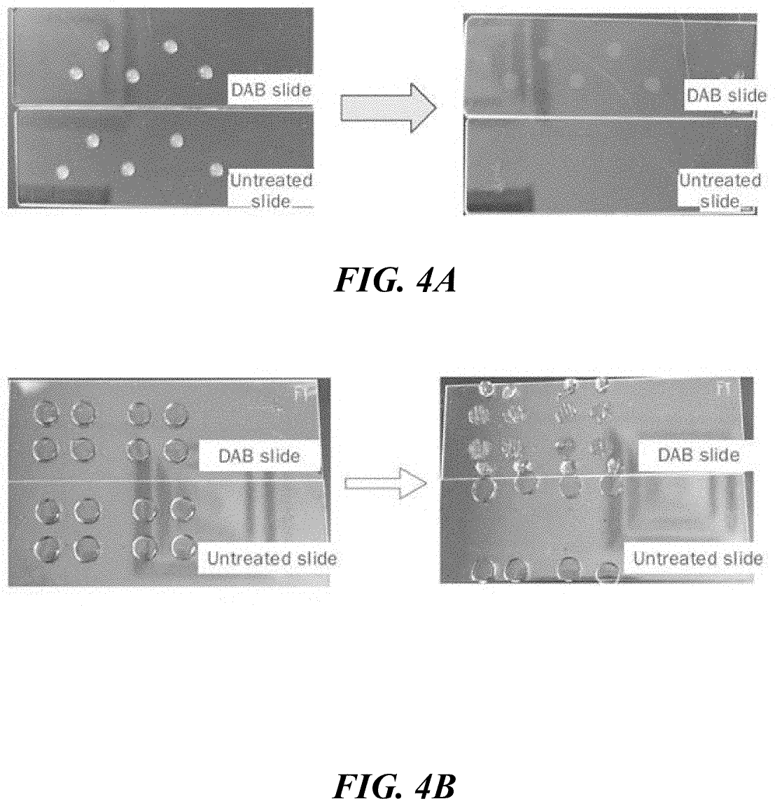

The double coating can comprise a methacryloxymethyltrimethoxysilane coating (e.g., using methacryloxymethyltrimethoxysilane as the matrix binding agent) for immobilizing a gel matrix and a (3-aminopropyl)triethoxysilane/bis-1,2-(triethoxysilyl)ethane (APES/BTESE) coating (e.g., using APES/BTESE as the sample binding agent) for immobilizing the sample via electrostatic interaction (FIG. 3). The methacryloxymethyltrimethoxysilane coating can be prepared on the support as discussed above. The APES can be used to functionalize the support with primary amine groups to provide positive surface charge. The dipodal silane BTESE can be used to enhance the hydrolytic stability of the APES coating. The APES/BTESE coating can be prepared after preparing the support with the first coating (e.g., a methacryloxymethyltrimethoxysilane coating). An example method of preparing a APES/BTESE coating can comprise providing a support. The support may comprise a first coating on the surface. Next, the support can be cleaned by sonicating in ethanol for at least about 1 minute, 2 minutes, 3 minutes, 4 minutes, 5 minutes, 6 minutes, 7 minutes, 8 minutes, 9 minutes, 10 minutes, 15 minutes or more. The support can then be dried. The support can be dried in the oven, for example, at a condition of at least about 50° C., 60° C., 70° C., 80° C., 90° C., 100° C., 110° C., 120° C., 130° C., 140° C., 150° C. or more. The support can be dried in the condition for at least about 10 minutes, 15 minutes, 20 minutes, 25 minutes, 30 minutes, 35 minutes, 40 minutes, 45 minutes, 50 minutes, 60 minutes or more. After being dried, the support can be soaked in a APES/BTESE solution for coating. The ratio of APES to BTESE in the APES/BTESE solution can be at least about 1:1, 2:1, 3:1 or more. The ratio of APES to BTESE in the APES/BTESE solution can be at most about 1:1, 1:2, 1:3 or less. The APES/BTESE solution can comprise at least about 0.5%, 1%, 1.2%, 1.5%, 1.8%, 2%, 2.2%, 2.5%, 2.8%, 3%, 3.5%, 4% or more APES/BTESE. The APES/BTESE solution can be prepared in EtOH/H2O (95%/5%). The pH of the APES/BTESE solution may be about 3, 4, 5, 6 or more. The support can be soaked (e.g., incubated) in the APES/BTESE solution at room temperature (e.g., 25° C.) for at least about 10 hours, 12 hours, 15 hours, 18 hours, 20 hours, 22 hours, 24 hours, 25 hours, 30 hours, or more. The incubation can be performed while gently shaking the support. Next, the support can be washed by sonicating in ethanol for at least about 10 seconds, 15 seconds, 20 seconds, 25 seconds, 30 seconds, 35 seconds, 40 seconds, 45 seconds, 50 seconds, 55 seconds, 1 minutes or more. The support can then be dried. The support can be dried in the oven, for example, at a condition of at least about 50° C., 60° C., 70° C., 80° C., 90° C., 100° C., 110° C., 120° C., 130° C., 140° C., 150° C. or more. The support can be dried in the condition for at least about 10 minutes, 15 minutes, 20 minutes, 25 minutes, 30 minutes, 35 minutes, 40 minutes, 45 minutes, 50 minutes, 60 minutes or more. The surface charge can be examined using a negatively charged polystyrene microspheres (FIG. 4A). The gel adhesion test can be used to verify the acrylate functionalization of methacryloxymethyltrimethoxysilane coated support (FIG. 4B).

FIG. 4A shows an example result of using the negatively charged polystyrene microspheres to verify the positive surface charge of the support coated with a double coating comprising a methacryloxymethyltrimethoxysilane coating and a APES/BTESE coating. The support was incubated in slightly acidic water having a pH of about 5 for about 3 min to ionize the primary amine on the coated surface of the support. The support was then dried at room temp. Diluted polystyrene bead solution (about 0.5 microns) was prepared. 5 μL of the diluted polystyrene bead solution was dropped on the support, and aspirated after about 1 minute. The support treated with the double coating had a white circular paint remaining uniformly on the surface of the support, while the untreated support did not have the paint remaining on the surface.

FIG. 4B shows an example result of using the gel adhesion test to verify the acrylate functionalization of the support coated with a double coating comprising a methacryloxymethyltrimethoxysilane coating and a APES/BTESE coating. In this example, polyacrylamide gel plugs were casted on the support comprising a methacryloxymethyltrimethoxysilane coating or untreated support in eight different areas. The gel plugs were peeled off with tweezer. The methacryloxymethyltrimethoxysilane treated support had gel residues remaining on the surface, while the untreated support had no or little gel residues.

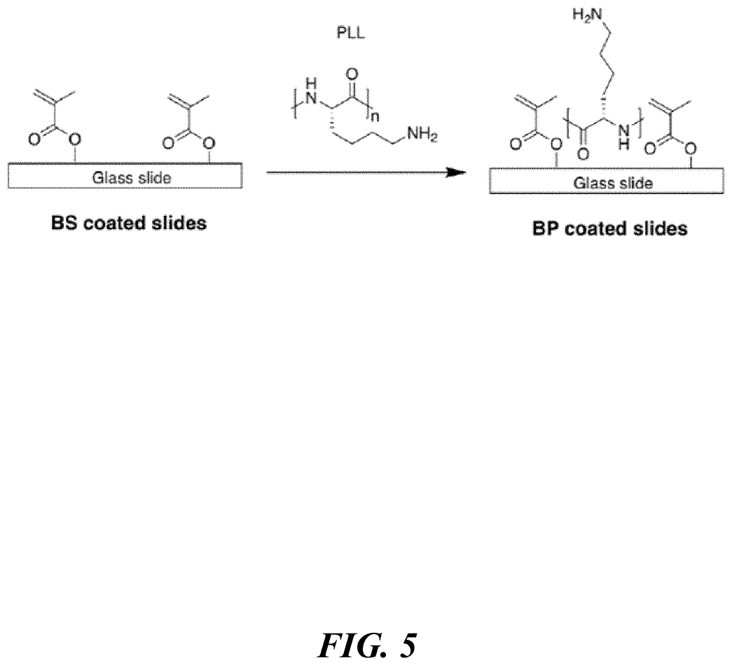

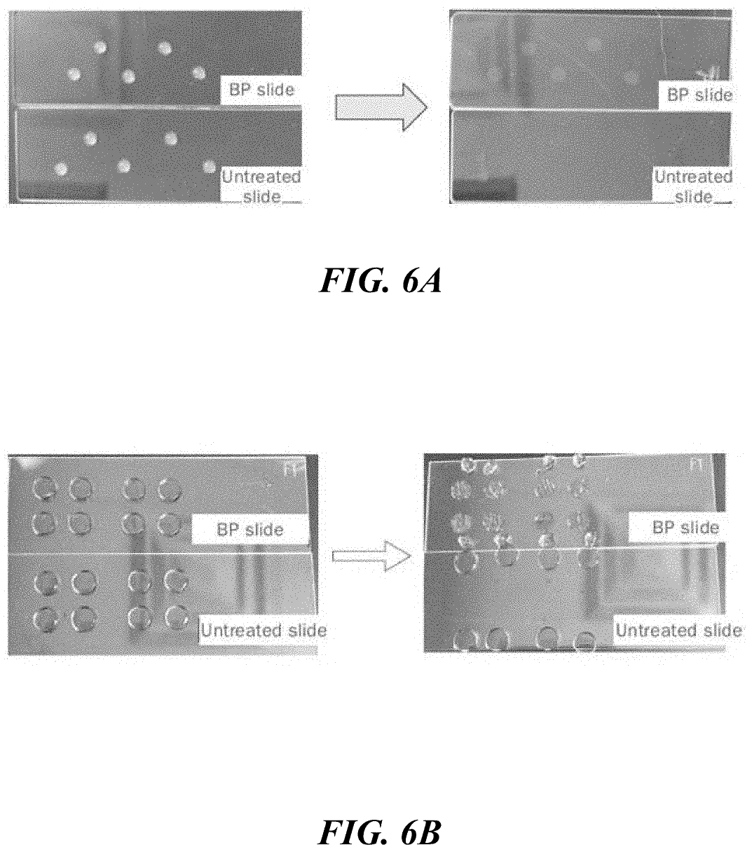

The support provided herein can comprise a double coating where the first coating can comprise the methacryloxymethyltrimethoxysilane for immobilizing the gel matrix and the second coating can comprise the poly-L-Lysine (PLL) for immobilizing a sample via electrostatic interaction (FIG. 5). PLL can be used to functionalize the support with primary amine groups to provide positive surface charge with strong hydrolytic stability. The first coating comprising the methacryloxymethyltrimethoxysilane can be prepared as discussed above. An example method of preparing a PLL coating can comprise providing a support. The support may comprise a first coating on the surface. Next, the support can be cleaned by sonicating in ethanol and dH₂O for at least about 1 minute, 2 minutes, 3 minutes, 4 minutes, 5 minutes, 6 minutes, 7 minutes, 8 minutes, 9 minutes, 10 minutes, 15 minutes or more. The support can then be dried. The support can be dried in the oven, for example, at a condition of at least about 50° C., 60° C., 70° C., 80° C., 90° C., 100° C., 110° C., 120° C., 130° C., 140° C., 150° C. or more. The support can be dried in the condition for at least about 10 minutes, 15 minutes, 20 minutes, 25 minutes, 30 minutes, 35 minutes, 40 minutes, 45 minutes, 50 minutes, 60 minutes or more. After being dried, the support can be soaked in a PLL solution for coating. The PLL solution can comprise at least about 0.01%, 0.05%, 0.1%, 0.5% 1%, 1.5%, 2%, 2.5%, 3%, 3.5%, 4% or more PLL. The support can be soaked (e.g., incubated) in the PLL solution at room temperature (e.g., 25° C.) for at least about 10 seconds, 20 seconds, 30 seconds, 40 seconds, 50 seconds, 1 minute, 2 minutes, 3 minutes, 4 minutes, 5 minutes or more. Next, the support can be washed by sonicating in ethanol for at least about 10 seconds, 15 seconds, 20 seconds, 25 seconds, 30 seconds, 35 seconds, 40 seconds, 45 seconds, 50 seconds, 55 seconds, 1 minutes or more. The support can then be dried. The support can be dried in the oven, for example, at a condition of at least about 10° C., 20° C., 30° C., 40° C., 50° C., 60° C., 70° C., 80° C., 90° C., 100° C., 110° C., 120° C., 130° C., 140° C., 150° C. or more. The support can be dried in the condition for at least about 10 minutes, 15 minutes, 20 minutes, 25 minutes, 30 minutes, 35 minutes, 40 minutes, 45 minutes, 50 minutes, 60 minutes, 70 minutes, 80 minutes, 90 minutes, 100 minutes or more. The surface charge can be examined using a negatively charged polystyrene microspheres (FIG. 6A). The gel adhesion test can be used to verify the acrylate functionalization of methacryloxymethyltrimethoxysilane coated support (FIG. 6B).

FIG. 6A shows an example result of using the negatively charged polystyrene microspheres to verify the positive surface charge of the support coated with a double coating comprising a methacryloxymethyltrimethoxysilane coating and a PLL coating. The support was incubated in slightly acidic water having a pH of about 5 for about 3 min to ionize the primary amine on the coated surface of the support. The support was then dried at room temp. Diluted polystyrene bead solution (about 0.5 microns) was prepared. 5 μL of the diluted polystyrene bead solution was dropped on the support, and aspirated after about 1 minute. The support treated with the double coating had a white circular paint remaining uniformly on the surface of the support, while the untreated support did not have the paint remaining on the surface.

FIG. 6B shows an example result of using the gel adhesion test to verify the acrylate functionalization of the support coated with a double coating comprising a methacryloxymethyltrimethoxysilane coating and a PLL coating. In this example, polyacrylamide gel plugs were casted on the support comprising a methacryloxymethyltrimethoxysilane coating or untreated support in eight different areas. The gel plugs were peeled off with tweezer. The methacryloxymethyltrimethoxysilane treated support had gel residues remaining on the surface, while the untreated support had no or little gel residues.

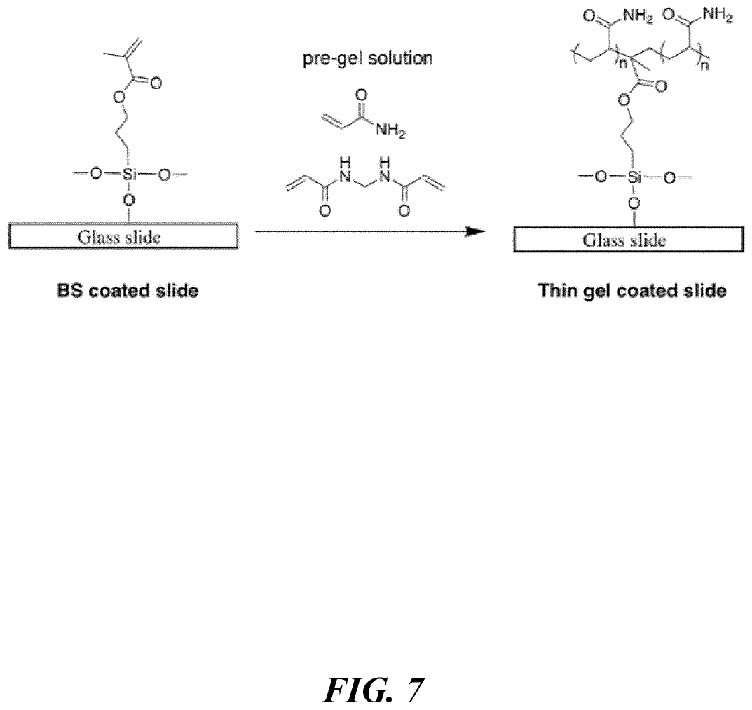

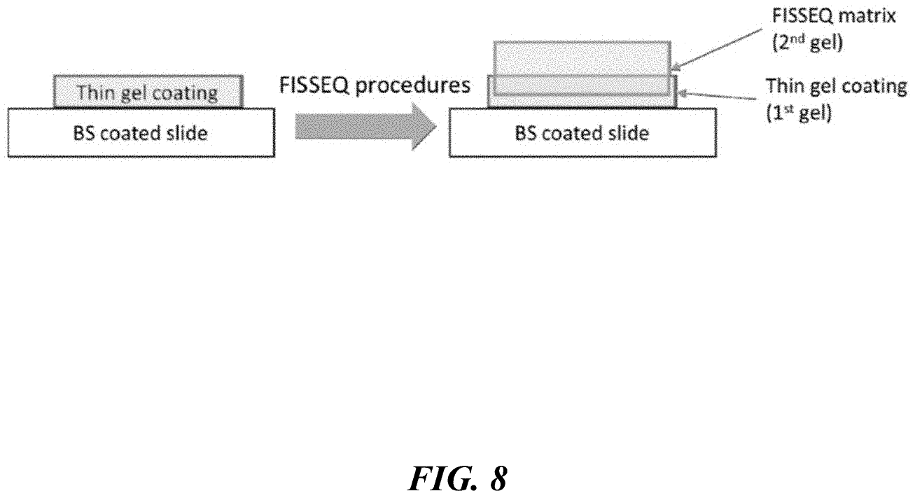

The support provided herein can comprise a double coating, where a first coating is used to immobilize the second coating. The second coating can immobilize both gel matrix and sample onto the support. In such cases, the matrix binding agent and the sample binding agent can be the same. The support provided herein can comprise a double coating where the first coating can comprise a methacryloxymethyltrimethoxysilane coating and the second coating can comprise a layer of hydrogel (e.g., thin gel coating) (FIG. 7). The layer of hydrogel can be thin. The layer of hydrogel can be at most about 300 μm, 250 μm, 200 μm, 150 μm, 100 μm, 80 μm, 50 μm, 40 μm, 30 μm, 20 μm, 10 μm, 5 μm, 1 μm or less. The thickness described throughout the disclosure can be measured when the hydrogel is wet or fully hydrated unless it is otherwise indicated to be dried. The first coating can be used to immobilize the second coating, where the second coating can be used to immobilize both the 3D matrix and the sample. For example, the methacryloxymethyltrimethoxysilane coating can be used to immobilize the layer of hydrogel onto the support, and the layer of hydrogel can immobilize the 3D matrix via interpenetrating network and the sample via hydrogen bonding and/or Van der Waals interaction. FIG. 8 shows a schematic of the interaction between the thin gel (e.g., 1st gel in FIG. 8) and the 3D matrix (e.g., 2nd gel in FIG. 8). The thin gel coating may provide strong adhesion of the 3D matrix (e.g., the gel matrix used for embedding the sample during FISSEQ) through interpenetrating network. The thin gel coating and the 3D matrix can be formed by the same or different gel-forming materials. The thin gel coating may have a thickness that is smaller than that of the 3D matrix. The 3D matrix can be at least about 100 μm, 150 μm, 200 μm, 250 μm, 300 μm, 350 μm, 400 μm, 450 μm, 500 μm or more.

The first coating comprising the methacryloxymethyltrimethoxysilane can be prepared using the methods discussed above. An example method of preparing the thin gel coating can comprise providing a support comprising a methacryloxymethyltrimethoxysilane coating. Next, a sample cassette can be assembled on the support such that a well can be formed around the surface area for coating the thin gel. A gel solution containing beads can be prepared. The beads can have a pre-determined size in order to control the thickness of the thin gel. The size of the beads can be at most about 300 μm, 250 μm, 200 μm, 150 μm, 100 μm, 80 μm, 50 μm, 40 μm, 30 μm, 20 μm, 10 μm, 5 μm, 1 μm or less. A small amount of the gel solution (about 5 μL, 10 μL, 15 μL, 20 μL or more) can be added to the well to cover the exposed surface area. A cap can be applied on top of the well filled with the gel solution such that a surface of the cap can touch and press the gel solution into certain thickness. The support casted within the sample cassette can then be incubated at 37° C. for at least about 20 minutes, 30 minutes, 40 minutes, 50 minutes, 60 minutes, 70 minutes, 80 minutes, 90 minutes, 100 minutes or more for gelation. The cap can be removed after gelation. The thin gel coating can then be dried at 40° C., 45° C., 50° C., 55° C., 60° C., 65° C. or more. The thin gel coating can be dried at the temperature for at least about 20 minutes, 30 minutes, 40 minutes, 50 minutes, 60 minutes, 70 minutes, 80 minutes, 90 minutes, 100 minutes or more. The gel adhesion test can be used to verify the bonding between the thin gel coating and the support.

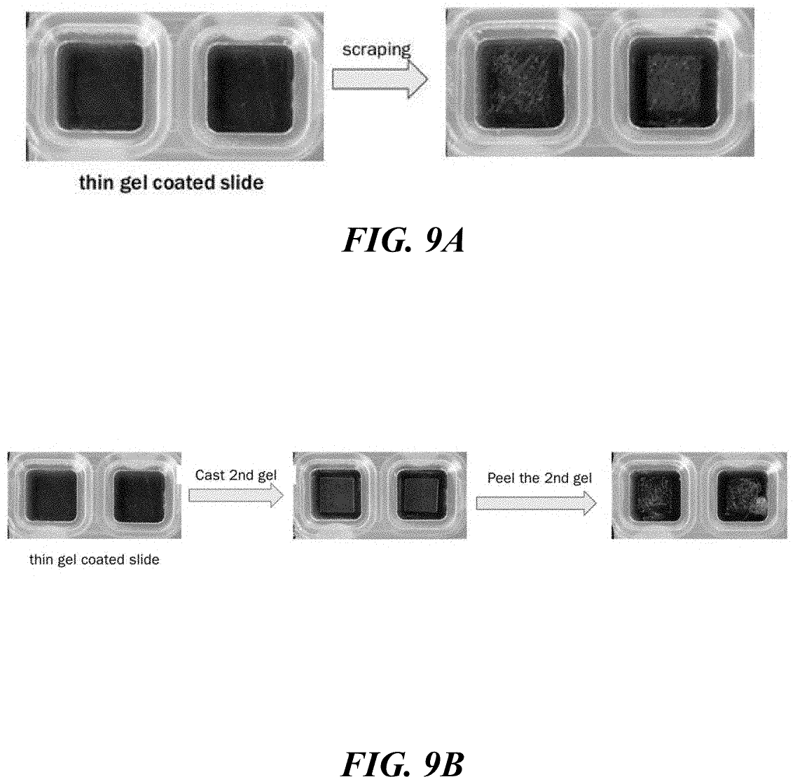

FIG. 9A shows an example result of the gel adhesion test. The thin gel layer was scraped by vacuum tip. The support coated with the thin gel coating had gel residues remaining uniformly on the surface. FIG. 9B shows an example result of the gel adhesion test used to examine the bonding between the thin gel coating and the 3D matrix. The thin gel coated support had gel residues remaining on the support after scraping, indicating strong interaction between the thin gel coating and the 3D matrix gel.

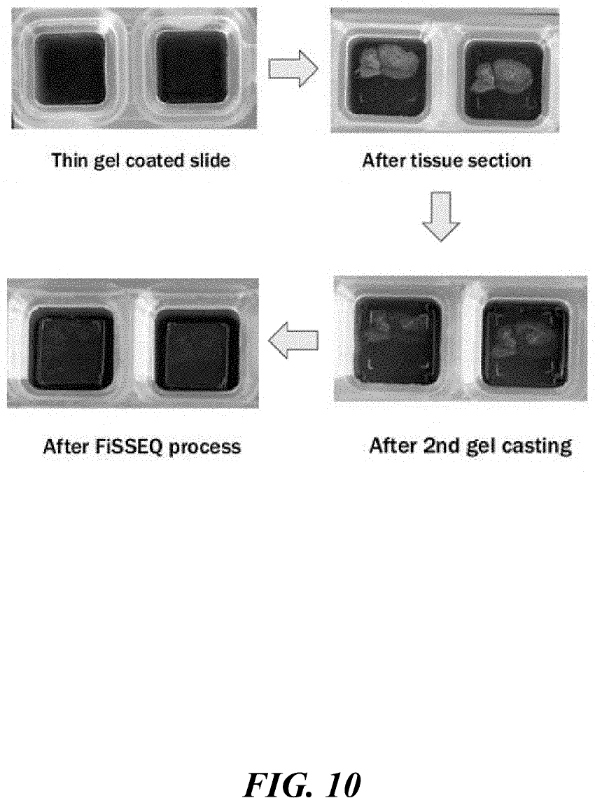

The thin gel coated support can be used for tissue section (where the tissue can be adhered via combination of hydrogen bonding and/or Van der Waals interactions). The thin gel coated support may be charged for electrostatic interactions with the tissue section, such as by absorption of a charged substance (e.g., poly(L)-lysine) or co-functionalization of the hydrogel matrix by the inclusion of an amino-acrylate monomer in the gel solution. As an example, FIG. 10 shows that the 3D matrix (with a mouse brain frozen tissue) can be strongly and stably adhered on the thin gel coated support throughout the FISSEQ process.

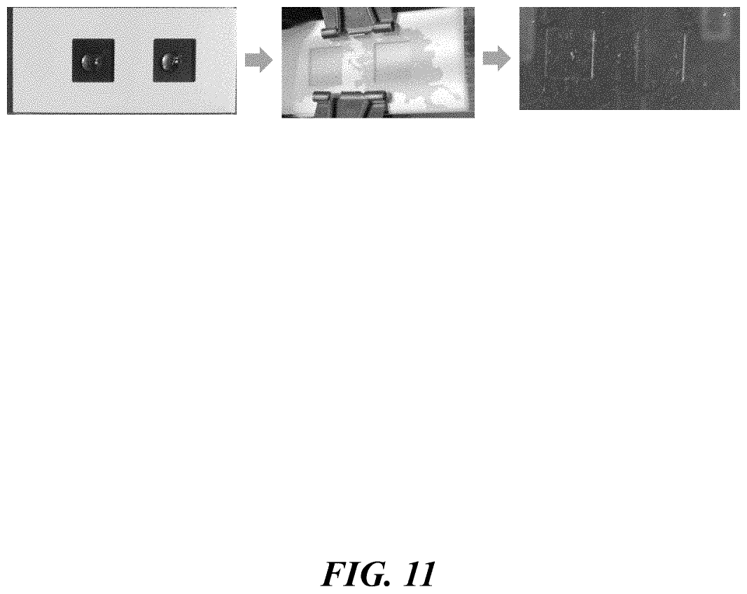

Various other methods can be used to control the thickness of the thin gel coating. In some cases, the thickness of the thin gel coating can be controlled by spin coating, where a drop of gel solution can be placed on the surface and the support can be spun, causing the drop to spread into a thin layer. In some cases, the thickness of the thin gel coating can be controlled by a mask (e.g., an adhesive mask) (FIG. 11). The mask can function as a protecting film for the sample (e.g., a tissue section) and can also function as a spacer to prepare a hydrogel coating with a thickness of at least about 50 microns, 60 microns, 70 microns, 80 microns, 90 microns, 100 microns, 110 microns, 120 microns, 130 microns, 140 microns, 150 microns or more. FIG. 11 shows an example workflow of using the mask for controlling the thickness of the thin gel coating. The mask can be applied onto the support without masking certain surface area such that a well is formed at the exposed surface area for sample processing. A small amount (e.g., 5 μL, 10 μL, 15 μL, 20 μL or more) of gel solution can be added into the well and spread to cover the well. Then the gel solution can be incubated for gelation. Examples of formed gel coatings are shown in FIG. 11.

The coated or functionalized support can be used for sample processing such as sectioning. For example, the support can be used to hold a tissue section on the surface of the support (e.g., sample placement), and then the tissue section can be fixed and/or permeabilized on the surface.

The coated support may include additional features for automated determination of spatial positioning of the solid support, or of the interface between the thin gel and tissue-co-support 3D matrix, which can determine the lower axial bound of the specimen as it resides on the thin gel or coating. Features for automated determination of spatial positioning can include optical features for detection, coupled with computer vision algorithms for localizing the feature. Optical features can include the placement of fiducial marks, such as fluorescent beads, nanodiamonds, quantum dots, and other fiducial markers, cognate to the surface of the coated support, e.g., the top of the thin gel. Fiducial marks may be localized to certain designated areas of the sample slide for automated detection. Other optical features can include refractive index changes between the thin gel and supporting 3D matrix, which can be detectable. Optical features can include gel-based features, which can be formed during polymerization of the gel, such as by relief casting. Other optical features can include features of or on the surface of the thin gel, which can be detectable using a light source and a photo-detector, such as the inclusion of fluorescent moieties in the thin gel, which can be temporally or spectrally separate from the fluorescent signals detected during FISSEQ. Alternatively, the thin gel may comprise detectable labels, which can be detected prior to FISSEQ detection, for the purpose of determining the surface of the thin gel. Such detectable labels can include probable moieties, such as DNA oligonucleotides, peptides, and other epitopes which may be fluorescently labeled, such as by sequencing, in particular sequencing by hybridization, for the purpose of labeling the thin gel matrix for the purpose of determining the location of, or mapping, the interface between the thin gel and the tissue and encapsulating matrix in 3D space. During to or prior to FISSEQ detection, the spatial sequencing instrumentation may be automated for acquiring data to determine the spatial organization of the sample upon the support.

The support of the present disclosure may be fashioned into a variety of shapes. In certain embodiments, the support is substantially planar. Examples of support include plates, slides, multiwell plates, flow cells, coverslips, microchips, containers, microcentrifuge tubes, test tubes, tubing, sheets, pads, films. Additionally, the support may be, for example, biological, non-biological, organic, inorganic, or a combination thereof. Example types of materials for the support include glass, modified glass, functionalized glass, inorganic glasses, microspheres, including inert and/or magnetic particles, plastics, polysaccharides, nylon, nitrocellulose, ceramics, resins, silica, silica-based materials, carbon, metals, an optical fiber or optical fiber bundles, a variety of polymers other than those exemplified above and multiwell plates. Example types of plastics include, but are not limited to, acrylics, polystyrene, copolymers of styrene and other materials, polypropylene, polyethylene, polybutylene, polyurethanes and Teflon™. Example types of silica-based materials include, but are not limited to, silicon and various forms of modified silicon. Surface of the support can be varied in their shape depending on the application in a method described herein. For example, a surface useful in the present disclosure can be planar, or contain regions which are concave or convex.

### Masks

The support of the device for sample holding, sample processing or analysis can be covered, at least partially, by a mask. The mask can be a removable mask.

The coated or functionalized support described above can be used to for sample processing such as sectioning and then assembled into a sample cassette for further use. However, the residues of parafilm or optical temperature compound (OTC) from samples such as FFPE or fresh frozen tissue sections on the coated or functionalized support may be hard to be washed away completely, causing leakage of the sample cassette during sample processing or other downstream procedures. Applying a mask (e.g., a film) on the support before sectioning to cover the cassette sealing area and peeling off the mask after sectioning may prevent the leakage. The mask can expose certain surface areas for sample placement. The mask can protect surface areas for sample cassette assembly to keep them clean such that a non-leaking seal can be formed. Fixtures can be used to guide mask placement such that the mask can be placed accurately on the support. The mask placement can be performed automatically by a machine.

The mask can be a non-sticking mask, a film, an adhesive coating or soft material. For example, the material for the mask can be silicone or rubber. The mask can be or be substantially impermeable to formaldehydes, waxes, polyolefins, alcohols or glycols. The mask can have a chemical compatibility with an agent used during FFPE deparaffinization processes. For example, the mask can be chemically compatible with xylene, histoclear, and/or alcohols. The mask can be attached to the support using an adhesive.

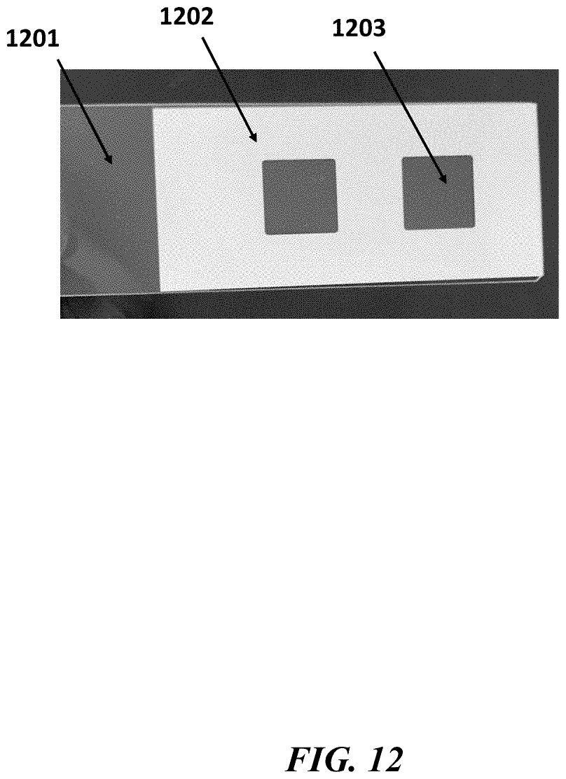

FIG. 12 shows an example of the masked support. In this example, a non-sticking mask (1202) is applied onto a sample slide (1201) to cover some surface areas of the sample slide. Two exposed surface areas (1203) can be used for sample placement and processing. In some cases, there may be only one exposed area for sample placement and processing. In some cases, there may be two or more exposed areas.

### Sample Cassettes

The device for sample holding, sample processing or analysis can further comprise a removable boundary. The removable boundary can be attached to a surface of the support, where the removable boundary can comprise a side wall and the surface of the support and the removable boundary can form a well (e.g., a sample well). The removable boundary can be attached to the surface of the support with an adhesive, where the adhesive can form a seal between the removable boundary and a surface of the support.

The removable boundary can be a sample cassette. The sample cassette can be used to cover certain areas of the support. The support can be assembled into the sample cassette. The support may comprise one or more coatings. The support may comprise a sample immobilized (e.g., fixed and/or permeabilized) onto the surface before assembling into the sample cassette. The support may have a mask on its surface to cover certain surface areas. Before assembling the sample cassette, the mask can be peeled off to expose the support entirely and then the support can be assembled into the sample cassette.

The support can comprise a sample binding area (e.g., a sample well). The sample binding area may be exposed. The sample binding area may not be covered by the mask. The sample binding area may not be covered when the support is assembled into the sample cassette. The sample binding area can be identified with a visible marking. The sample binding area can be partially or fully transparent. The support or the sample cassette can comprise a machine-readable identification tag. The machine-readable identification tag can provide the device with a unique identifier. The machine-readable identification tag can identify a sample attached to the device. The machine-readable identification tag can provide a system preparing or analyzing a sample attached to the device with instructions for preparing or analyzing the sample. The machine-readable identification tag can comprise a barcode, an electromagnetic tag or any other identifying mark. The machine-readable identification tag can comprise a 2D barcode. The machine-readable identification tag can comprise a quick response (QR) code, a data matrix (e.g., ECC200), a radio-frequency identification (RFID) tag, or a near-field communication (NFC) chip. The support can comprise at least one marker (e.g., a fiducial marker) to facilitate sample placement or registration. The sample binding area of the support can comprise at least one fiducial marker. The fiducial marker can be a laser-cut (e.g., laser-ablated or laser-engraved) register. The fiducial marker can aid in sample placement, human registration of the slide, machine registration of the slide, optical alignment, and/or software-based alignment. The sample binding area of the support can comprise at least one fiducial marker to mark the sample binding area. The fiducial marker can be viewed by various methods. For example, the support (e.g., a glass slide) can be lit from a side by a light source, such as by a LED. When light strikes the laser-cut fiducial marker, the light can be scattered upward into a light path for detection by a detector (e.g., a photodetector), such as a camera optical system. In such cases, the support can function as a wave guide, resulting in light striking the fiducial markers from the side and being scattered upward into the light path. The depth, engraving pattern (or ablation pattern), and/or characteristics of the engraving can be optimized to provide the light catching and scattering characteristics.

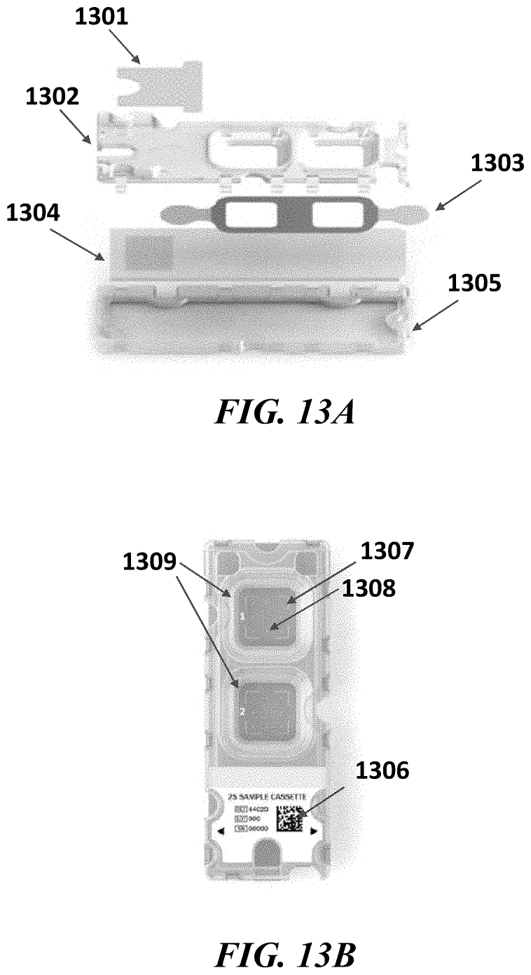

FIG. 13A shows a schematic of assembling the sample cassette. The support 1304 (e.g., a glass slide) can be placed in between a top piece of the sample cassette 1302 and a bottom piece 1305. A double-sided tape 1303 can be placed in between the top piece 1302 and the support 1304 to facilitate assembly such that the support 1304 can be securely sandwiched in between the top piece 1302 and the bottom piece 1305. The sample cassette may further comprise an information piece 1301 with information related to the sample cassette printed on top. The information piece 1301 can have a machine-readable identification tag such as a radio-frequency identification (RFID) tag storing information related to sample processing and/or analysis. For example, sequencing protocols or read length information can be stored in the RFID and later be read when the sample cassette is used on devices described herein. FIG. 13B shows an assembled sample cassette with the support sandwiched in between the top piece and the bottom piece of the sample cassette. The sample cassette can have an RFID tag 1306. The support within the assembled sample cassette can have corner marks 1307 to mark the sample area and laser-cut registers 1308 for positioning when the sample cassette is used on the devices described herein. Two sample wells 1309 can be generated on the support.

### Passivation

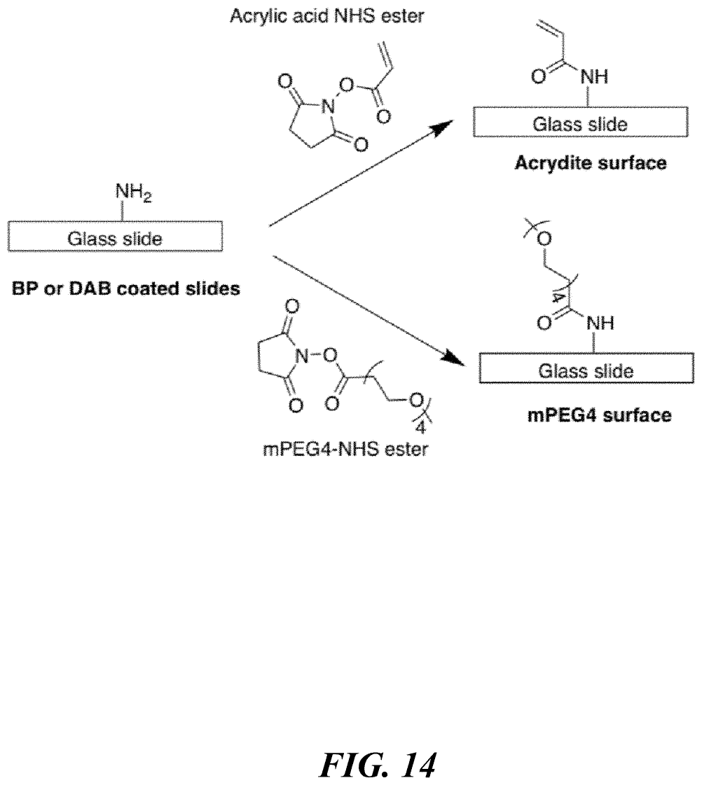

The support can be functionalized with primary amines to promote tissue adhesion via electrostatic interaction. For example, APES/BTESE coating and PLL coating discussed above can provide primary amines. However, after sectioning, the residual positive charges on the coated or functionalized support may cause accumulation of negative charged nucleotides or oligonucleotides on the surface and inhibition of enzyme activity. The surface can be passivated to remove or reduce the positive charges on the surface. An example of passivation includes using an n-hydroxysuccinimide (NHS)-amine chemistry to neutralize the primary amines, resulting in a neutral surface (FIG. 14). In addition, different surface functionality can be achieved via different NHS ester based passivation reagents. Both acrylic acid NHS ester and mPEG4-NHS ester can react with the primary amine and result in a neutral surface. The acrylic acid NHS ester can functionalize the surface with acrydite groups, which can participate following free radical polymerization of gelation to further facilitate immobilization of the 3D matrix on the support. The mPEG4-NHS ester can result in mPEG functionalized surface, which can be hydrophilic and resistant to nonspecific adsorption of nucleotides and proteins.

An example passivation method can comprise preparing a passivation reagent 10× stocking solution (e.g., an NHS ester) by reconstitution of the passivation reagent in anhydrous DMSO at a concentration of at least about 50 mg/mL, 60 mg/mL, 70 mg/mL, 80 mg/mL, 90 mg/mL, 100 mg/mL, 120 mg/mL, 150 mg/mL or more. Next, the passivation reaction solution can be prepared by diluting the stocking solution to 1× in 2× borate buffer. The support can be incubated in the passivation reaction solution for at least about 20 minutes, 25 minutes, 30 minutes, 35 minutes, 40 minutes, 45 minutes, 50 minutes, 55 minutes, 60 minutes, 65 minutes, 70 minutes, 75 minutes, 80 minutes, 85 minutes, 90 minutes, 95 minutes, 100 minutes or more at room temperature. After incubation, the reaction solution can be aspirated and the support can be washed with PB ST.

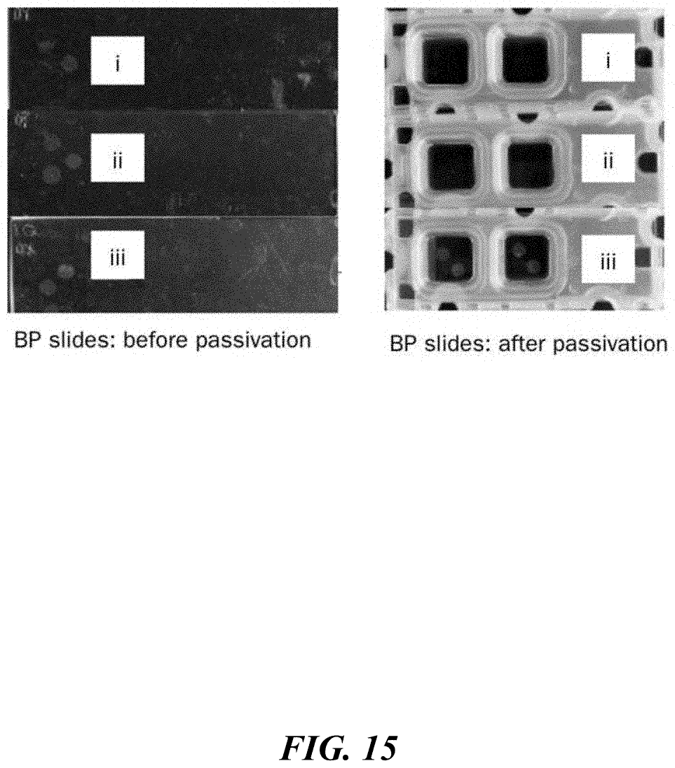

FIG. 15 shows an example result of charge passivation. In this example, the supports used have been coated with a double coating comprising a methacryloxymethyltrimethoxysilane coating and a PLL coating. The supports were then treated with acrylic acid NHS ester (i), mPEG-NHS ester (ii) and 2× borate buffer as negative control (iii). The initial positively charged support, as indicated by the white paint of polystyrene beads, became neutral (no polystyrene beads) after passivation (i and ii), while the negative control (iii) remained positively charged.

### Methods of Using the Devices

The devices described herein can be used for holding a sample. The sample can be further processed or analyzed while attached to the support of the device. An example method of using the device can comprise providing a support such as a glass slide. The support may be pre-treated with the double coatings for immobilizing a 3D matrix and a sample. The support may comprise laser cut registers and/or markers for the sample binding area. A mask can be put onto the support to protect non-sample binding area. Next, a sample can be retained on the sample binding area of the support. For example, a tissue sample can be fished out using the support during tissue sectioning. The sample can be then fixed and/or permeabilized. Next, the mask can be peeled off from the support. The support can then be assembled into a sample cassette. The assembly can comprise sandwiching the support in between a bottom layer and a top layer of the sample cassette, and using double-sided tape to seal top layer and the support. The already masked support and sample cassette can be provided to users, and the users can assemble the support into the sample cassette. Next, a matrix-forming material can be put onto the sample in the sample wells on the support and polymerized in an oxygen-free environment, for example, under vacuum or argon.

The devices for sample holding or processing can be used in conjunction with the systems described herein.

The methods described here can be used to analyze a sample (e.g., a biological sample). The method can comprise attach a sample to the sample binding agent of the device described herein. Next, the sample attached to the sample binding agent of the device can be contacted with a matrix-forming material. The matrix-forming material can be a polymeric material described herein. For example, the matrix-forming material can comprise acrylamide. The acrylamide can be propargyl acrylamide. The matrix-forming material can further comprise a crosslinker. The crosslinker can be N,N′-methylenebisacrylamide (BIS), piperazine diacrylate (PDA), N,N′-bisacrylylcystamine (BAC), or N,N′-diallyltartardiamide (DATD). The matrix-forming material may further comprise an activator or an inhibitor. The activator or inhibitor can control a rate of polymerization of the matrix-forming material. The method can further comprise generating a synthetic 3D matrix from the matrix-forming material. The synthetic 3D matrix can be generated comprises polymerizing or crosslinking the matrix-forming material. The generation of the synthetic 3D matrix from the matrix-forming material can be performed in an oxygen-free environment. The synthetic 3D matrix can be attached to the matrix binding agent of the device described herein. Attachment of the synthetic 3D matrix to the matrix binding agent can comprise crosslinking the synthetic 3D matrix to the matrix binding agent. The crosslinking can comprise physical crosslinking or chemical crosslinking. The crosslinking can comprise free-radical polymerization, chemical conjugation, or bioconjugation reactions. The crosslinking can comprise photopolymerization. The photopolymerization can be initiated by single-photon or multiphoton excitation systems. The photopolymerization can be initiated by manipulation of light to form specific two-dimensional (2D) or 3D patterns. The photopolymerization can be initiated by a spatial light modulator. The spatial light modulator can comprise a digital spatial light modulator. The spatial light modulator can employ a transmissive liquid crystal, reflective liquid crystal on silicon (LCOS), digital light processing, or a digital micromirror device (DMD). The synthetic 3D matrix can comprise a polymeric material. The synthetic 3D matrix can comprise an additional polymeric material crosslinked to the polymeric material. The polymeric material can comprise polyacrylamide, poly-ethylene glycol (PEG), poly(acrylate-co-acrylic acid) (PAA) or poly(N-isopropylacrylamide) (NIPAM). The synthetic 3D matrix can expand. A 3D map of the sample can be obtained while the sample is on the device described herein. The 3D map can comprise a 3D map of a plurality of nucleic acid sequences present in the sample. A FISSEQ protocol can be performed on the sample. At least a portion of the method can be performed by a system described herein.

### Three-Dimensional Matrix

The fluorescent in situ sequencing (FISSEQ) can use a three-dimensional (3D) matrix to embed a sample for analysis. The 3D matrix can be used to preserve an absolute or relative 3D position of one or more analytes within the sample. The 3D matrix can preserve an absolute or relative 3D position of a plurality of nucleic acid molecules. The 3D matrix can be a gel matrix. The 3D matrix can be a hydrogel matrix. The FISSEQ procedure, from embedding the sample within the 3D matrix to the sequencing or detection, can be performed on the devices described herein. For example, the FISSEQ procedure can be performed after assembling the support with the sample immobilized on the surface into the sample cassette. The devices can be designed to be used manually or automatically for reagent exchanges. The FISSEQ procedure may comprise embedding a sample within a 3D matrix, immobilizing an analyte or derivative thereof to the 3D matrix, amplifying the analyte or derivative thereof to generate amplification products localized to the position of the original analyte, detecting the amplification products within the 3D matrix. The detection can comprise hybridizing detection probes with the amplification products or sequencing the amplification products. The detection can comprise imaging the sample volumetrically through the three-dimensional space. Some or all of the FISSEQ procedure can be performed automatically on a machine.

In some cases, a matrix-forming material may be used to form the 3D matrix. The matrix-forming material may be polymerizable monomers or polymers, or cross-linkable polymers. The matrix-forming material may be polyacrylamide, acrylamide monomers, cellulose, alginate, polyamide, agarose, dextran, or polyethylene glycol. The matrix-forming materials can form a matrix by polymerization and/or crosslinking of the matrix-forming materials using methods specific for the matrix-forming materials and methods, reagents and conditions. The matrix-forming material may form a polymeric matrix. The matrix-forming material may form a polyelectrolyte gel. The matrix-forming material may form a hydrogel gel matrix.

To generate the 3D matrix on the sample device, a gel solution comprising the matrix-forming material can be added into the sample wells (see e.g., 1309 of FIG. 13B). A cap can be applied on top of the gel solution within the sample well such that a surface of the cap can touch and press the gel solution into certain thickness. The cap can have a surface with protrusions (e.g., protruded feet) to control the thickness of the gel. The protrusions can be designed to exclude gel solution from an area, for example, where aspiration may occur or where the surface of the support may need to be clear from the gel. The protrusions can be located at the four corners of the cap. The protrusions can be used to create areas on the sample device amenable to automated fluidic dispense and/or aspiration without disrupting the overall matrix. The surface area of the cap that is in contact with the gel solution can be flat or have a low surface roughness value. The area of the cap that is in contact with the gel solution can be processed by various methods to have a surface finish of a low surface roughness value. The methods include, but are not limited to, grinding (abrasive cutting), polishing, lapping, abrasive blasting, honing, electrical discharge machining (EDM), milling, lithography, industrial etching/chemical milling, laser texturing, or other processes. While the cap is on the gel solution, the sample cassette can be incubated at 37° C. for at least about 20 minutes, 30 minutes, 40 minutes, 50 minutes, 60 minutes, 70 minutes, 80 minutes, 90 minutes, 100 minutes or more for gelation. The sample cassette can be incubated in an oxygen-free environment such as under vacuum or in argon. The cap can be removed after gelation. The thickness of the 3D matrix can be at least about 30 um, 50 um, 100 μm, 150 μm, 200 μm, 250 μm, 300 μm, 350 μm, 400 μm, 450 μm, 500 μm or more. Additional reagents (e.g., buffers or probes) may be added into the sample wells to further process the sample. Excess reagents can be aspirated from the corners of the sample wells.

The matrix-forming material may form a 3D matrix including the plurality of nucleic acids while maintaining the spatial relationship of the nucleic acids. In some cases, the plurality of nucleic acids can be immobilized within the matrix material. The plurality of nucleic acids may be immobilized within the matrix material by co-polymerization of the nucleic acids with the matrix-forming material. The plurality of nucleic acids may also be immobilized within the matrix material by crosslinking of the nucleic acids to the matrix material or otherwise cross-linking with the matrix-forming material. The plurality of nucleic acids may also be immobilized within the matrix by covalent attachment or through ligand-protein interaction to the matrix.

In some cases, the matrix can be porous thereby allowing the introduction of reagents into the matrix at the site of a nucleic acid for amplification of the nucleic acid. A porous matrix may be made according to various methods. For example, a polyacrylamide gel matrix can be co-polymerized with acrydite-modified streptavidin monomers and biotinylated DNA molecules, using a suitable acrylamide:bis-acrylamide ratio to control the cross-linking density. Additional control over the molecular sieve size and density can be achieved by adding additional cross-linkers such as functionalized polyethylene glycols.

In some cases, the 3D matrix may be sufficiently optically transparent or may have optical properties suitable for standard sequencing chemistries and deep three-dimensional imaging for high throughput information readout. Examples of the sequencing chemistries that utilize fluorescence imaging include ABI SoLiD (Life Technologies), in which a sequencing primer on a template is ligated to a library of fluorescently labeled octamers with a cleavable terminator. After ligation, the template can then be imaged using four color channels (FITC, Cy3, Texas Red and Cy5). The terminator can then be cleaved off leaving a free-end to engage in the next ligation-extension cycle. After all dinucleotide combinations have been determined, the images can be mapped to the color code space to determine the specific base calls per template. The workflow can be achieved using an automated fluidics and imaging device (e.g., SoLiD 5500 W Genome Analyzer, ABI Life Technologies). Another example of sequencing platform uses sequencing by synthesis, in which a pool of single nucleotide with a cleavable terminator can be incorporated using DNA polymerase. After imaging, the terminator can be cleaved and the cycle can be repeated. The fluorescence images can then be analyzed to call bases for each DNA amplicons within the flow cell (HiSeq, Illumina).

The 3D matrix can be a hydrogel matrix. The 3D matrix can be a polyacrylamide hydrogel matrix. The sample (e.g., a cell or tissue) can be embedded in a polyacrylamide hydrogel matrix via free radical polymerization. To form the polyacrylamide hydrogel matrix, the matrix-forming material comprising a plurality of acrylamide monomers may be used to prepare a gel solution. The acrylamide monomers concentration in the gel solution can be at least 1%, 1.5%, 2%, 2.5%, 3%, 3.5%, 4%, 4.5%, 5%, 5.5%, 6%, 6.5%, 7%, 7.5%, 8%, 8.5%, 9%, 9.5%, 10% or more. The matrix-forming material may further comprise propargyl acrylamide, which can be used to tether azide-DNA via click chemistry. The propargyl acrylamide concentration in the gel solution can be at least 0.02%, 0.04%, 0.06%, 0.08%, 0.1%, 0.12%, 0.14%, 0.16%, 0.18%, 0.2%, 0.4%, 0.6%, 0.8% or more. The matrix-forming material can further comprise a crosslinker, which can crosslink the polyacrylamide monomers to form the network. Various crosslinkers can be used. Examples of crosslinkers include, but are not limited to, N,N′-methylenebisacrylamide (BIS), piperazine diacrylate (PDA), N,N′-bisacrylylcystamine (BAC), and N,N′-di allyltartardiamide (DATD). In some cases, the crosslinkers can comprise BIS. The ratio of acrylamide to BIS in the gel solution can be at least about 5:1, 6:1, 7:1, 8:1, 9:1, 10:1, 11:1, 12:1, 13:1, 14:1, 15:1, 16:1, 17:1, 18:1, 19:1, 20:1, 21:1, 22:1, 23:1, 24:1, 25:1 or more. In some cases, the crosslinkers can comprise PDA and DATD. The ratio of acrylamide:PDA:DATD can be at least about 5:1:1, 6:1:1, 7:1:1, 8:1:1, 9:1:1, 10:1:1, 11:1:1, 12:1:1, 13:1:1, 14:1:1, 15:1:1, 16:1:1, 17:1:1, 18:1:1, 19:1:1, 20:1:1, 21:1:1, 22:1:1, 23:1:1, 24:1:1, 25:1:1 or more. Alternatively, the ratio of acrylamide:PDA:DATD can be at least about 5:1:2, 6:1:2, 7:1:2, 8:1:2, 9:1:2, 10:1:2, 11:1:2, 12:1:2, 13:1:2, 14:1:2, 15:1:2, 16:1:2, 17:1:2, 18:1:2, 19:1:2, 20:1:2, 21:1:2, 22:1:2, 23:1:2, 24:1:2, 25:1:2 or more. The 3D matrix can be expandable or rigid. The gel solution can comprise activators or inhibitors, which can affect polymerization rate and permeabilization of the sample. For example, the gel solution can comprise ammonium persulfate (APS), which can function as free radical polymerization initiator. The concentration of APS in the gel solution can range from 0.01% to 0.5%. In some cases, the concentration of APS in the gel solution can be at least about 0.05%, 0.1%, 0.2%, 0.5% or more. The gel solution can further comprise tetramethylethylenediamine (TEMED), which can promote APS initiation. The concentration of TEMED in the gel solution can range from 0.01% to 0.5%. In some cases, the concentration of APS in the gel solution can be at least about 0.05%, 0.1%, 0.2%, 0.5% or more. The gel solution can comprise an inhibitor such as 4-hydroxy-2,2,6,6-tetramethylpiperidin-1-oxyl (4-hydroxy-TEMPO). The inhibitor can delay gelation, allowing longer permeabilization of the sample. The concentration of the inhibitor in the gel solution can be at most about 0.1%, 0.08%, 0.05%, 0.02%, 0.01% or less.

Oxygen can be everywhere at ambient environment, both in the gel solution and in the air during gelation. Oxygen may lead to polymerization inhibition such as causing incompletion and irreproducibility of gelation. Oxygen may form reactive oxygen species (ROS) which can cause DNA damages. Methods can be used to reduce or remove oxygen in solutions. For example, solutions can be degassed in a vacuum and/or be treated with argon bubbling to remove dissolved oxygen. Solutions can be subject to oxygen-scavenging materials or reactions, such as ferrous carbonate and a metal halide catalyst, or by enzymes such as glucose oxidase. Polymerization under argon or vacuum protection can avoid oxygen during gelation.

The gel solution can be degassed in a large volume and later be aliquoted into small volumes for storage. An example procedure of forming the 3D matrix can comprise preparing a large volume (e.g., 10-20 mL) of gel solution without the activator. The gel solution can be degassed under vacuum for at least about 5 minutes, 10 minutes, 15 minutes, 20 minutes, 25 minutes, 30 minutes or more. The dissolved oxygen can then be removed by argon bubbling for at least about 5 minutes, 10 minutes, 15 minutes, 20 minutes, 25 minutes, 30 minutes or more. The deoxygenated gel solution can be aliquoted into 500 μL fractions under argon protection, and stored at −20° C. During gelation, an aliquot of the gel solution can be thawed at room temperature. The activator (e.g., APS and TEMED) can be added into the thawed gel solution. Next, a small amount of the activated gel solution can be added into the well of the device. A cap can be added on top of the gel solution within the well such that a flat surface of the cap can touch and press the gel solution to control the thickness of the gel. The sample cassette can be transferred into a humidified dish. The humidified dish can be transferred into a sample bag, which can then be filled with argon for protection. The humidified dish can be incubated at 37° C. for at least 20 minutes, 30 minutes, 40 minutes, 50 minutes, 60 minutes, 70 minutes, 80 minutes, 90 minutes or more for polymerization.

### Systems for Sample Processing or Analysis

The present disclosure provides a system for sample analysis such as nucleic acid analysis. The system can comprise a stage (e.g., carrier or sample carrier) configured to retain a sample. The stage can be configured to retain a device for sample holding or analysis described herein. The sample can comprise one or more analytes including nucleic acids, polypeptides, lipids, metabolites or other molecules. The sample can comprise a cell or tissue. The sample can comprise one or more analytes within a cell or tissue. The sample can comprise a synthetic three-dimensional (3D) matrix. The sample can comprise one or more analytes within a synthetic 3D matrix. The sample can comprise a cell or tissue within a synthetic 3D matrix. The sample can comprise a plurality of nucleic acid molecules in a 3D matrix. The plurality of nucleic acid molecules can have a relative or absolute 3D spatial relationship. The system can comprise a detector configured to detect one or more signals from the sample. The system can comprise a computer operatively coupled to the detector. The computer can be configured to subject the sample for processing. For example, the computer can be configured to subject one or more analytes to bind with one or more detection probes. For another example, the computer can be configured to subject one or more nucleic acid molecules to various reactions including, but not limited to, transcription, reverse transcription, amplification, polymerization, ligation, or any combinations thereof. For another example, the computer can be configured to subject one or more analytes to detection within a synthetic 3D matrix. The computer can be configured to subject a plurality of nucleic acid molecules to nucleic acid amplification under conditions sufficient to form a plurality of amplicons within a synthetic 3D matrix. Subsequent to formation, the plurality of amplicons may be coupled to the synthetic 3D matrix and have a relative 3D spatial relationship. The computer can be configured to subject a plurality of analytes (e.g., nucleic acids or proteins) to hybridization with a plurality of probes (e.g., nucleic acid probes, antibodies or aptamers). Subsequent to hybridization, the plurality of probes can be couple to the synthetic 3D matrix and have a relative 3D spatial relationship. The computer can be configured to subject one or more nucleic acid molecules (e.g., one or more amplicons) to nucleic acid sequencing while the one or more nucleic acid molecules are coupled to the synthetic 3D matrix. The nucleic acid sequencing may comprise (i) sequentially contacting the one or more nucleic acid molecules with detectable labels and (ii) using the detector to obtain signals corresponding to the detectable labels from the synthetic 3D matrix. The signals can be obtained by the detector from a plurality of planes during the nucleic acid sequencing. The computer can further be configured to use the signals obtained by the detector from the plurality of planes to generate a 3D volumetric image of the one or more nucleic acid molecules. The 3D volumetric image can identify the relative 3D spatial relationship of the one or more nucleic acid molecules.

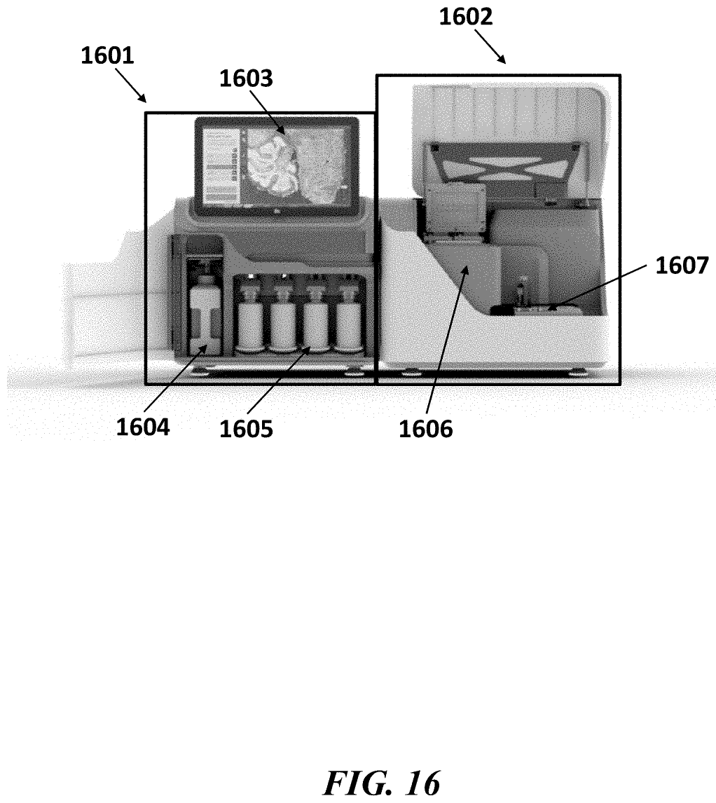

The system for sample analysis can comprise two modules comprising a first module and a second module, where the first module comprising any components that may lead to vibration can be contained in a separate housing from the second module comprising a imaging system (e.g., optical assembly) such that vibration to the imaging system can be minimized. The housing of the first module can be distinct from the housing of the second module. The two modules can be coupled (e.g., connected or attached) in a way such that (i) vibration may not be transferred from one module to the other, (ii) light or dust may not be allowed to enter from the ambient environment into either module, (iii) the distance from one module to the other (e.g., roughly 3-5 mm between module enclosures) can be minimized, (iv) electrical cables and liquid tubing can be passed between the two modules, and/or (v) air flow between the two modules can be encouraged. Various methods can be used to couple the two modules. For example, the two modules can be coupled by a sheet metal bevel and a mating rubber sweeper. FIG. 16 shows an example of the two-module system. The first module 1601 can comprise a user interface (e.g., a graphical user interface) 1603. The user interface can comprise a touch screen (e.g., 10-point touch interface). The first module 1601 can further comprise a waste bottle interface 1604 and/or a bulk bottle interface 1605. The second module 1602 can comprise the imaging system. The second module 1602 can further comprise a reagent cartridge interface 1606 and/or a stage 1607 for holding a sample or a sample device. The second module 1602 may not comprise a cooling system that can lead to vibration. The second module 1602 may not comprise any fans that can lead to vibration. The second module 1602 may comprise a liquid or fluidic cooling/circulating system to dissipate heat. In some cases, the system may comprise one module, where the imaging system may not be decoupled with the other components within the system. In some other cases, the system may comprise more than two modules.

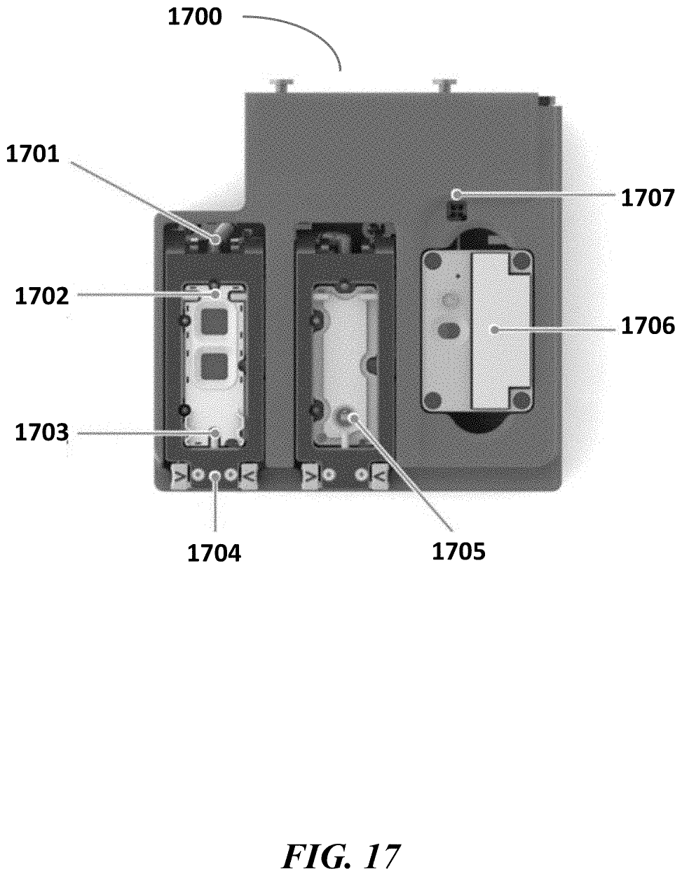

The stage can be configured to hold a sample device described herein. FIG. 17 shows an example design of the stage. The stage 1700 can hold one or more sample devices. The sample device can be the sample slide assembled into the sample cassette as described herein. The stage can comprise one or more recesses configured to hold the one or more sample devices. The example in FIG. 17 shows a stage having two recesses to hold two sample devices. A sample device 1702 is inserted into one of the recesses of the stage. The stage can comprise a temperature control system 1701. The template control system 1701 can be located near or within a recess to provide direct thermal control of the recess or the sample device inserted into the recess through thermal conduction and/or convection. The stage can comprise one or more pins 1703 configured to position the sample device. The stage can control sub-micron XYZ positioning of the sample device repeatedly. The stage can comprise a lid 1704. A lid interface mechanism can be configured to receive the lid when the lid is closed onto the recess for sample device. The lid can be a hinged lid. The lid can comprise a hinge. The stage can comprise a sensor 1705 configured to sense the presence or identification of the sample device. In some cases, the stage can further comprise a recess to receive a liquid handling accessory consumable 1706. The stage can further comprise an automated sipper tube calibration mechanism 1707.

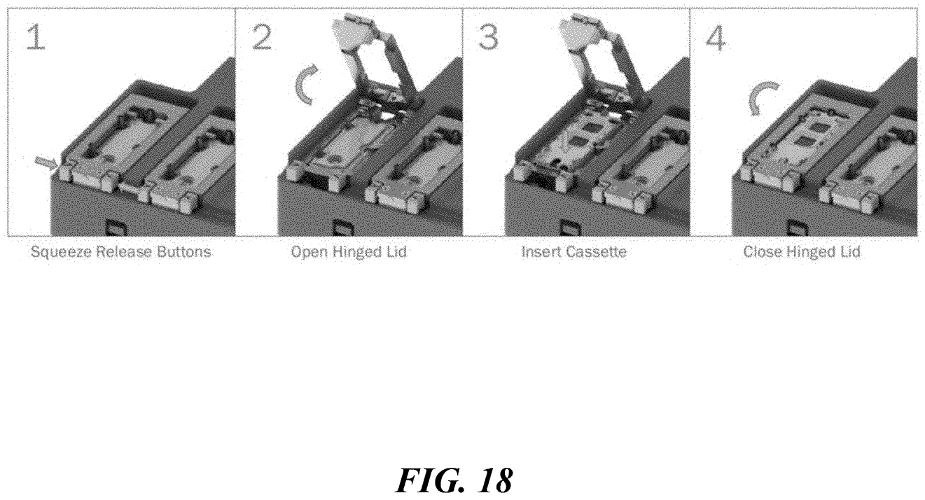

FIG. 18 shows an example process of inserting a sample device into the recess of the stage. A lid (e.g., hinged lid) can be closed onto the sample device to secure the sample device in place.

The stage can comprise a mechanism for sample device positioning. The sample may be rigidly attached to a sample device comprising a glass slide. The glass slide can have markers to guide sample placement into an area within the markers, which can be the imagable area. The sample may need to be stationary within the system for high quality imaging and image processing. The glass slide may be subjected to XYZ temperature range through thermoelectric modules (TEMs) which can cause the glass slide and some of the surrounding metal to expand and contract (e.g., thermal expansion). Thermal communication between the sample device and the components of the system not in direct contact with the TEMs may need to be minimized. In addition, the mechanism for sample device positioning can further assist positioning the sample repeatedly within the imagable area. For example, the recess of the stage can comprise a sample position controller for positioning the sample device. The sample position controller can comprise one or more pins. The one or more pins can comprise one or more X pins, one or more Y pins, or one or more Z pins. The sample position controller can comprise one or more mechanical linkages such as cams. The one or more cams can comprise a X cam and a Y cam. The pin and cam placement can be used to provide “stability triangles” between points of contact while accommodating both sample well and slide protection and attachment features in the sample device or the sample cassette of the sample device. In some cases, using no more than three points of contact in a dimension may avoid any unstable configurations even with imperfect manufacturing or unanticipated thermal stress. The X and Y cams can allow constant force in each of those directions while also allowing for thermal expansion, which may encourage the sample device and thus the sample to return to its original position after heating and cooling. The X pins may be placed as far apart as possible while leaving sufficient room for additional interface points for the top and bottom of the sample device. The Y pin can be placed in the center/top of the sample device while the Y cam can be placed slightly offset on the right/bottom to discourage clockwise rotation of the sample device. The forces in the X, Y, and Z directions may be tuned specifically to achieve repeatable positioning of the sample device. For example, the forces in the X, Y, and Z directions may be tuned to overcome frictions resistant to motion present in the system. The force applied in any one direction (e.g., X, Y or Z) may not be too large as to render the force being applied in another direction inadequate to overcome the increased friction forces.

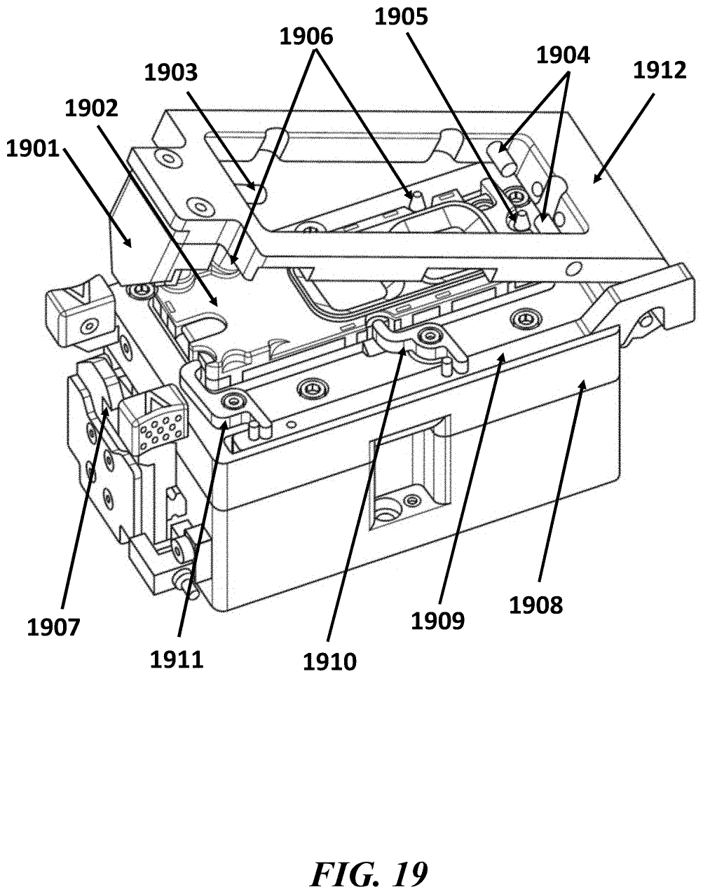

FIG. 19 shows an example design of the mechanism (e.g., sample position controller) for sample device positioning, retention, and thermal management. As an example, the sample device 1902 can be referenced against six pins (e.g., 316SS pins) including two ‘X’ pins 1906, one ‘Y’ pin 1905, and three ‘Z’ pins 1903 and 1904. The X or Y pins 1906 and 1905 can be mounted in the cam plate 1908. The Z pins 1903 and 1904 can be mounted on the lid 1912 (e.g., the hinged lid). The sample device 1902 can be pushed against these pins by the following process: four stacked wave springs in the Z riser module (ZRM) can push vertically against the bottom of the sample device against the Z pins 1903 and 1904. This motion can be accomplished when the lid 1912 is closed and the pins press against the top of the slide of the sample device. Neither the Z pins nor the ZRM may touch any of the plastic components in the sample cassette of the sample device. As the hinge's angle relative to the imaging plane decreases, X and Y cams 1910 and 1911 may begin to rotate. The rotation and timing can be controlled by the motion of a cam pusher 1909. The X cam 1910 can contact the slide (e.g., a glass slide within the sample device). The slide can reference against two X pins 1906 in the cam plate 1908 versus the single Y pin 1905 in the cam plate 1908. Once the slide has been referenced in the X dimension, the cam pusher 1909 can continue to move and the Y cam 1911 can engage with the edge of the slide. The Y cam can push the slide against the Y pin 1905 in the cam plate 1908. To register in Z, the two “top pins” 1904 in the lid 1912 can contact the sample device or the slide within the sample device first and begin the depression of the slide and ZRM. The “bottom pin” 1903 on the lid 1912 can contact the slide and bring it so the slide can be parallel to the imaging plane. The hinge latch 1901 of the lid 1912 can engage with the hinge catch 1907 on the stage and lock the lid, the sample device, and ZRM in place.

The stage can comprise a mechanism for optical registration. The imaging process may involve repeatedly scanning the same three-dimensional sub-volume of a sample. The data from each temporally-distinct scan can then be processed and mapped to the same coordinate system. As such, images may be acquired on the system such that they can be subsequently “registered”. Because the scans can occur over a long period of time (e.g., one or more hours, or one or more days), there can be a number of sources of “drift” that can cause the sample device and/or sample to move. Optical registration of physical markings on the slide (e.g., fiducial markers) can be used as a method of compensating for the drift. Many imaging or machine vision processes that involve object tracking, or a need to register images to one another, may rely on “fiducial markers” (e.g., objects of pre-determined shape, signal characteristics, etc.) as reference features. Such fiducial markers may be used with the sample device or the system described herein. For example, the sample device can comprise a glass slide which can be cut out of floated borosilicate glass and then laser ablated to produce small cross-shaped fiducial markings within the imagable sample well areas. The laser ablation can be optimized to produce sharp or clean markings that are at the top surface. The recess on the stage for holding the sample device can comprise an edge lighting which edge lights the glass slides using high power LEDs. The edge lighting can be mounted in the hinge of the lid (FIG. 19). The glass slide can act as a waveguide such that most of the light (e.g., LED light) can be contained within the glass due to total internal reflection. When the light strikes the fractured edges of the laser ablated fiducial markings, it may be scattered and able to entire the light path of the imaging system. This design can produce a high signal to noise ratio and minimize the extent to which the sample can be illuminated by the LEDs, which may produce background and photobleach the sample. The LED wavelength can be selected such that the majority of the LED emission can pass through the “blue” channel emission filter passband. This design can allow users to image the fiducial markers with fluorescence filters in place. This design can also reduce the axis travel requirements for the filter axis and cut down on background due to any autofluorescence or fluorescence induced in the sample. XYZ motion in conjunction with the edge lighting can be used to locate the fiducial markers prior to imaging. This method can provide users with an absolute reference for the position of the glass slide in three-dimensional space. XYZ centroid of each fiducial marker can be found using imaging processing algorithms.

The stage may include a temperature controller such as a heating or cooling apparatus where the stage may be heated or cooled (such as through thermoelectric cooling using Peltier elements). The heating or cooling may be according to a programmed time and temperature. The heating or cooling may be programmed according to thermo-cycling protocols for applications such as nucleic acid hybridization, amplification and sequencing. The heating or cooling apparatus or heating or cooling unit may be capable of rapid temperature cycling. The heating or cooling apparatus or unit may use a heat sink in conjunction with a fan to dissipate heat produced during temperature changes. The heating or cooling apparatus or unit may use a radiator and liquid cooling/circulating system to dissipate heat produced during temperature changes. The heating or cooling apparatus or unit may use temperature one or more sensors or thermistors to provide temperature feedback to a control system, which may be a microcontroller or other electronic circuit.

The system for sample analysis can comprise a mechanism for calibrating a fluidic waste extraction tube (e.g., a sipper tube calibration mechanism). The fluidic waste extraction tube can be a sipper tube. The sipper tube can be a hollow consumable part that is the end effector of the sample waste extraction system. The sipper tube can be the component that is lowered into the sample well and through which liquid waste can be extracted. In order to ensure that waste extraction is as complete as possible, the tip of the sipper tube can be positioned as close to the well bottom as possible (without making contact). The sipper tube can be placed within the sample well in X and Y directions, and be moved along the Z axis to increase the efficiency of extraction. Because the sipper tube can be user replaceable and may be manufactured with relatively low tolerances, it may be calibrated each time it is replaced. The calibration process can be designed to determine the XYZ position of the tip to at least about +/−100 μm, +/−90 μm, +/−80 μm, +/−70 μm, +/−60 μm, +/−50 μm, +/−40 μm, +/−30 μm, +/−20 μm, +/−10 μm or less in accuracy. The sipper tube can be positioned in a sample well through the use of three linear motion axes: the sipper axis can position the tube in Z, while the X and Y axes of the stage can position the well in X and Y. The sipper tube can be positioned in the sample well through the coordination of all three motion axes. The X, Y and Z positions used to position the sipper tube in a particular location relative to the well can be calculated by combining coordinate system configurations (based on the device design and sample cassette layout) and calibration data. Initial calibration data can be generated through the use of mechanical fixtures that relate motion axis positions to the relative positioning of device features (e.g., the position of the sipper tube relative to the stage coordinate system origin). This initial calibration data can be generated during initial instrument setup. Each time after a new sipper tube is installed, an additional automated calibration can be performed to provide a more refined relational mapping between the sipper tube and the stage or well coordinates.

The stage can be a motorized stage. The stage can move in an x, y, or z direction relative to the detector. The stage can move in an x, y, or z direction relative to the detector such that a single from the sample secured on the stage can be detected in three dimensions.

During the automated sipper tube calibration process, the sipper tube tip can be detected using an array of sensors such as photointerrupters. By varying the position of the sipper tube in Z, and the position of the stage in X and Y, the tip location can be detected in three-dimensional space. A photointerrupter can be a type of sensor that can detect when a small beam of light is interrupted by an outside object. When the sipper tube passes through a photointerrupter's beam, the beam can be broken and the photointerrupter can output a signal indicating as such.

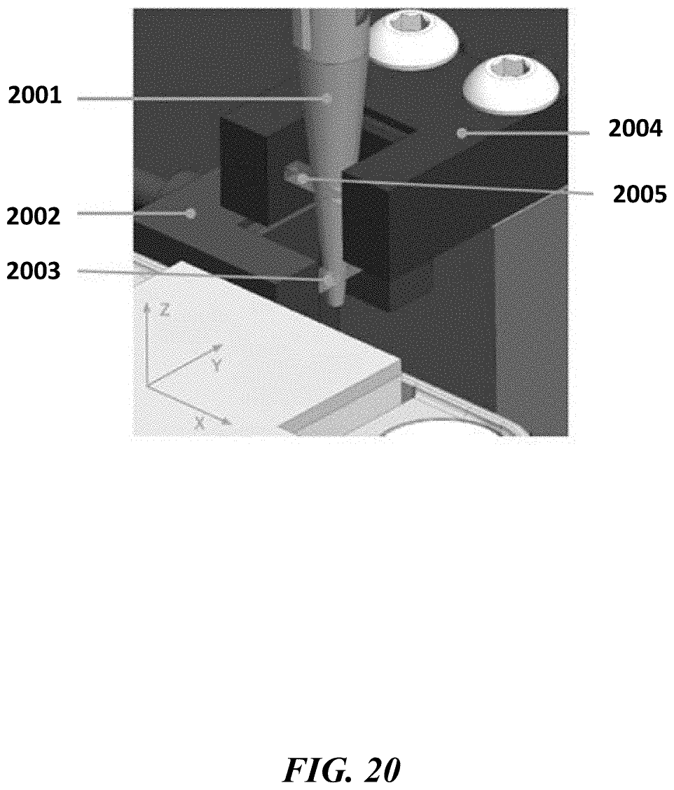

FIG. 20 shows an example design of the sipper tube calibration mechanism. The X-direction photointerrupter 2004 and Y-direction photointerrupter 2002 are shown in this example. The two photointerrupters can be mounted at 90 degrees to one another, such that the beams can be allowed for sipper tube edge detection in X and Y. The X-direction photointerrupter beam 2005 and the Y-direction photointerrupter beam 2003 are shown in this example. By first locating the tube centroid in X and Y, the sipper tube tip in Z can be located by lowering the sipper tube 2001 into the photointerrupter array at its X/Y center.

An example process workflow can comprise retracting the sipper tube. Next, the stage can be positioned such that photointerrupter array can be centered under expected sipper tube X/Y center. Next, the sipper tube can be lowered such that the tip location may be 1-2 mm below lower photointerrupter beam. Next, the stage can be moved in X direction, using a binary search pattern, until the beam is broken, and the position at which beam is broken can be recorded as one sipper tube edge in X. Next, the movement of the stage can be continued in X direction until the beam is no longer broken, and this position can be recorded as the other sipper tube edge. For the Y direction, the stage can be moved in Y direction, using a binary search pattern, until the beam is broken, and the position at which beam is broken can be recorded as one sipper tube edge in Y. Next, the movement of the stage can be continued in Y direction until the beam is no longer broken, and this position can be recorded as the other sipper tube edge. Using the above results, the sipper tube can be centered on the beam pattern using the X+Y axes. Next, the sipper tube can be raised until lower beam is no longer broken, and this position can be recorded as the calibrated sipper tube Z position. After the completion of the calibration procedure, the recorded data can be used in conjunction with the initial instrument calibration data and/or sample device layout data to compute the requisite X/Y/Z positions to precisely position the sipper tube at any point within a sample well.

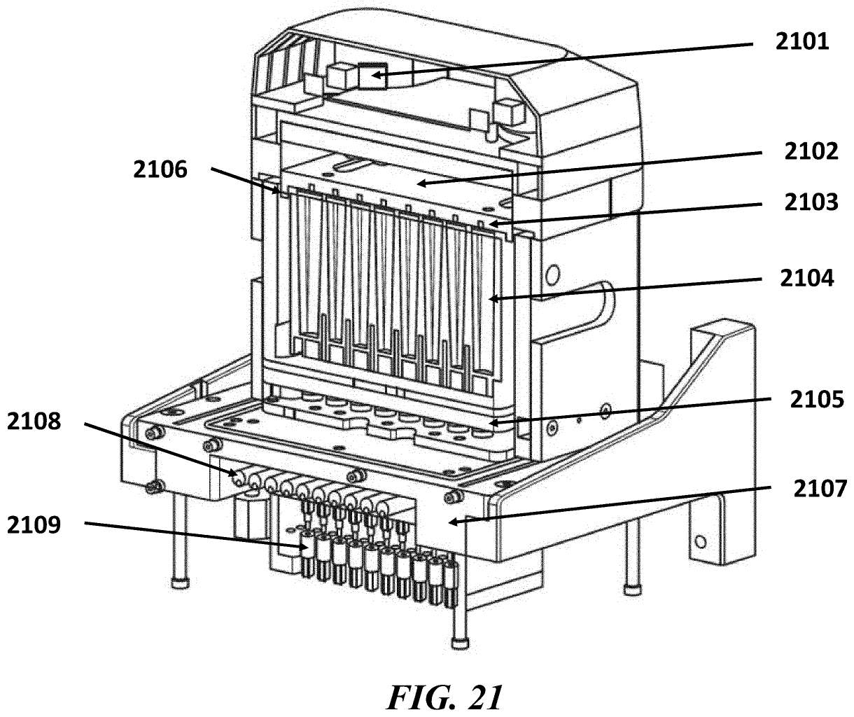

The system for sample analysis can comprise a fluidics dispensing system. The fluidics dispensing system can be used to deliver reagents to the samples. The fluidics dispensing system can work via pressurization with argon gas metered by opening and/or closing valves (e.g., solenoid valves) specific to a reagent. The fluidics dispensing system can comprise a pressurization system. The fluidics dispending system can comprise a fluidics manifold and solenoid system. The fluidics dispensing system can comprise a waste extraction system. The fluidics dispensing system can comprise a fluidics control system to control the fluid flow. The fluidics dispensing system can comprise an interface (e.g., a reagent cartridge interface) for loading a reagent cartridge. The fluidics dispensing system can comprise an additional interface (e.g., a reagent reservoir interface) for loading one or more reagent reservoirs such as bulk reagent bottles. The fluidics dispensing system can comprise a pressurization system, a fluidics manifold and solenoid system, a waste extraction system, a fluidics control system, or a combination thereof. FIG. 21 shows an example of the reagent cartridge interface and the fluidics manifold and solenoid system of the fluidics dispensing system. The fluidics dispensing system can comprise a reagent cartridge interface for fluidically connecting the fluidics dispending system to a reagent cartridge 2104 comprising one or more chambers for holding reagents. The reagent cartridge interface can comprise a radial seal gasket 2106. The reagent cartridge interface can comprise one or more first tubular or notched bodies for introducing gas into the chambers for holding reagents. The first tubular or notched bodies can comprise piercing elements 2103 for piercing one or more upper seals on the top of the reagent cartridge 2104. The first tubular or notched bodies comprising piercing elements can be notched conical bosses. The first tubular or notched bodies comprising piercing elements can be needles. The fluidics dispending system can comprise a tank of pressurized argon gas fluidically connected to the tubular or notched bodies. The reagent cartridge interface can comprise a lid 2102. The lid 2102 can be actuated by an actuator 2101. The lid can comprise the one or more first tubular or notched bodies. The reagent cartridge interface can comprise one or more second tubular bodies on the bottom for removing reagents from the chambers for holding reagents. The one or more second tubular bodies can comprise piercing elements for piercing a lower seal on the bottom of the chambers for holding reagents. The one or more second tubular bodies can be in fluidic communication with the device for retaining the sample. The one or more second tubular bodies can be in fluidic communication with a sample. The one or more second tubular bodies can comprise one or more sprung needle shrouds or a sprung needle shroud plate 2105. The one or more second tubular bodies can become exposed when the lid of the reagent cartridge interface secures a reagent cartridge. The exposed one or more second tubular bodies can pierce a seal on the reagent cartridge. The reagent cartridge interface can comprise a machine-readable identification tag reader. The reagent cartridge interface can further comprise a liquid cooling heat transfer plate. The liquid cooling heat transfer plate can be located at the bottom of the reagent cartridge interface. The fluidics manifold and solenoid system of the fluidics dispensing system can comprise a manifold 2107. The fluidics manifold and solenoid system can further comprise one or more inlet valves 2108. The fluidics manifold and solenoid system can further comprise one or more distal valves (e.g., jetting valves) 2109. The one or more distal valves can dispense one or more reagents from the one or more chambers of the reagent cartridge to a sample.

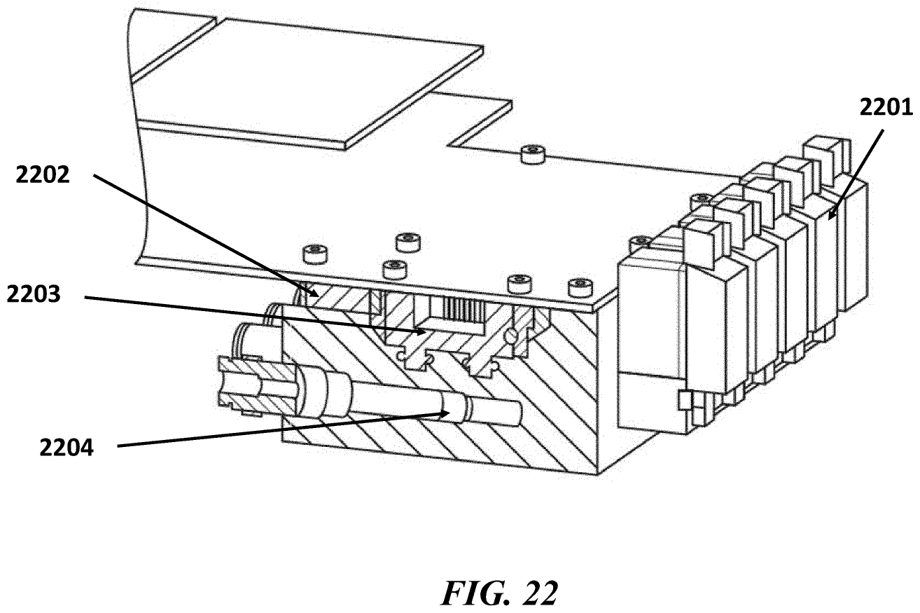

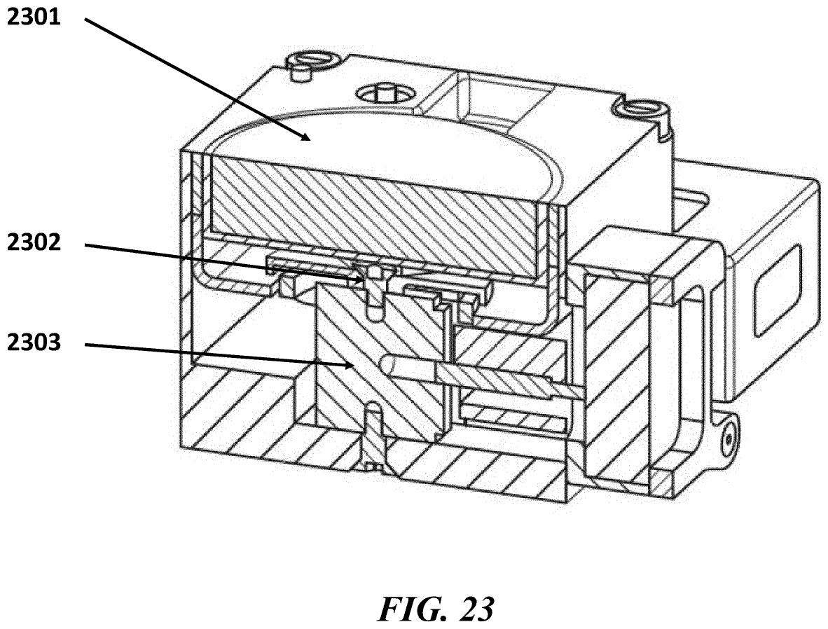

A reagent cartridge and/or bulk reagent bottle(s) can be loaded into the fluidics dispensing system. The reagent cartridge can be loaded into a reagent cartridge interface of the fluidics dispensing system. The bulk reagent bottle can be loaded onto a bulk reagent interface. The fluidics dispensing system can be pressurized with argon to at least about 3, 3.5, 4, 4.5, 5, 5.5, 6, 6.5 pound-force per square inch (psi). The fluidics dispensing system can be pressurized with argon to from 3 to 6, from 4 to 7, from 4 to 6, or from 4.5 to 5.5 psi. The pressure may be high enough to overcome the fluidic resistance of the system while not being so high as to increase the flow rate to a rate that would disturb, damage, or dislodge the embedded sample. The fluidics dispensing system can choose to pressurize all bulk reagents and pressure vessel independently. The fluidics dispensing system can comprise a fluidics control system. FIG. 22 shows example components of the fluidics control system. The fluidics control system can comprise a gauge pressure sensor 2202 to measure or sense the gauge pressure of the fluidics dispensing system. The gauge pressure sensor 2202 can detect pulses in air flow corresponding to dispenses. The fluidics control system can further comprise one or more pressure selection pneumatic valves 2201. The fluidics control system can further comprise a flow restrictor 2204. The fluidics dispensing system can check for leaks using a differential pressure sensor 2203 situated in a bypass in the pressurization line. For example, the pressure above a certain value may indicate excessive flow and therefore a leak may exist. The fluidics dispensing system can be calibrated before each run by priming the system and dispensing small volumes into a waste dish 2301 which can be placed on the top of a load cell 2303 (FIG. 23). The waste dish 2301 can be held by a waste dish holder 2302. The waste dish hold can comprise a overload protection mechanism. The calibration can be performed with any liquid with a known kinematic viscosity. The waste dish can be part of the waste extraction system. These can be measured along with the absolute pressure of the system to check the fluidic resistance of the system. The fluidics dispensing system may be within established parameters in order to continue use of the system.

To dispense a reagent, the gauge pressure of the fluidics dispensing system can be measured and can be used to modify the flow rate calculated during the calibration of the fluidics system. The two valves corresponding to the reagent that needs to be dispensed can be opened to prime the most distal valve. The dispensed reagent can be collected in the waste dish and measured to ensure the fluidics system is functioning normally. If the system is functioning normally, the stage can be moved to place the selected sample well underneath the most distal valve, and the reagent can be dispensed for a volume based on time. In some cases, the distal valve may be clogged or salted. To prevent clogging and/or salting of the distal valve, water from another reservoir may be routed to the distal valve and dispensed into the waste dish, hence the need for priming before dispensing.

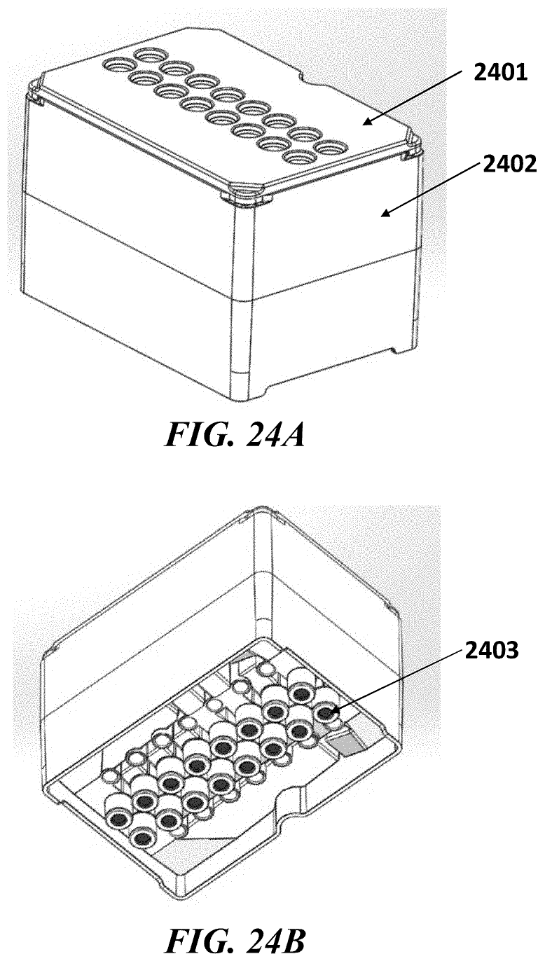

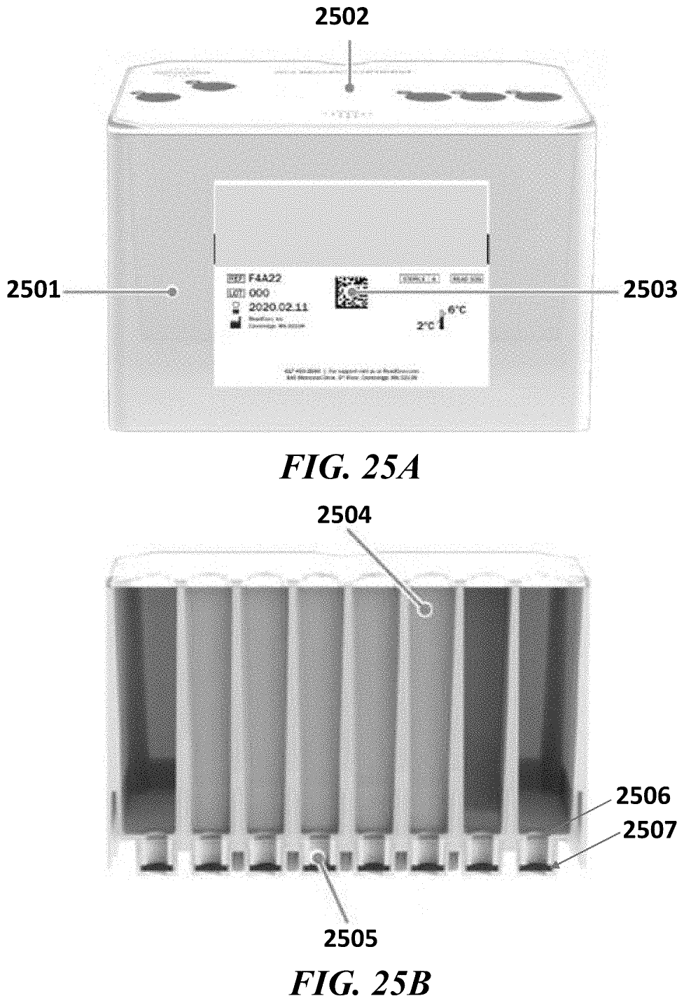

The system can comprise a reagent cartridge. The reagent cartridge can be loaded into the fluidics dispensing system, where a reagent of the reagent cartridge can be drawn or dispensed into a sample well. The reagent cartridge can comprise a main reservoir body, an upper seal, and a protective lid for the seal. The seal can be a foil. The foil can be made of various materials, for example, including but not limited to, aluminum, copper, tin, plastic, adhesive, rubber, laminate, and gold. The foil can comprise aluminum, copper, tin, plastic, adhesive, rubber, laminate, gold, or any combinations thereof. The main reservoir body can be sectioned into one or more cavities (e.g., 1, 2, 3, 4, 5, 6, 7, 8, 9, 10, 11, 12, 13, 14, 15, 16, 17, 18, 19, 20, 21, 22, 23, 24, 25, 26, 27, 28, 29, 30 or more cavities) to individually hold one or more reagents. The protective lid can comprise one or more holes to align with each reagent cavity. Each reagent cavity can be sealed at the distal end with a stack up comprising a relatively large pore size filter (e.g., at least about 10, 20, 30, 40, 50, 60 or more μm) and a septa (e.g., a silicone septa) spaced apart from the filter. The main reservoir body of the reagent cartridge can comprise a polymer such as polypropylene, polyvinyl chloride (PVC), polyether ether ketone (PEEK) or high-density polyethylene (HDPE). The main reservoir body of the reagent cartridge can comprise glass filled polypropylene. The main reservoir body of the reagent cartridge can further comprise silicone rubber, and/or chemically compatible pressure sensitive adhesive tape. FIG. 24A shows an example of the reagent cartridge. In this example, the reagent cartridge comprises a protective lid 2401 having holes corresponding to the cavities for holding reagents, and a main reservoir body 2402. Each cavity can be sealed with a foil. FIG. 24B shows a view of the distal end (or the bottom) of the reagent cartridge. The distal end of each cavity of the reagent cartridge can be sealed with a filter and a septa 2403. In this example, the filter is not visible. FIG. 25A shows an example of the reagent cartridge. The reagent cartridge can have an injection-molded construction 2501. The injection-molded construction 2501 can be low cost. The reagent cartridge can have a surface 2502 with labeled guidance for customization. The reagent cartridge can comprise a label having 2D Barcode and/or RFID (NFC) tracking. FIG. 25B shows a cross-sectional view of the reagent cartridge. The reagent cartridge can have one or more cavities 2504 for holding one or more reagents. The cavity may have various volume capacity. Each cavity can comprise a bottom portion having a filter 2506 and a septa 2507. The filter 2506 and the septa 2507 can be separated by a spacer 2505.

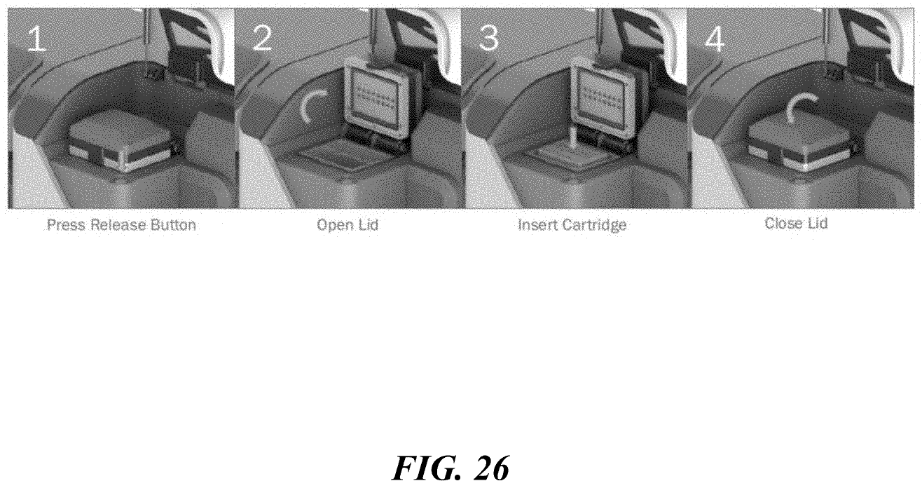

To access the reagents within a reagent cartridge, a lid of the fluidics dispending system can be opened and the reagent cartridge can be placed inside. The lid can then be closed. The inner actuated lid (FIG. 21) can be depressed down onto the protective lid and thus the reagent cartridge. The foil piercers (FIG. 21) can pierce the seal of each cavity of the reagent cartridge before or during the lid is actuated. The foil piercers can allow pressurization of the reagents within the cavities of the reagent cartridge. As the lid depresses, the sprung needle shroud (or needle shroud plate, see FIG. 21) can depress, exposing the needles to the septa. The needle can become fully seated within the spacer (see the spacer 2505 in FIG. 25) between the top of the septa and the bottom of the filter. The actuated lid can comprise a radial seal gasket (FIG. 21) to form a radial seal with the pressure vessel. The radial seal gasket can comprise silicone such as 40 Shore A silicone rubber. FIG. 26 shows an example workflow of loading a reagent cartridge into a fluidics system. In this example, the process comprises opening the lid of the fluidics system by pressing a release button that can control the lid. The lid can then be opened. Next, the reagent cartridge can be loaded into the fluidics system. The lid can then be closed after loading the reagent cartridge.

The reagent cartridge can contain one or more reagents for sample processing or analysis. For example, the reagent cartridge can contain one or more reagents for detection, reverse transcription, amplification, or sequencing. The one or more reagents can comprise an enzyme, a buffer, a probe, a detectable label, or nucleotides.

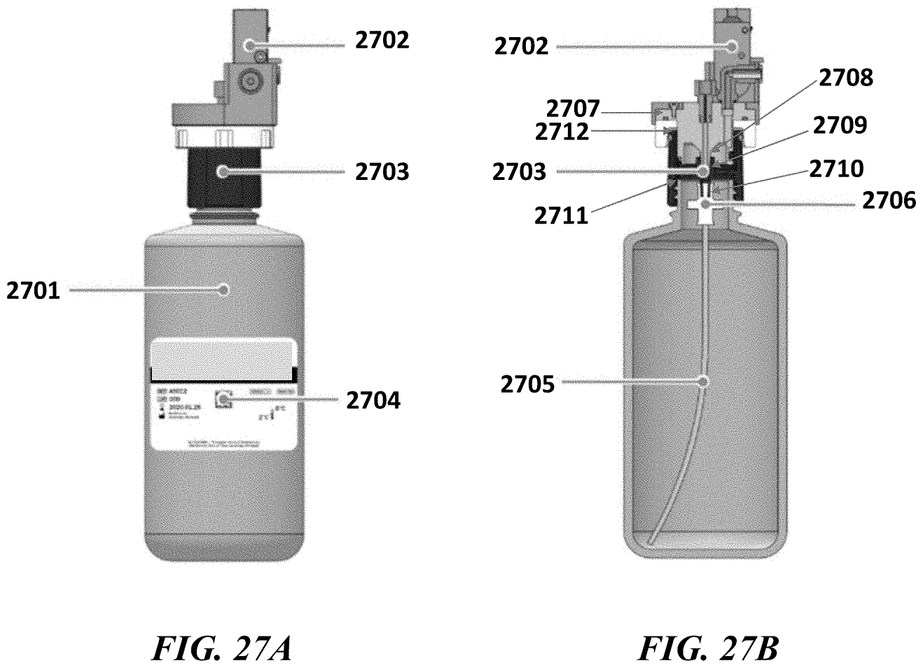

The system for sample analysis can comprise a reagent reservoir interface (e.g., bulk reagent interface). The bulk reagent interface can comprise one or more bulk reagent interface modules (BRIMS) for connecting to one or more bulk reagent bottles. The bulk reagent interface can comprise a base for holding the one or more bulk reagent bottles. The bulk reagent interface can further comprise an interface cap, which can be used to connect the BRIM to the opening of the bulk reagent bottle. The interface cap can comprise a coaxial cap with argon seal and fluidic seal. The interface cap can further comprise a straw connected to the fluidics channel via a large porosity filter. The pore size of the filter can be at least about 10 μm, 20 μm, 30 μm, 40 μm, 50 μm, 60 μm or more. The bulk reagent bottle can be a bottle that has a capacity to hold liquid of at least about 50 mL, 100 mL, 150 mL, 200 mL, 250 mL, 300 mL, 350 mL, 400 mL, 450 mL, 500 mL, 550 mL, 600 mL, 650 mL, 700 mL, 750 mL, 800 mL, 850 mL, 900 mL or more. The bulk reagent bottle can comprise a machine-readable identification tag. The machine-readable identification tag can comprise a barcode, an electromagnetic tag or any other identifying mark. The machine-readable identification tag can comprise a 2D barcode. The machine-readable identification tag can comprise a quick response (QR) code, a data matrix (e.g., ECC200), a radio-frequency identification (RFID) tag, or a near-field communication (NFC) chip. The bulk reagent bottle can comprise an RFID or NFC tag. The machine-readable identification tag such as an RFID or NFC tag can be read by a sensor on the based once the bulk reagent bottle is loaded onto the bulk reagent interface. Each bulk reagent interface module can use pressurized Argon to force reagent out of an HDPE bottle/cap/filter assembly and into the system. The bulk reagent bottle may need to be sealed properly in order to prevent argon leakage. The argon leakage may lead to improper reagent dosing. FIG. 27A shows an example of the bulk reagent bottle 2701 connect to the BRIM 2702 through the interface cap 2703. The bulk reagent bottle 2701 can comprise an RFID tag 2704 to store information related to the reagent.

The BRIM and the interface cap can comprise one or more seals in order to ensure that the opening of the bulk reagent bottle is properly connected or sealed to the BRIM. The one or more seals may comprise a Teflon BRIM seal for overall bottle pressurization. The Teflon BRIM seal can comprise a o-ring such as a Buna-N o-ring. The o-ring can be used to seal the top of the interface cap connecting to the BRIM. The one or more seals may further comprise a luer seal, where a male luer on the BRIM thread can be connected to a female luer on the interface cap. The one or more seals may further comprise an additional luer seal between a male luer of the interface cap to an internal filter. The one or more seals can further comprise a seal between the bottle opening and the interface cap. The surface of the opening of the bulk reagent bottle can match to a surface of the bottom portion of the interface cap. FIG. 27B shows a cross-sectional view of the bulk reagent bottle 2701 connected to the BRIM 2702 through the interface cap 2703. The BRIM 2702 comprises a BRIM thread 2707. In this example, a first seal is generated between the top 2712 of the interface cap connecting to the BRIM. A second seal is generated between the male luer 2708 of the BRIM thread 2707 and the female luer 2709 of the interface cap 2703. A third seal is generated between the male luer 2710 of the interface cap and the internal filter 2706. A fourth seal is generated between the surface of the opening 2711 of the bulk reagent bottle 2701 and the interface cap 2703.

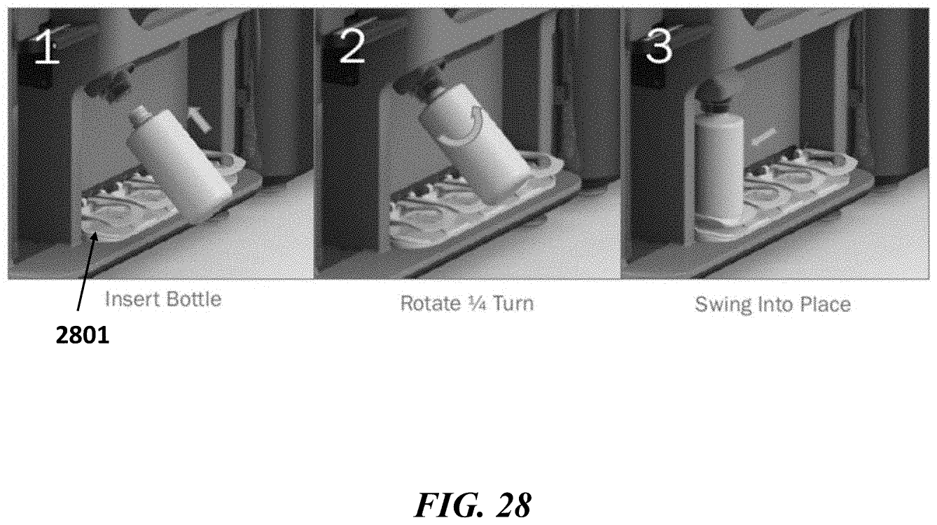

The BRIM can be in a loading position. Users can grasp the bottle/2PPC assembly (the bulk reagent bottle connected to the interface cap) and align three internal posts in the 2PPC with mating thread features in the BRIM thread. Users can then twist roughly 90 degrees clockwise so the bottle/2PPC assembly can be brought inwards with positive feedback when the threads are fully engaged. This motion can engage the seal between the top of the 2PPC and the BRIM. The inward motion of the bottle/2PPC assembly can also engage the luer seal, where the male luer on the BRIM thread can be connected to the female luer on the 2PPC. The inward motion can flex three molded arms and provides pressure to seal the luers. The luer seal between the 2PPC cap and the internal filter or the seal between the 2PPC and the bottle opening can be engaged when the bottle is assembled with the 2PPC. Once the bulk reagent bottle is engaged fully with the BRIM, the bottle/2PPC assembly can be rotated on the BRIM's internal hinge downward. The bottom of the bottle can push a spring-loaded arm (or BRIM arm) out of the way until it is in a position where it can be read by the RFID boards in the BRIM base. While the bottle passes into this position, features in the BRIM arms can disengage and spring up to lock the bottle in position and brace it against unwanted movement. To disengage the bottle/2PPC assembly from the BRIM base, the BRIM arm can be pushed down with a hand or wrist such that the users can take the bottle and pivot it back up towards the loading position. Users can disengage the BRIM from the bottle/2PPC assembly by a quarter turn counterclockwise, which disengages the seals between the BRIM and the 2PPC. FIG. 28 shows an example process of loading a bulk reagent bottle to the bulk reagent interface. The bulk reagent interface can comprise a base 2801. The example process comprises inserting the bottle to the BRIM, rotating clockwise for ¼ turn (e.g., about 90 degrees), and swinging the bottle into the base.

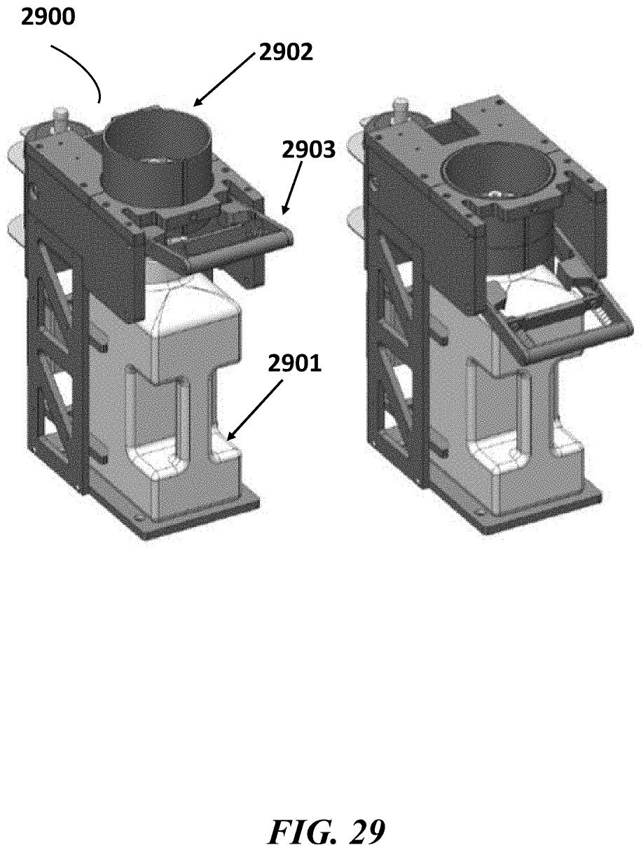

The system for sample analysis can comprise a waste interface module (e.g., 1604 of FIG. 16). The waste interface module can be used to dispense and store waste process fluids in a consumable vessel (e.g., a waste bottle) that can easily be loaded, removed, and disposed of. The fluids and vapors present in the system can potentially be noxious, and therefore the module design may protect the users and the device from these noxious substances. The users can load the waste bottle by sliding it into the module opening until the edges of the waste bottle slip past the rounded positioning pins and hit the backstop. The position of the positioning pins can provide tactile feedback to the users, as the sudden change in resistance can indicate when the waste bottle has been pushed in far enough. Additionally, the positioning pins may interfere with the waste bottle enough to retain it in the appropriate loading position, but not enough to make loading and unloading difficult. The users can actuate a handle mechanism and lower a cap assembly of the waste interface module from the unloaded position down to the loaded position. Once the locking pins from the handle click into place, the cap can be in the proper loaded position and the waste bottle can be fully loaded. When loaded, a vapor seal can be formed on the lip of the waste bottle via a gasket and wave spring located inside the cap assembly. The cap assembly can comprise limit switches, which can activate and tell the system that a bottle is loaded. Dispensing may not take place before the switches are activated. Waste process fluids can be dispensed into the waste bottle via a tube stem that extends off the bottom of the cap assembly. Vapor can passively flow through a flexible tube and into a carbon filter located on the rear of the module. A float switch (or alternative liquid level sensor) located on the bottom of the cap assembly can detect when liquid has reached the neck of the waste bottle and can cease liquid dispense and/or trigger other system safety features. To unload the waste bottle, the users can unlock the handle mechanism by squeezing the handle actuator and raise the cap assembly back to the unloaded position, where it can click into place. The waste bottle can then be removed by pulling it past the positioning pins. The handle mechanism can comprise a stationary handle and a spring loaded actuator. The actuator may have two oblique slotted arms that pull on spring loaded locking pins when displaced. The handle mechanism can be in the locked position without the user interaction. This can allow the positioning pins to lock into place automatically when the load/unload positions are reached. FIG. 29 shows an example waste interface module 2900 loaded with a consumable waste bottle 2901. The waste interface module 2900 comprises a cap assembly 2902 and a handle mechanism 2903. On the left, the figure shows the handle in an unloaded position, and on the right, the figure shows the handle in a loaded position.

The system for sample analysis may include an optical assembly including one or more optical axes. The optical assembly may include one or more detectors, such as large area detectors, for volumetric imaging of the 3D nucleic acid containing matrix. The detectors may be cameras, and in particular, cameras with physical attributes tailored to high-speed, low-noise scientific imaging, such as a scientific CMOS (sCMOS) camera. A reflection based autofocus system can provide closed loop control of the optical axis in order to attain and/or maintain sample focus. In some cases, a microcontroller, FPGA, or other computing device may provide software focus and positioning feedback using one or more image analysis algorithms. Such automated sample positioning may include coordination of one or more motion axes in conjunction with the imaging system. The sample positioning may account for physical shifts in sample position over the course of imaging and may be tolerant of shifts that are greater than the field of view captured in a single image frame.

The system may implement methods to map a planar surface, rendering the need for autofocusing in real time unnecessary. Such a system may include using a reflection- or software-based autofocus system to sample three or more points at the sample surface and then fitting those points to the equation for a plane or the surface geometry of the solid substrate. The fitting process may involve excluding one or more points based on autofocus signal data, its residual as a result of regression analysis, or other factors indicating its fitness as a data point. The fitting process may include allowances for surface variance consistent with the sample mounting medium, such that the resulting surface map may include local deviations from a perfectly flat plane to reflect variations in the actual substrate surface.

The system may use image-based software programs for determining, adjusting, correcting, and/or tracking the position of the sample. Image data can be computationally registered to a reference for the purpose of calculating a positional shift along one or more dimensions. A Fourier transform (FT), such as the discrete Fourier transform (DFT) or fast Fourier transform (FFT) can be used to compute a shift between two or more images or image volumes along one or more dimensions. In some cases, sub-pixel shifts can be calculated, such as by using the upscaled DFT. In some cases, translational shifts can be calculated along one or more dimensions. In some cases, rotational shifts are calculated along one or more dimensions. Features or fiducial markers contained within the sample device can be used for the purpose of aiding positional tracking using image analysis. Features or fiducial markers include features manufactured into or added onto the sample device, such as engraved features, laser-engraved features, printed features, deposited features, microcontact print-ed features, beads, and other types of patterns in one or more dimensions.

The system for sample analysis may include one or more objective lenses for imaging. The optical assembly of the system can comprise the one or more objective lenses for imaging. In some cases, the system may include one objective lens. In some cases, the system may contain two objective lenses. In some cases, the system may contain three or more objective lenses. The objective lenses may be water immersion lenses, oil immersion lenses, water dipping lenses, air lenses, lenses with a refractive index matching another imaging medium, or lenses with an adjustable refractive index. The system may contain a single water dipping objective lens, which provides for higher image quality by eliminating the refractive index mismatch occurring at the interface between two media with distinct refractive indexes, such as an air-water interface or water-glass interface.

The objective lens can be an autofocus objective lens. The system can comprise an autofocus controller. The autofocus controller can comprise an integrated circuit, a computer, or a field-programmable gate array (FPGA). The autofocus controller can be a reflection-based autofocus controller.

The system may comprise one or more objective lenses with refractive index not matched to air, and the objective lens may interface with an imaging media, such as water, oil, or other imaging buffer. In such cases, the system may comprise a mechanism of wetting the objective lenses or otherwise creating an interface between the objective lens and the imaging medium. Certain mechanisms of lens wetting can include dipping the lens into an imaging medium or dispensing an imaging medium onto the lens, such as by a syringe, needle valve. The system may dispense a certain amount of liquid into a well for the purpose of creating an incident angle between the objective lens and the liquid interface for deposition of liquid onto the objective lens without forming bubbles. The system may dispense a certain amount of liquid onto the objective, such as by using a syringe or needle valve, without forming bubbles, as by controlling the speed and angle of incidence between the liquid droplet and the objective lens.

During imaging in a liquid imaging medium, bubbles may form either on the objective lens, within the sample, or between the objective lens and the sample. The system may contain a mechanism of detecting bubbles formed on the objective lens, or bubbles present between the objective lens and the sample. Mechanisms of bubble detection can include detection via scattering of light; by image analysis, e.g., by measurement of the point spread function of the optical system, which is perturbed by bubbles; by external machine vision, such as by a camera or other imaging system observing the lens, connected to a computer system with software programmed to detect bubbles on the lens. The system may further contain a mechanism for eliminating bubbles formed on the objective lens. The system may comprise a mechanism for contacting the objective lens with an aspirating needle, which removes any liquid present on the objective lens. The system may comprise a mechanism for contacting the objective lens with an absorbent material, which absorbs any liquid present on the objective lens. The absorbent material can be a composite. The absorbent material can be composite comprising two or more layers. For example, in some cases, the absorbent material can comprise three layers including a first layer (e.g., a lens paper) that protects the objective lens, a second layer (e.g., an absorbent pad), and a third layer (e.g., an adhesive backing) for installation to the consumable. The system may contain a mechanism for drying or removing liquid from the objective lens. The system may execute a software and hardware routine for removing and replacing a liquid imaging medium from the lens upon detection of a bubble. The system may contain a mechanism for alerting a user upon detection of bubbles on the objective lens, within the sample, or between the objective lens and the sample.

During operation of the system, the objective lens may accumulate dirt, dust, deposited salts or other reagent solutes, or other types of materials which interfere with imaging. The system may contain a mechanism for detecting such interference, via scattering of light or other properties of the interaction between light and the interfering material; by image analysis, e.g., by measurement of the point spread function of the optical system, which is perturbed by the presence of interfering materials; by external machine vision, such as by a camera or other imaging system observing the lens, connected to a computer system with software programmed to detect interfering materials on the lens. The system may further contain a mechanism for cleaning the objective lens. The system may include a lens cleaning reagent, which can be dispensed onto the lens for the purpose of cleaning the lens, such as by a syringe or needle valve, or by dipping the objective lens into a cleaning reagent dispensed into a well or onto a non-abrasive material, which is made to contact the objective lens. The system may contain a mechanism for alerting a user upon detection of an interfering material on the objective lens, within the sample, or between the objective lens and the sample.

The system can comprise one or more optical light paths. The system may contain optics for the purpose of correcting refractive index mismatches between certain components of the optical system and the sample or imaging medium. The system may contain optics for the purpose of correcting other types of optical distortion within the optical system, such as spherical or chromatic aberration. The system may contain a mechanism of detecting optical distortion, such as by using an image sensor combined with software to detect changes in a point-spread function of the optical system or other property of the optical system. The system can comprise one or more beam characterizing cameras. In some cases, prior to, during, or after operation of the system, the system may contain an automated or manual routine for measuring the point spread function or other optical property of the system and alerting users or engaging a mechanical, electromechanical, or optical system for correcting the optical distortion. The system can contain an adaptive optical system (AO), which can be used to improve the performance of optical systems by reducing the effect of wavefront distortions. Adaptive optics can correct deformations of an incoming wavefront by deforming a mirror in order to compensate for the distortion. The adaptive optics system may comprise a deformable mirror, image sensor, and hardware and software feedback systems. The adaptive optic system can contain a wavefront sensor, such as the Shack-Hartmann wavefront sensor. The adaptive optical system and other corrective optical systems may be open loop, where errors are measured before they have been corrected by the corrector. The adaptive optical system and other corrective optical systems may be closed loop, where the errors are measured after they have been corrected by the corrector. Adaptive optics may be used to improve the image quality within a 3D sample by correcting for optical aberrations within the sample.

The system can comprise a light source. The light source can be part of the imaging system. The module containing the imaging system can comprise the light source. the first module comprises a light source. The light source can comprise a laser, light-emitting diode, or incandescent lamp. The light source can comprise a spectral filter. The light source can be used for the purpose of exciting fluorescence emission by the sample. The light source can be used for the purpose of detecting absorbance, Raman scattering, or other modalities of interaction between the light and the sample. The light source can comprise one or more light emitting diodes (LED). The light source can comprise one or more lasers. The light source can comprise one or more lamps, such as a mercury or metal halide lamp. The light source can be coupled to the system by free space optics, wherein the light is propagated through gas or vacuum from the source to the optical system. The light source can be coupled to the system by a fiber optic or liquid light guide. The system can comprise a digital processing device. In some cases, the module which does not comprise the imaging system (e.g., the first module in FIG. 16) may comprise the digital processing device (e.g., a computer). The digital processing device can comprise at least one processor, an operating system configured to perform executable instructions, a memory, and a computer program including instructions executable by the digital processing device to provide an application. The application can comprise a software module for controlling the system to repeatedly scan a three-dimensional sub-volume of a sample. The repeated scans can include temporal data. The software module can further be used to process data from the repeated scans including the temporal data to generate three-dimensional map of the sub-volume of the sample. The three-dimensional map can comprise a coordinate system. The digital processing device can comprise a software module for detecting a position of a fiducial marker on the sample device associated with a scan of the repeated scans and adjusting the three-dimensional map of the sub-volume of the sample to compensate for the position of the fiducial marker on the sample device. The digital processing device can comprise a software module for controlling the timing of fluidic, optical, and motion-related events. The software module for controlling the timing of fluidic, optical, and motion-related events can control motors, cameras, optical tuning systems, optical gating systems, and/or sensors. The digital processing device can comprise a software module that selects or suggests a protocol for processing or analyzing a sample based on detection by the system of a machine-readable identification tag present on at least one of a sample, a reagent reservoir, and a reagent cartridge.

The system may include one or more electromechanical, electronic, or fully computerized systems for the purposes of controlling and coordinating the timing of fluidic, optical, and motion-related events. The subsystems within the system for sample analysis, such as motor controllers, temperature controllers, pneumatics controller, valve controllers, cameras, optical tuning or gating systems, sensors, and other electronic systems, may leverage a variety of communication protocols for the purposes of such coordination. Communication protocols may be selected on the basis of latency, interoperability, electromechanical constraints or other application-focused considerations. Subsystems may conform to consistent or well-defined application program interfaces (APIs) such that they may be individually addressed and/or operated from generic computers or human machine interfaces.

Timing of optical systems such as cameras, confocal optical systems, illumination devices, AOTFs, mechanical shutters, etc., and single- or multi-axis motion control systems may be coordinated by microcontrollers, motor controllers, electronic circuits, and/or computerized systems. Optical sensor exposure timing may be optimized such that motion control movements overlap with non-measurement sensor events such as pixel readin/readout or background measurements. Optical illumination timing (e.g., laser illumination gated) may be implemented such that it is tied to specific optical sensor events (e.g., readin/readout) so as to minimize sample exposure to excitation light. Single- or multi-axis motion control for the purposes of optical imaging may be further optimized to account for the sensor exposure regimen (e.g., rolling shutter exposure) for continuous motion applications. Under certain specialized imaging regimes, e.g., time delay integration (TDI), it is possible to execute continuing axis motion during the acquisition of imaging data.

The dimension order of multi-axis motion control (when coupled with optical imaging) may be selected so as to minimize frame-to-frame move times. For example, the vertical axis (e.g., Z or optical axis) move times can be the fastest, so it may be useful to perform three-dimensional imaging in a series of “Z stacks” in which frames are acquired while the vertical axis is driven up or down. These Z stacks can be performed repeatedly across an X/Y plane or plane-like surface in order to acquire a fully three-dimensional volume of image data. In some cases, it may be useful to image a three-dimensional volume that is not cuboid in nature. In such cases, a three-dimensional coordinate system based on physical or engineering units may be employed to dictate arbitrary three-dimensional imaging positions that are then disseminated to the participating motion control and imaging systems. Employing such a system allows for imaging that is constrained exclusively to the region of a three-dimensional matrix in which sample voxels of interest exist. It may be useful to image the volume with a particular spatial sampling frequency. In some cases, the sampling frequency of imaging along one or more axes can be determined relative to the Nyquist frequency of the optical system. Image data acquired using a 40×1.0 NA objective can be sampled in the axial (Z) axis at approximately 100˜900 (e.g., 100, 150, 200, 250, 300, 350, 400, 450, 500, 550, 600 or more) nanometer intervals. The sampling frequency of imaging along one or more axes may be oversampled, such as by acquiring image data or sampling the same area of the sample volume twice. Over-sampling the volume may facilitate computational volumetric reconstruction, such as by providing redundant image data in neighboring image frames for the purpose of volumetric image stitching. Image data may be acquired with 10% overlaps along one or more axes, with 20% overlaps along one or more axes, or with 30% or more overlapping pixel data along one or more axes.

### Samples

A sample may be provided in the methods, systems/devices and compositions described herein. The sample can be a biological sample. The biological sample can comprise the analyte to be processed and/or detected using the methods described herein.

In some aspects, a biological sample may be fixed in the presence of the matrix-forming materials, for example, hydrogel subunits. By “fixing” the biological sample, it is meant exposing the biological sample, e.g., cells or tissues, to a fixation agent such that the cellular components become crosslinked to one another. By “hydrogel” or “hydrogel network” is meant a network of polymer chains that are water-insoluble, sometimes found as a colloidal gel in which water is the dispersion medium. In other words, hydrogels are a class of polymeric materials that can absorb large amounts of water without dissolving. Hydrogels can contain over 99% water and may comprise natural or synthetic polymers, or a combination thereof. Hydrogels may also possess a degree of flexibility very similar to natural tissue, due to their significant water content. By “hydrogel subunits” or “hydrogel precursors” refers to hydrophilic monomers, prepolymers, or polymers that can be crosslinked, or “polymerized”, to form a 3D hydrogel network. Fixation of the biological sample in the presence of hydrogel subunits may crosslink the components of the biological sample to the hydrogel subunits, thereby securing molecular components in place, preserving the tissue architecture and cell morphology.

In some cases, the biological sample (e.g., cell or tissue) may be permeabilized or otherwise made accessible to an environment external to the biological sample. In some cases, the biological sample may be fixed and permeabilized first, and then a matrix-forming material can then be added into the biological sample.

Any suitable biological sample that comprises nucleic acid may be obtained from a subject. Any suitable biological sample that comprises nucleic acid may be used in the methods and systems described herein. A biological sample may be solid matter (e.g., biological tissue) or may be a fluid (e.g., a biological fluid). In general, a biological fluid can include any fluid associated with living organisms. Non-limiting examples of a biological sample include blood (or components of blood—e.g., white blood cells, red blood cells, platelets) obtained from any anatomical location (e.g., tissue, circulatory system, bone marrow) of a subject, cells obtained from any anatomical location of a subject, skin, heart, lung, kidney, breath, bone marrow, stool, semen, vaginal fluid, interstitial fluids derived from tumorous tissue, breast, pancreas, cerebral spinal fluid, tissue, throat swab, biopsy, placental fluid, amniotic fluid, liver, muscle, smooth muscle, bladder, gall bladder, colon, intestine, brain, cavity fluids, sputum, pus, micropiota, meconium, breast milk, prostate, esophagus, thyroid, serum, saliva, urine, gastric and digestive fluid, tears, ocular fluids, sweat, mucus, earwax, oil, glandular secretions, spinal fluid, hair, fingernails, skin cells, plasma, nasal swab or nasopharyngeal wash, spinal fluid, cord blood, emphatic fluids, and/or other excretions or body tissues. A biological sample may be a cell-free sample. Such cell-free sample may include DNA and/or RNA.

Any convenient fixation agent, or “fixative,” may be used to fix the biological sample in the absence or in the presence of hydrogel subunits, for example, formaldehyde, paraformaldehyde, glutaraldehyde, acetone, ethanol, methanol, etc. Typically, the fixative may be diluted in a buffer, e.g., saline, phosphate buffer (PB), phosphate buffered saline (PBS), citric acid buffer, potassium phosphate buffer, etc., usually at a concentration of about 1-10%, e.g., 1%, 2%, 3%, 4%, 5%, 6%, 7%, 8%, or 10%, for example, 4% paraformaldehyde/0.1M phosphate buffer; 2% paraformaldehyde/0.2% picric acid/0.1M phosphate buffer; 4% paraformaldehyde/0.2% periodate/1.2% lysine in 0.1 M phosphate buffer; 4% paraformaldehyde/0.05% glutaraldehyde in phosphate buffer; etc. The type of fixative used and the duration of exposure to the fixative will depend on the sensitivity of the molecules of interest in the specimen to denaturation by the fixative, and may be readily determined histochemically or immunohistochemically.

The fixative/hydrogel composition may comprise any hydrogel subunits, such as, but not limited to, poly(ethylene glycol) and derivatives thereof (e.g., PEG-diacrylate (PEG-DA), PEG-RGD), polyaliphatic polyurethanes, polyether polyurethanes, polyester polyurethanes, polyethylene copolymers, polyamides, polyvinyl alcohols, polypropylene glycol, polytetramethylene oxide, polyvinyl pyrrolidone, polyacrylamide, poly(hydroxyethyl acrylate), and poly(hydroxyethyl methacrylate), collagen, hyaluronic acid, chitosan, dextran, agarose, gelatin, alginate, protein polymers, methylcellulose and the like. Agents such as hydrophilic polymers, e.g., poly-lactic acid (PLA), poly-glycolic acid (PLG), or poly(lactic-co-glycolic acid) (PLGA) may be used to improve the permeability of the hydrogel while maintaining patternability. Materials such as block copolymers of PEG, degradable PEO, poly(lactic acid) (PLA), and other similar materials can be used to add specific properties to the hydrogel. Crosslinkers (e.g., bis-acrylamide, diazirine, etc.) and initiators (e.g., azobisisobutyronitrile (MEM), riboflavin, L-arginine, etc.) may be included to promote covalent bonding between interacting macromolecules in later polymerization operations.

The biological sample (e.g., a cell or tissue) may be permeabilized after being fixed. Permeabilization may be performed to facilitate access to cellular cytoplasm or intracellular molecules, components or structures of a cell. Permeabilization may allow an agent (such as a phospho-selective antibody, a nucleic acid conjugated antibody, a nucleic acid probe, a primer, etc.) to enter into a cell and reach a concentration within the cell that is greater than that which would normally penetrate into the cell in the absence of such permeabilizing treatment. In some embodiments, cells may be stored following permeabilization. In some cases, the cells may be contacted with one or more agents to allow penetration of the one or more agent after permeabilization without any storage and then analyzed. In some embodiments, cells may be permeabilized in the presence of at least about 60%, 70%, 80%, 90% or more methanol (or ethanol) and incubated on ice for a period of time. The period of time for incubation can be at least about 10, 15, 20, 25, 30, 35, 40, 50, 60 or more minutes.

Permeabilization of the cells may be performed by any suitable method. Selection of an appropriate permeabilizing agent and optimization of the incubation conditions and time may be performed. Suitable methods include, but are not limited to, exposure to a detergent (such as CHAPS, cholic acid, deoxycholic acid, digitonin, n-dodecyl-beta-D-maltoside, lauryl sulfate, glycodeoxycholic acid, n-lauroylsarcosine, saponin, and triton X-100) or to an organic alcohol (such as methanol and ethanol). Other permeabilizing methods can comprise the use of certain peptides or toxins that render membranes permeable. Permeabilization may also be performed by addition of an organic alcohol to the cells.

Permeabilization can also be achieved, for example, by way of illustration and not limitation, through the use of surfactants, detergents, phospholipids, phospholipid binding proteins, enzymes, viral membrane fusion proteins and the like; through the use of osmotically active agents; by using chemical crosslinking agents; by physicochemical methods including electroporation and the like, or by other permeabilizing methodologies.

Thus, for instance, cells may be permeabilized using any of a variety of techniques, such as exposure to one or more detergents (e.g., digitonin, Triton X-100™, NP-40™, octyl glucoside and the like) at concentrations below those used to lyse cells and solubilize membranes (e.g., below the critical micelle concentration). Certain transfection reagents, such as dioleoyl-3-trimethylammonium propane (DOTAP), may also be used. ATP can also be used to permeabilize intact cells. Low concentrations of chemicals used as fixatives (e.g., formaldehyde) may also be used to permeabilize intact cells.

The biological sample within the 3D matrix may be cleared of proteins and/or lipids that are not targets of interest. For example, the biological sample can be cleared of proteins (also called “deproteination”) by enzymatic proteolysis. The clearing may be performed before or after covalent immobilization of any target molecules or derivatives thereof.

In some cases, the clearing is performed after covalent immobilization of target nucleic acid molecules (e.g., RNA or DNA), primers (e.g., RT primers), derivatives of target molecules (e.g., cDNA or amplicons), probes (e.g., padlock probes) to a synthetic 3Dmatrix. Performing the clearing after immobilization can enable any subsequent nucleic acid hybridization reactions to be performed under conditions where the sample has been substantially deproteinated, as by enzymatic proteolysis (“protein clearing”). This method can have the benefit of removing ribosomes and other RNA- or nucleic-acid-target-binding proteins from the target molecule (while maintaining spatial location), where the protein component may impede or inhibit primer binding, reverse transcription, or padlock ligation and amplification, thereby improving the sensitivity of the assay by reducing bias in probe capture events due to protein occupation of or protein crowding/proximity to the target nucleic acid.

The clearing can comprise removing non-targets from the 3D matrix. The clearing can comprise degrading the non-targets. The clearing can comprise exposing the sample to an enzyme (e.g., a protease) able to degrade a protein. The clearing can comprise exposing the sample to a detergent.

Proteins may be cleared from the sample using enzymes, denaturants, chelating agents, chemical agents, and the like, which may break down the proteins into smaller components and/or amino acids. These smaller components may be easier to remove physically, and/or may be sufficiently small or inert such that they do not significantly affect the background. Similarly, lipids may be cleared from the sample using surfactants or the like. In some cases, one or more of these agents are used, e.g., simultaneously or sequentially. Non-limiting examples of suitable enzymes include proteinases such as proteinase K, proteases or peptidases, or digestive enzymes such as trypsin, pepsin, or chymotrypsin. Non-limiting examples of suitable denaturants include guanidine HCl, acetone, acetic acid, urea, or lithium perchlorate. Non-limiting examples of chemical agents able to denature proteins include solvents such as phenol, chloroform, guanidinium isocyananate, urea, formamide, etc. Non-limiting examples of surfactants include Triton X-100 (polyethylene glycol p-(1, 1,3,3-tetramethylbutyl)-phenyl ether), SDS (sodium dodecyl sulfate), Igepal CA-630, or poloxamers. Non-limiting examples of chelating agents include ethylenediaminetetraacetic acid (EDTA), citrate, or polyaspartic acid. In some embodiments, compounds such as these may be applied to the sample to clear proteins, lipids, and/or other components. For instance, a buffer solution (e.g., containing Tris or tris(hydroxymethyl)aminomethane) may be applied to the sample, then removed.

In some cases, nucleic acids that are not target of interest may also be cleared. These non-target nucleic acids may not be captured and/or immobilized to the 3D matrix, and therefore can be removed with an enzyme to degrade nucleic acid molecules. Non-limiting examples of DNA enzymes that may be used to remove DNA include DNase I, dsDNase, a variety of restriction enzymes, etc. Non-limiting examples of techniques to clear RNA include RNA enzymes such as RNase A, RNase T, or RNase H, or chemical agents, e.g., via alkaline hydrolysis (for example, by increasing the pH to greater than 10). Non-limiting examples of systems to remove sugars or extracellular matrix include enzymes such as chitinase, heparinases, or other glycosylases. Non-limiting examples of systems to remove lipids include enzymes such as lipidases, chemical agents such as alcohols (e.g., methanol or ethanol), or detergents such as Triton X-100 or sodium dodecyl sulfate. In this way, the background of the sample may be removed, which may facilitate analysis of the nucleic acid probes or other targets, e.g., using fluorescence microscopy, or other techniques as described herein.

### Detection

The present disclosure provides methods and systems for sample processing for use in nucleic acid detection. A sequence of the nucleic acid target may be identified. Various methods can be used for nucleic acid detection, including hybridization and sequencing. Nucleic acid detection can comprise imaging the biological sample or the 3D matrix described herein.

Reporter agents may be linked with nucleic acids, including amplified products, by covalent or non-covalent interactions. Non-limiting examples of non-covalent interactions include ionic interactions, Van der Waals forces, hydrophobic interactions, hydrogen bonding, and combinations thereof. Reporter agents may bind to initial reactants and changes in reporter agent levels may be used to detect amplified product. Reporter agents may be detectable (or non-detectable) as nucleic acid amplification progresses. Reporter agents may be optically detectable. An optically-active dye (e.g., a fluorescent dye) may be used as a reporter agent. Non-limiting examples of dyes include SYBR green, SYBR blue, DAPI, propidium iodine, Hoeste, SYBR gold, ethidium bromide, acridines, proflavine, acridine orange, acriflavine, fluorcoumanin, ellipticine, daunomycin, chloroquine, distamycin D, chromomycin, homidium, mithramycin, ruthenium polypyridyls, anthramycin, phenanthridines and acridines, ethidium bromide, propidium iodide, hexidium iodide, dihydroethidium, ethidium homodimer-1 and -2, ethidium monoazide, and ACMA, Hoechst 33258, Hoechst 33342, Hoechst 34580, DAPI, acridine orange, 7-AAD, actinomycin D, LDS751, hydroxystilbamidine, SYTOX Blue, SYTOX Green, SYTOX Orange, POPO-1, POPO-3, YOYO-1, YOYO-3, TOTO-1, TOTO-3, JOJO-1, LOLO-1, BOBO-1, BOBO-3, PO-PRO-1, PO-PRO-3, BO-PRO-1, BO-PRO-3, TO-PRO-1, TO-PRO-3, TO-PRO-5, JO-PRO-1, LO-PRO-1, YO-PRO-1, YO-PRO-3, PicoGreen, OliGreen, RiboGreen, SYBR Gold, SYBR Green I, SYBR Green II, SYBR DX, SYTO-40, -41, -42, -43, -44, -45 (blue), SYTO-13, -16, -24, -21, -23, -12, -11, -20, -22, -15, -14, -25 (green), SYTO-81, -80, -82, -83, -84, -85 (orange), SYTO-64, -17, -59, -61, -62, -60, -63 (red), fluorescein, fluorescein isothiocyanate (FITC), tetramethyl rhodamine isothiocyanate (TRITC), rhodamine, tetramethyl rhodamine, R-phycoerythrin, Cy-2, Cy-3, Cy-3.5, Cy-5, Cy5.5, Cy-7, Texas Red, Phar-Red, allophycocyanin (APC), Sybr Green I, Sybr Green II, Sybr Gold, CellTracker Green, 7-AAD, ethidium homodimer I, ethidium homodimer II, ethidium homodimer III, ethidium bromide, umbelliferone, eosin, green fluorescent protein, erythrosin, coumarin, methyl coumarin, pyrene, malachite green, stilbene, lucifer yellow, cascade blue, dichlorotriazinylamine fluorescein, dansyl chloride, fluorescent lanthanide complexes such as those including europium and terbium, carboxy tetrachloro fluorescein, 5 and/or 6-carboxy fluorescein (FAM), 5-(or 6-) iodoacetamidofluorescein, 5-{[2 (and 3)-5-(Acetylmercapto)-succinyl]amino}fluorescein (SAMSA-fluorescein), lissamine rhodamine B sulfonyl chloride, 5 and/or 6 carboxy rhodamine (ROX), 7-amino-methyl-coumarin, 7-Amino-4-methylcoumarin-3-acetic acid (AMCA), BODIPY fluorophores, 8-methoxypyrene-1,3,6-trisulfonic acid trisodium salt, 3,6-Disulfonate-4-amino-naphthalimide, phycobiliproteins, AlexaFluor 350, 405, 430, 488, 532, 546, 555, 568, 594, 610, 633, 635, 647, 660, 680, 700, 750, and 790 dyes, DyLight 350, 405, 488, 550, 594, 633, 650, 680, 755, and 800 dyes, or other fluorophores.

In some embodiments, a reporter agent may be a sequence-specific oligonucleotide probe that is optically active when hybridized with a nucleic acid target or derivative thereof (e.g., an amplified product). A probe may be linked to any of the optically-active reporter agents (e.g., dyes) described herein and may also include a quencher capable of blocking the optical activity of an associated dye. Non-limiting examples of probes that may be useful used as reporter agents include TaqMan probes, TaqMan Tamara probes, TaqMan MGB probes, or Lion probes.

The method for determining the nucleic acid sequence of a target nucleic acid molecule can include sequencing. Sequencing by synthesis, sequencing by ligation or sequencing by hybridization can be used for determining the nucleic acid sequence of a target nucleic acid molecule. As disclosed herein, various amplification methods can be employed to generate larger quantities, particularly of limited nucleic acid samples, prior to sequencing. For example, the amplification methods can produce a targeted library of amplicons.

For sequencing by ligation, labeled nucleic acid fragments may be hybridized and identified to determine the sequence of a target nucleic acid molecule. For sequencing by synthesis (SBS), labeled nucleotides can be used to determine the sequence of a target nucleic acid molecule. A target nucleic acid molecule can be hybridized with a primer and incubated in the presence of a polymerase and a labeled nucleotide containing a blocking group. The primer can be extended such that the labeled nucleotide is incorporated. The presence of the blocking group may permit the incorporation of a single nucleotide. The presence of the label can permit identification of the incorporated nucleotide. As used herein, a label can be any optically active dye described herein. Either single bases can be added or, alternatively, all four bases can be added simultaneously, particularly when each base is associated with a distinguishable label. After identifying the incorporated nucleotide by its corresponding label, both the label and the blocking group can be removed, thereby allowing a subsequent round of incorporation and identification. Thus, cleavable linkers can link the label to the base. Examples of cleavable linker include, but are not limited to, peptide linkers. Additionally, a removable blocking group may be used so that multiple rounds of identification can be performed, thereby permitting identification of at least a portion of the target nucleic acid sequence. The compositions and methods disclosed herein are useful for such an SBS approach. In addition, the compositions and methods can be useful for sequencing from a solid support (e.g., an array or a sample within a 3D matrix as described herein), where multiple sequences can be “read” simultaneously from multiple positions on the solid support since each nucleotide at each position can be identified based on its identifiable label. Example methods are described in US 2009/0088327; US 2010/0028885; and US 2009/0325172, each of which is incorporated herein by reference.

### Kits

The present disclosure also provides a kit. The kit can comprise a device for holding a sample described herein. For example, the kit can comprise a support for holding the samples. The kit can further comprise a sample cassette to be assembled with the support. The kit can comprise a reagent cartridge described herein. The reagent cartridge can comprise one or more of the reagents for carrying out a reaction such as nucleic acid amplification, reverse transcription and sequencing. The one or more reagents can comprise an enzyme, a buffer or a probe (e.g., a nucleic acid probe).

The kit can include informational material. The informational material can be descriptive, instructional, marketing or other material that relates to the methods described herein. For example, the informational material describes methods for using the device for holding a sample and/or the methods for assembling a support with a sample cassette.

The informational material of the kits is not limited in its form. The informational material, e.g., instructions, can be provided in printed matter, e.g., a printed text, drawing, and/or photograph, e.g., a label or printed sheet. The informational material can also be provided in other formats, such as Braille, computer readable material, video recording, or audio recording. In another embodiment, the informational material of the kit is a link or contact information, e.g., a physical address, email address, hyperlink, website, or telephone number, where a user of the kit can obtain substantive information about the formulation and/or its use in the methods described herein. The informational material can also be provided in any combination of formats.

The kit can contain separate containers, dividers or compartments for each component and informational material. For example, each different component can be contained in a bottle, vial, or syringe, and the informational material can be contained in a plastic sleeve or packet. The separate elements of the kit can be contained within a single, undivided container.

### Computer Systems

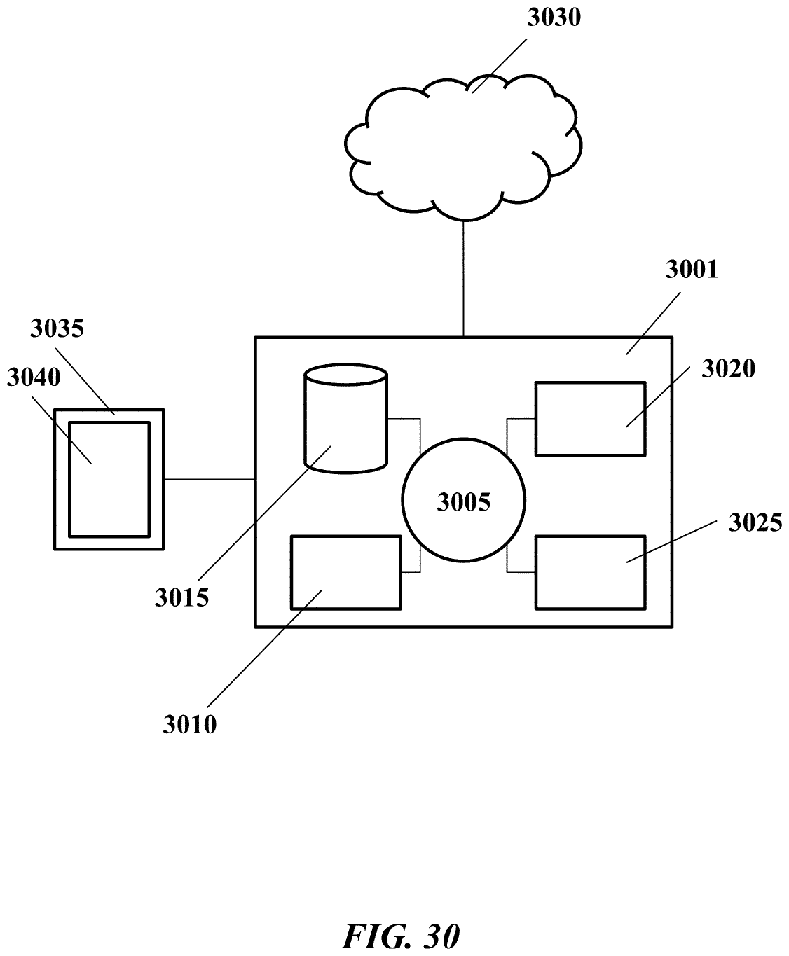

The present disclosure provides computer systems that are programmed to implement methods of the disclosure or control the systems for sample analysis. FIG. 30 shows a computer system 3001 that is programmed or otherwise configured to process a sample using the methods of the present disclosure. The computer system 3001 can regulate various aspects of sample processing of the present disclosure, such as, for example, providing a sample on a stage, contacting a reagent or buffer to the sample, performing a reaction within the sample and sequencing. The computer system 3001 can be an electronic device of a user or a computer system that is remotely located with respect to the electronic device. The electronic device can be a mobile electronic device.

The computer system 3001 includes a central processing unit (CPU, also “processor” and “computer processor” herein) 3005, which can be a single core or multi core processor, or a plurality of processors for parallel processing. The computer system 3001 also includes memory or memory location 3010 (e.g., random-access memory, read-only memory, flash memory), electronic storage unit 3015 (e.g., hard disk), communication interface 3020 (e.g., network adapter) for communicating with one or more other systems, and peripheral devices 3025, such as cache, other memory, data storage and/or electronic display adapters. The memory 3010, storage unit 3015, interface 3020 and peripheral devices 3025 are in communication with the CPU 3005 through a communication bus (solid lines), such as a motherboard. The storage unit 3015 can be a data storage unit (or data repository) for storing data. The computer system 3001 can be operatively coupled to a computer network (“network”) 3030 with the aid of the communication interface 3020. The network 3030 can be the Internet, an internet and/or extranet, or an intranet and/or extranet that is in communication with the Internet. The network 3030 in some cases is a telecommunication and/or data network. The network 3030 can include one or more computer servers, which can enable distributed computing, such as cloud computing. The network 3030, in some cases with the aid of the computer system 3001, can implement a peer-to-peer network, which may enable devices coupled to the computer system 3001 to behave as a client or a server.

The CPU 3005 can execute a sequence of machine-readable instructions, which can be embodied in a program or software. The instructions may be stored in a memory location, such as the memory 3010. The instructions can be directed to the CPU 3005, which can subsequently program or otherwise configure the CPU 3005 to implement methods of the present disclosure. Examples of operations performed by the CPU 3005 can include fetch, decode, execute, and writeback.

The CPU 3005 can be part of a circuit, such as an integrated circuit. One or more other components of the system 3001 can be included in the circuit. In some cases, the circuit is an application specific integrated circuit (ASIC).

The storage unit 3015 can store files, such as drivers, libraries and saved programs. The storage unit 3015 can store user data, e.g., user preferences and user programs. The computer system 3001 in some cases can include one or more additional data storage units that are external to the computer system 3001, such as located on a remote server that is in communication with the computer system 3001 through an intranet or the Internet.

The computer system 3001 can communicate with one or more remote computer systems through the network 3030. For instance, the computer system 3001 can communicate with a remote computer system of a user (e.g., a user performing sample processing or nucleic acid sequence detection of the present disclosure). Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system 301 via the network 3030.

Methods as described herein can be implemented by way of machine (e.g., computer processor) executable code stored on an electronic storage location of the computer system 3001, such as, for example, on the memory 3010 or electronic storage unit 3015. The machine executable or machine readable code can be provided in the form of software. During use, the code can be executed by the processor 3005. In some cases, the code can be retrieved from the storage unit 3015 and stored on the memory 3010 for ready access by the processor 3005. In some situations, the electronic storage unit 3015 can be precluded, and machine-executable instructions are stored on memory 3010.

The code can be pre-compiled and configured for use with a machine having a processer adapted to execute the code, or can be compiled during runtime. The code can be supplied in a programming language that can be selected to enable the code to execute in a pre-compiled or as-compiled fashion.

Aspects of the systems and methods provided herein, such as the computer system 301, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 3001 can include or be in communication with an electronic display 3035 that comprises a user interface (UI) 340 for providing, for example, protocols to perform the sample processing methods and/or nucleic acid sequence detection methods described in the present disclosure. Examples of UI's include, without limitation, a graphical user interface (GUI) and web-based user interface.

Methods and systems of the present disclosure can be implemented by way of one or more algorithms. An algorithm can be implemented by way of software upon execution by the central processing unit 3005. The algorithm can, for example, be executed so as to process a sample and/or detect a nucleic acid sequence utilizing methods and systems disclosed in the present disclosure.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

1.-189. (canceled)

190. A system for analyzing a sample comprising:
a first module having a first housing comprising:
a first stage configured to retain a sample comprising a plurality of nucleic acid molecules in a three-dimensional (3D) matrix, which plurality of nucleic acid molecules have a relative 3D spatial relationship; and
a detector configured to detect one or more signals from the sample; and
a second module having a second housing comprising:
a computer operatively coupled to the detector, wherein the computer is configured to:
(a) bring said plurality of nucleic acid molecules or derivatives thereof in contact with detectable moieties, and use said detector to obtain signals corresponding to said detectable moieties from a plurality of planes of said 3D matrix, and
(b) use said signals obtained by said detector to generate a 3D volumetric representation of said plurality of nucleic acid molecules, which 3D volumetric representation identifies said relative 3D spatial relationship of said plurality of nucleic acid molecules; and
a second stage,
wherein the first housing is physically distinct from the second housing.

191. The system of claim 190, wherein the first module further comprises a fluidic waste extraction tube positioned above the first stage.

192. The system of claim 190, wherein the second module further comprises a reagent reservoir interface.

193. The system of claim 190, wherein the first stage or the second stage comprises at least one recess for holding a device for retaining the sample, wherein the device comprises a support.

194. The system of claim 193, wherein the first stage or the second stage comprises a lid for securing the device.

195. The system of claim 194, wherein the lid comprises a hinge.

196. The system of claim 193, wherein the at least one recess comprises a sample position controller that positions the sample within the at least one recess.

197. The system of claim 196, wherein the sample position controller comprises at least one mechanical linkage that positions the sample within the at least one recess.

198. The system of claim 197, wherein the at least one mechanical linkage comprises a cam.

199. The system of claim 196, wherein the sample position controller comprises at least one pin that positions the sample within the at least one recess.

200. The system of claim 196, wherein the sample position controller comprises at least one X pin, at least one Y pin, and at least one Z pin.

201. The system of claim 190, wherein the first stage or the second stage further comprises a temperature controller.

202. The system of claim 201, wherein the temperature controller comprises a Peltier element.

203. The system of claim 190, wherein the first stage or the second stage is a motorized stage that moves in an x, y, and z direction relative to the detector.

204. The system of claim 190, wherein the system further comprises a reagent cartridge interface for fluidically connecting the system to a reagent cartridge comprising a plurality of chambers for holding reagents.

205. The system of claim 190, wherein the second module comprises a digital processing device comprising: at least one processor, an operating system configured to perform executable instructions, a memory, and a computer program including instructions executable by the digital processing device to provide an application comprising:
a software module for controlling the system to repeatedly scan a three-dimensional sub-volume of the sample to generate repeated scans, which repeated scans comprises temporal data, and processing data from the repeated scans including the temporal data to generate a three-dimensional map of the three-dimensional sub-volume of the sample.

206. The system of claim 205, wherein the three-dimensional map comprises a coordinate system.

207. The system of claim 205, wherein the digital processing device comprises a software module for detecting a position of a fiducial marker on a sample device associated with a scan of the repeated scans and adjusting the three-dimensional map of the sub-volume of the sample to compensate for the position of the fiducial marker on the sample device.

208. The system of claim 205, wherein the digital processing device comprises a software module for controlling a timing of fluidic, optical, and motion-related events occurring in the first module.

209. The system of claim 208, wherein the software module for controlling the timing of fluidic, optical, and motion-related events occurring in the first module controls motors, cameras, optical tuning systems, optical gating systems, or sensors.
